(19) United States
(12) Patent Application Publication
(10) Pub. No.: US 2012/0173209 A1
(43) Pub. Date: Jul. 5, 2012

(54) SYSTEM AND METHOD FOR ANALYZING AND DESIGNING AN ARCHITECTURAL STRUCTURE USING PARAMETRIC ANALYSIS

(76) Inventors: Peter Leonard Krebs, Las Cruces, NM (US); Mads Næstholt Jensen, London (GB); Varun Singh, New York, NY (US); Jacob Miles, Brooklyn, NY (US); Jeremy Gayed, Washington Township, NJ (US); David Wightman Swartz, Brooklyn, NY (US)

(21) Appl. No.: 13/367,236

(22) Filed: Feb. 6, 2012

Related U.S. Application Data
(63) Continuation-in-part of application No. 12/893,225, filed on Sep. 29, 2010.

(51) Int. Cl. G06F 17/50

(52) U.S. Cl. 703/1

(57) ABSTRACT

According to various embodiments of the invention, systems and methods are provided for parametrically analyzing architectural structures. Such embodiments may be utilized by architects and engineers as tools that assist in designing architectural structures that achieve specific design goals, such as those related to sustainability. For example, an embodiment may comprise a system that: (i) provides a sustainability on an architectural structure design created using a computer-assisted design (CAD) tool, and then (ii) applies a design option with a parametric value to that design to determine one or more improvements that provide a desired sustainability. Various embodiments may be accessed through a web-based platform, which provides a user with easier access and better collaboration between and among design team members.

### CROSS-REFERENCE TO RELATED APPLICATIONS

This application is a continuation-in-part of and claims the benefit of U.S. patent application Ser. No. 12/893,225 filed Sep. 29, 2010, which is incorporated by reference herein.

### FIELD OF THE INVENTION

The present invention relates to architectural structures, such as buildings, and more particularly, some embodiments relate to analyzing design options for an architectural structure, some of which improve a structure's sustainability (e.g., lower resource consumption and minimize environmental impacts).

### DESCRIPTION OF THE RELATED ART

During the design phase of an architectural structure (also herein referred to as a “massing”), architects consider and analyze, among other things, where and how energy, water, materials, and other resources associated with the architectural structure (e.g., building, bridges, etc.) are being consumed or utilized. Generally, architects attempt to optimize their design of architectural structure for optimal resource consumption (e.g., energy, water, materials, etc.), lower construction costs, lower operational costs, and lower maintenance costs. In addition to lowering overall costs and resource uses, an optimized design may also improve a structure's compliance with building standards, certifications and ratings. These standards, certifications and ratings include green building certification and rating systems, such as Leadership in Energy & Environmental Design (LEED®), Code for Sustainable Homes (CSH), and Estidama, and environmental impact rating systems, such as Building Research Establishment Environment Assessment Method (BREEAM), and Building and Construction Authority (BCA) GreenMark.

Unfortunately, architects seeking to achieve sustainable architectural designs are finding themselves expending more and more time optimizing the design to achieve their particular sustainability goals. The expended time not only influences the development schedule for an architectural structure, but also proves to be disadvantageous when design documents need to be submitted in a timely fashion as proof of building standards compliance (e.g., green standards).

### BRIEF SUMMARY OF EMBODIMENTS OF THE INVENTION

Various embodiments of the invention provide systems and methods for analyzing and designing architectural structures. These embodiments may assist architects, engineers, and the like in designing architectural structures that achieve specific design goals, such as those related to sustainability. For example, an embodiment may comprise a system that: (i) provides a sustainability analysis on an architectural structure design created using a computer-assisted design (CAD) tool; and then (ii) applies a design option to that design (e.g., single or multi-story house, office building, warehouse, apartment building, hospital, school, municipal building, etc.) to improve its sustainability. In addition, various embodiments may be accessed through a web-based platform, which provides a user with easier access and better collaboration between and among design team members.

In particular, some embodiments of the invention involve selecting an architectural structure/massing to analyze, and then (e.g., designer, building engineer, or architect) selecting one or more design strategies (also herein referred to as “design options”) to be applied to and evaluated against a selected design model representing the selected architectural structure. The architectural structure to be analys may be in the form of a design model, which may be prepared by a designer, architect, or the like, and then provided to an embodiment for analysis.

Alternatively, a user may choose to use a design model of a generic architectural structure/massing (also referred to herein as a “parametrically created design model”) that closely matches certain aspects (e.g., in dimensions, structure, size, volume, etc.) of the architectural structure intended to be analyzed. Generally, design models for generic architectural structures/massings are ready-made, have a simple geometry in comparison to actual architectural structures, and can be parametrically adjusted (e.g., by a user) to better match properties of a architectural structure a user wants to analyze. A design model of a generic architectural structure/massing may be used in place of an actual architectural, for example, when a design model of the actual architectural structure has yet to be prepared or when the actual architectural structure is overly complex and therefore requiring more analysis time. Depending on the embodiment, a user may substitute the architectural structure to be analyzed with a design model of a generic architectural structure/massing by first selecting a design model of the generic architectural structure/massing (e.g., from a list of read-made design models) and then parametrically adjusting the selected model to better match properties of the actual architectural structure the user intends to analyze. For instance, after selecting a design model of a generic architectural structure/massing, a user adjust the dimensions and numbers of festrations for the selected design model.

Once selected, one or more of the selected design strategies/options may be configured to behave parametrically with respect to the architectural structure. For some embodiments, a selected design strategy/option may be configured to behave parametrically by assigning the design option parameters associated of that selected design strategy/option with a set of varying values, comprising one or more unique or non-unique values, rather than a single static value. By configuring at least one design strategy/option in a set of selected design strategies/options to behave parametrically in this manner (i.e., by assigning a set of varying values to a design option parameter associated with at least one selected design strategy/option), the entire set of selected design strategies/options can have more than one possible configuration. Specifically, due to the set of varying values being assigned to a design option parameter associated with at least one selected design strategy/option, each possible configuration may have a unique combination of values assigned to the design option parameters associated with the selected design strategies/options. Consequently, when the set of selected design strategies/options is applied to and analyzed for an architectural structure, the architectural structure may be analyzed under a plurality of design scenarios, each design scenario evaluating the architectural structure under a possible configuration for the set of design strategies/options (i.e., each design scenario considers a different combinations of values possible for the design option parameters of the selected design strategies/options). Through such analysis, a user may quickly and efficiently evaluate an architectural structure under a plurality of design scenarios, and determine one or more optimal design scenarios (e.g., optimal design options, design option parameters, and values) for the architectural structure. Additionally, such analysis may provide information on the sensitivity response of certain impacts/effects on the architectural structure to different design options or design option parameters.

According to some embodiments, a method for parametrically analyzing an architectural structure is provided, comprising: receiving a design option to apply to an element of the architectural structure (e.g., changes to orientation of building, size of fenestrations of the architectural structure, wall insulation, glazing on windows, wall conductance, etc.), and assigning a set of varying values to a design option parameter associated with the design option, where the design option parameter is configured to control a level of change effectuated on the architectural structure by the design option. For example, where a design option—design option A—is to be applied to an architectural structure for impact analysis, the design option parameter associated with design option A (i.e., design option parameter A) may be assigned a set of varying values comprising the values of 1, 2 and 3 (i.e., {1, 2, 3}).

Then, for each varying value in the set of varying values, a method may further comprise applying the design option to the element of the architectural structure while the design option parameter is assigned the varying value, and analyzing an impact on the architectural structure as a result of the application (i.e., as a result of applying the design option to the element of the architectural structure while the design option parameter is assigned the varying value). For instance, with respect to the example of design option A, design option parameter A, and the set of varying values {1, 2, 3}, a method may apply design option A to the element of the architectural structure and analyze a resulting impact (on some or all of the architectural structure) three times due to the three different assignment scenarios: once while design option parameter A is assigned the value of 1, once while design option parameter A is assigned the value of 2, and once while design option parameter A is assigned the value of 3. In this manner, the methods of some embodiments can parametrically analyze an architectural structure under the influence of a design option that is being controlled by a set of varying values. Stated another way, such embodiments allow analysis of an architectural structure while treating a design option parameter as a parametric variable.

For various embodiments, the value assigned to a design option parameter may be a discrete value (e.g., Light, Medium, Heavy) rather than just numerical value, where the discrete value may have a numerical value associated with the discrete value. In some embodiments, where a design option parameter is configured to be assigned discrete values (e.g., Light, Medium, Heavy), the set of varying discrete values may be defined by a list of discrete values (e.g., an array of discrete values), by a range of values between a min discrete value and a max discrete value, or by a formula, which may produce the set of varying discrete values based on a set of input values to the formula.

Additionally, in place of or in addition to parameterizing design options during analysis of an architectural structure, various embodiments may parameterize location-related data applied to the architectural structure. For example, some embodiments may parameterize the weather information applied to the analysis of an architectural structure: (a) over time for a given geographical location (e.g., current weather information vs. weather information projected for 2030, 2050 and 2080), or (b) weather information across multiple geographical locations (e.g., project sites in California, New York, Florida, and Texas). Similarly, some embodiments may parameterize location-related data applied to the analysis of an architectural structure over multiple geographical locations (i.e., multiple project sites).

An architectural structure may comprise a plane, a wall, or a fenestration (e.g., windows, doorways) and converting the architectural structure to three-dimensional data may comprise obtaining geometric data regarding the plane, the wall, or the fenestration. For example, the architectural structure may be a building (e.g., single or multi-story house, office building, warehouse, apartment building, bridge, tunnel, etc.). The architectural structure may comprise a structure property relating to an operation of the architectural structure, a resource associated with the architectural structure, an equipment item associated with the architectural structure, or construction of the architectural structure, and analyzing an impact of applying the first design option to the architectural structure further uses the structure property. Then, for each varying value in the set of varying values, a method may further comprise applying the design option to the element of the architectural structure while the design option parameter is assigned the varying value, and analyzing an impact on the architectural structure as a result of applying the design option in such a manner (i.e., applying the design option to the element of the architectural structure while the design option parameter is assigned the varying value).

A design option may include a change in the three-dimensional data of the architectural structure, an equipment choice for the architectural structure, an energy source choice for the architectural structure, a water source choice for the architectural structure, a heating choice for the architectural structure, a cooling choice for the architectural structure, or a construction choice for the architectural structure. Further, in some embodiments, the design option may implement an improvement to the architectural structure with respect to building performance metrics, an operational cost, a maintenance cost, or compliance with a structural building standard. For example, improvements may include energy use, water use, day-lighting feasibility, an operational cost, a maintenance cost, or compliance with a building standard.

As noted herein, for some embodiments, a design option parameter may control a level of change effectuated on the architectural structure by the design option. For example, a design option parameter may be assigned a value (e.g., a static/locked value, or a set of values) that controls the level of change by the design option (e.g., glazing ratio of windows, amount of wall conductance, etc.). As discussed herein, where a design option parameter is assigned a set of values (as opposed to a static/locked value), a method according to some embodiments may perform a plurality of analysis iterations such that each analysis iteration considers each value within the set of values when applying a design option to an architectural structure and analyzing the resulting impact on the architectural structure.

In various embodiments, analyzing the impact of applying the design option to the architectural structure may comprise determining an effect of the design option to the architectural structure by evaluating a formula associated with the design option. Depending on the embodiment, the formula evaluated utilizes the design option parameter, the three-dimensional data, the location-related data, a structure property, or an informed assumption. Additionally, in various embodiments, analyzing the impact of applying the design option to the architectural structure may comprise determining a cost or a benefit associated with applying the first design option to the architectural structure.

Depending on the embodiment, the architectural structure (to which the design option is applied) may be received in the form of a design model, which may comprise three-dimensional (3D) data describing the structure and elements of the architectural structure. In some embodiments, the design model may be contained 3D design tool file, such an AutoCAD® file or a Google® SketchUp® file, which may be accessed by a system performing a method of an embodiment and from which the system can extract the design model. Additionally, for some embodiments, the set of varying values may be defined by a range of values and an associated interval value (i.e., step value, or pre-determined delta) that determines which values from the range are included in the set of varying values. The set of varying values may also be defined by a formula or algorithm that determines one or more values included in the set of varying values.

To apply the design option to the element of the architectural structure and analyzing the resulting impact, a method may further comprise obtaining a first geographic location of the architectural structure, obtaining location-related data regarding the first geographic location, and extracting from the architectural structure three-dimensional data representing the element of the architectural structure. Subsequently, for each varying value in the set of varying values, a method may further comprise applying the set of design options to the architectural structure using the three-dimensional data, and analyzing the set of impacts on the architectural structure using the three-dimensional data and the location-related data.

Location-related data may include weather data for the geographic location, altitude data for the geographic location, an energy source option available at the geographic location, a water source available at the geographic location, information about another architectural structure neighboring the architectural structure, demographic information for the geographic location, development information for the geographic location, a transportation option for the geographic location, environmental information for the geographic location, or construction zoning and code data for the geographic location.

In various embodiments, obtaining the geographic location may comprise receiving a definition of a project site upon which the architectural structure is disposed, the project site providing coordinates for the geographic location. In some such embodiments, the project site may comprise a plurality of architectural structures of which the architectural structure is one, and applying the first design option to the architectural structure is a result of applying the first design option to the project site.

For some embodiments, a method may further comprise defining a collection of elements of the architectural structure, such that during performance of the method, the design option is applied only to those elements identified/specified in the collection rather than the entirety of the architectural structure (i.e., applying the design option to the collection of elements of the architectural structure while the design option parameter is assigned the varying value). Thereafter, a method may further comprise analyzing an impact on the architectural structure that results from applying the design option to the collection of elements of the architectural structure while the design option parameter is assigned the varying value.

According to some embodiments, a method for parametrically analyzing an architectural structure is provided, comprising receiving a set of design options to be applied to the architectural structure, and assigning a set of values to the set of design option parameters. The set of design options may include a design option associated with a design option parameter in a set of design option parameters, where the design option parameter may be configured to control a level of change effectuated on the architectural structure by the design option. Additionally, at least one member of the set of values may be a set of varying values that is assigned to the design option parameter associated with the design option in the set of design options. Those members of the set of values that are not sets of varying values may be static values, which do not vary during a parametric analysis process.

In some embodiment, a method may further comprise determining a set of assignment combinations for the set of design option parameters based on the design option parameter associated with the design option being assigned the set of varying values, The method may also comprise determining a set of analysis iterations based on the set of assignment combinations.

Consider, for example, where three design options—design option A, design option B, and design option C—are being applied to an architectural structure for impact analysis. Additionally, assume for this example that the design option parameter associated with design option A (i.e., design option parameter A, hereafter represented as “A:”) is assigned a set of varying values containing the values of 1 and 2 (i.e., {1, 2}), where the design option parameter associated with design option B (i.e., design option parameter B, hereafter represented as “B:”) is assigned a set of varying values containing the values of 3 and 4 (i.e., {3, 4}), and the design option parameter associated with design option C (i.e., design option parameter C, hereafter represented as “C:”) is assigned the static value of 5 (i.e., {5}). According to these value assignments, a method may determine that the set of assignment combinations to be the following: {{A:1, B:3,C: 5},{A:2, B:3,C: 5},{A:1, B:4,C: 5},{A:2, B:3,C: 5}}, and that the set of analysis iterations would comprise four analysis iterations each using a different assignment combination from the set of assignment combinations. In this way, the methods of some embodiments can parametrically analyze an architectural structure under the influence of one or more design options that are being controlled by a set of varying values. As noted before, such methods can analyze of an architectural structure while treating two or more design option parameters as parametric variables.

For certain embodiments, each analysis iteration may be associated with an assignment combination from the set of assignment combinations, and may be configured to apply the set of design options to the architectural structure in accordance with the set of design option parameters as modified by an assignment combination associated with the analysis iteration. Each analysis iteration may be further configured to analyze a set of impacts on the architectural structure that result from applying the set of design options to the architectural structure, thereby producing analysis data.

In some embodiment, a method may further comprise performing the set of analysis iterations on the architectural structure. In various embodiments, performing the set of analysis iterations on the architectural structure may comprise obtaining a first geographic location of the architectural structure, obtaining location-related data regarding the first geographic location, and extracting from the architectural structure three-dimensional data representing the architectural structure. Subsequently, for each analysis iteration in the set of analysis iterations, A method may further comprise applying the set of design options to the architectural structure using the three-dimensional data, and analyzing the set of impacts on the architectural structure using the three-dimensional data and the location-related data.

Once the set of analysis iterations is performed on the architectural structure, a method may further comprise identifying a specific analysis iteration in the set of analysis iterations based on the analysis data (e.g., search critieria applied on the analysis data). To that end, a method may further comprise filtering the analysis data according to a desired feature, thereby resulting in filtered analysis data, and then identifying the specific analysis iteration in the set of analysis iterations such that the specific analysis iteration corresponds to the filtered analysis data.

For some embodiments, a feature may include energy consumption of the architectural structure, water consumption of the architectural structure, compliance of the architectural structure with a construction standard, a thermal characteristic of the architectural structure, carbon footprint of the architectural structure, indoor environment quality of the architectural structure, a construction material utilized in the architectural structure, an equipment item utilized by the architectural structure, a construction cost of the architectural structure, an operational cost of the architectural structure, or a maintenance cost of the architectural structure.

In some embodiments, a method may comprise determining a feature of the architectural structure based on the analysis data (e.g., search critieria applied on the analysis data). When determining the feature, a method may comprise computing a cost-benefit analysis of applying the design option to the architectural structure. In more embodiments, determining the feature may comprise computing a return-on-investment or payback period for applying the design option to the architectural structure.

In some embodiments, identifying a specific analysis in the set of analysis iteration based on analysis data may comprise using the analysis data to compare a first impact as a function of a specific design option parameter and a second impact as a function of the (same) specific design option parameter, where both the first and second impacts are from the set of impacts, and where the specific design option parameter is from the set of design option parameters. Subsequently, the specific analysis iteration is identified in the set of analysis iterations based on the impact comparison.

For some embodiments, a method may comprise identifying a specific analysis iteration in the set of analysis iterations, where the specific analysis iteration corresponds to a value or a range of values assigned to a design option parameter in the set of design option parameters.

A method may further comprise identifying a computing resource necessary to perform the set of analysis iterations on the architectural structure, and/or determining a time necessary to perform the set of analysis iterations on the architectural structure. In so doing, a user (e.g., designer, building engineer, or architect) may be informed of the computing resource(s) and/or time needed to perform set of analysis iterations before the performance is initiated.

Where a design option is being applied to certain elements of the architectural structure rather than all of the architectural structure, a method may further comprise receiving a set of element selections (e.g., mapping), wherein application of a design option in the set of design options to an element of the architectural structure an element selection in the set of element selections determines (e.g., maps) application of a design option in the set of design options to an element of the architectural structure.

In some embodiments, a method may further comprise creating a design concept using the set of design options, using the set of design option parameters, and using an assignment combination associated with a specific analysis iteration. In various embodiments, a method may further comprise modifying an existing design concept using the set of design options, using the set of design option parameters, and using an assignment combination associated with a specific analysis iteration. In various embodiments, a design concept may comprise a plurality of design options that may be applied to an architectural structure, and the design concept may comprise variables (i.e., design concept variables) that store the adjusted values for the parameters of design options contained therein.

It should be noted that in some embodiments, a method might be configured such that applying the design option to the architectural structure impacts an effect of another design option that is applied to the architectural structure. Further, a method may comprise implementing a change to the design option parameter, the change to the design option parameter impacting an effect of another design option that is applied to the three-dimensional data. In accordance with some such embodiments, a change to a design option parameter cascades as a change that impacts an effect of another design option being applied to the architectural structure.

Additionally, for some embodiments, location-related data utilized by a method may be provided by or acquired from a data source provider. For example, a data source provider for location-related data may be the U.S. Department of Energy, the Bureau of Labor Statistics (BLS), the Environmental Protection Agency (EPA), the U.S. Energy Information Administration (EIA), or the National Oceanic and Atmospheric Administration (NOAA)/National Weather Service. As described above, the location-related data may include climate data for the geographic location, altitude data for the geographic location, an energy source option available at the geographic location, a water source available at the geographic location, information about another architectural structure neighboring the architectural structure, demographic information for the geographic location, development information for the geographic location, a transportation option for the geographic location, environmental information for the geographic location, construction zoning and code data for the geographic location. Cost-related data, on the other hand, may include energy costs, water costs, labor costs, and materials costs.

In some embodiments, a methods as described above are implemented into a computer system, such as one implementing a computer-aided design (CAD) tool, comprising: a processor; and a memory, coupled to the processor and having computer program code embodied therein for enabling the processor to perform operations in accordance with those methods. For instance, some methods as described above may be implemented as a computer program product comprising a computer-readable storage medium in which program instructions are stored, the program instructions configured to cause a computer system to perform operations in accordance with those methods. In various embodiments, the methods described above are implemented in a client and server environment such that a first set of operations from the method is performed by a client and a second set of operations from the method is performed by a server. Various embodiments may utilize a client and server environment involving a virtual computing environment, such as cloud-based computing platform, where some or all of the methods described herein are performed in the virtual computing environment. Likewise, for some embodiments, the system components described herein may be implemented in the virtual computing environment.

Further, some embodiments may utilize socket communication between two or more components of a system, where together the components implement some or all of various methods described herein. Example components may include, without limitation, a component integrated into a CAD tool, a component of a web browser, a client-side component, or a server-side component.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1A is a flowchart illustrating an example method in accordance with an embodiment of the present invention.

FIG. 1B is a flowchart illustrating an example extraction method in accordance with an embodiment of the present invention.

FIG. 2A is a diagram illustrating an example system in accordance with an embodiment of the present invention.

FIG. 2B is a flowchart illustrating an example energy analysis engine in accordance with an embodiment of the present invention.

FIG. 2C is a flowchart illustrating an example water analysis engine in accordance with an embodiment of the present invention.

FIG. 2D is a table illustrating an example calculation of certification credit in accordance with an embodiment of the present invention.

FIG. 2E is a flowchart illustrating an example onsite generation analysis engine in accordance with an embodiment of the present invention.

FIG. 2F is a flowchart illustrating example daylighting analysis engine in accordance with an embodiment of the present invention.

FIG. 2G is a flowchart illustrating an example data aggregation method in accordance with an embodiment of the present invention.

FIG. 3 is a sequence diagram illustrating the sequence of operations performed by an example system in accordance with an embodiment of the present invention.

FIG. 4 is flowchart illustrating an example method in accordance with an embodiment of the present invention.

FIG. 5A is a screenshot illustrating an example operation for starting a new design project in accordance with an embodiment of the present invention.

FIG. 5B is a diagram illustrating an example project composition in accordance with an embodiment of the present invention.

FIG. 6 is a screenshot illustrating an example operation for defining a project site in accordance with an embodiment of the present invention.

FIG. 7 is a screenshot illustrating an example operation for defining a project site in accordance with an embodiment of the present invention.

FIG. 8 is a screenshot illustrating an example operation for defining a project site in accordance with an embodiment of the present invention.

FIG. 9 is a screenshot illustrating an example operation for selecting one or more architectural structures for a project site in accordance with an embodiment of the present invention.

FIG. 10 is a screenshot illustrating an example operation for editing a building (i.e., structure) property in accordance with an embodiment of the present invention.

FIG. 11 is a screenshot illustrating an example operation for selecting a building (i.e., architectural structure) to be analyzed in accordance with an embodiment of the present invention.

FIG. 12 is a screenshot illustrating an example report on design concepts applied to an architectural structure in accordance with an embodiment of the present invention.

FIG. 13 is a screenshot illustrating an example summary performance report on an architectural structure being analyzed under a design concept in accordance with an embodiment of the present invention.

FIG. 14 is a screenshot illustrating an example preview of a three-dimensional model that may be analyzed in accordance with an embodiment of the present invention.

FIG. 15 is a screenshot illustrating an example overview of energy design options that may be applied to an architectural structure in accordance with an embodiment of the present invention.

FIG. 16 is a screenshot illustrating an example overview and application of energy design options to an architectural structure in accordance with an embodiment of the present invention.

FIGS. 17A-17B are screenshots illustrating example operations for editing design option parameters in accordance with an embodiment of the present invention.

FIG. 18 is a screenshot illustrating an example operation for editing structure resource properties in accordance with an embodiment of the present invention.

FIG. 19 is a screenshot illustrating an example operation for editing structure equipment properties in accordance with an embodiment of the present invention.

FIG. 20 is a screenshot illustrating an example operation for editing structure operation properties in accordance with an embodiment of the present invention.

FIG. 21 is a screenshot illustrating an example operation for editing structure construction properties in accordance with an embodiment of the present invention.

FIG. 22 provides a flowchart illustrating an example method for performing parametric analysis on an architectural structure in accordance with an embodiment of the present invention.

FIGS. 23A-23B provide a flowchart illustrating an example method for performing parametric analysis on an architectural structure in accordance with an embodiment of the present invention.

FIG. 24 is a screenshot illustrating an example interface for accessing collections of architectural structure elements in accordance with an embodiment of the present invention.

FIG. 25 is a screenshot illustrating an example interface for creating collections of architectural structure elements in accordance with an embodiment of the present invention.

FIG. 26 is a screenshot illustrating an example interface for creating an architectural structure analysis project in accordance with an embodiment of the present invention.

FIG. 27 is a screenshot illustrating an example interface for configuring a parametric analysis of an architectural structural in accordance with an embodiment of the present invention.

FIGS. 28 and 29 are screenshots illustrating example interfaces for selecting and configuring design options for a parametric analysis of an architectural structural in accordance with an embodiment of the present invention.

FIG. 30 is a screenshot illustrating an example interface for configuring a parametric analysis progress notification in accordance with an embodiment of the present invention.

FIG. 31 is a screenshot illustrating an example interface for reviewing and accessing one or more parametric analyses associated with an architectural structure in accordance with an embodiment of the present invention.

FIG. 32-36 are screenshots illustrating example interfaces for reviewing one or more results of a parametric analysis on an architectural structure in accordance with an embodiment of the present invention.

FIG. 37 illustrates an example computing module for implementing various embodiments of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

The present invention is directed toward systems and methods for analyzing and designing an architectural structure. For example, certain systems in accordance with the present invention are configured to receive, from a designer (e.g., architect), a three-dimensional (3D) concept/initial design (i.e., model) for an architectural structure (e.g., office building), and analyze the design in the context of suggested and applied design options (also referred as design strategies) that improve aspects of the architectural structure. The 3D concept design may have been created with a 3D design tool, such as Google® SketchUp®, and, as such, may involve importation into the system before it can be analyzed. Additionally, subsequent to importing the 3D concept design into the system, some embodiments may perform a series of operations in preparation for analyzing the concept design, and in preparation for applying design options to the concept design.

In one embodiment, the architect may place the architectural structure on a world map based on latitude and longitude coordinates (i.e., geographic coordinates) or postal address. By obtaining the geographic location of the architectural structure, certain embodiments of the invention are able to obtain various location-related data for the geographic location. Such location-related data may include, for example, (i) climate data (e.g., rainfall, solar insolation, prevailing winds, typical meteorological year—TMY, future weather estimates) for the geographic location; (ii) altitude information for the geographic location; (iii) resource and utility options available at the geographic location (e.g., water source, energy source); (iv) data about surrounding and neighboring architectural structures, (v) environmental information for the geographic location; and (vi) zoning and code data at and around the geographic location (e.g., recommendations by standards boards for the location, financial information such as local currency, local tax information). Additional location-related data may include physical structures in the vicinity of geographic location, path of the sun throughout the year for the geographic location, weather predictions for the current year and future years for the geographic location, and weather information from past years for the geographic location.

Examples of other types of location-related data include: (a) demographic information for the geographic location; development information for the geographic location (e.g., statistics of development in the area); (b) community information for the geographical location (e.g., schools, retail); (c) environmental information for the geographical location (e.g., endangered species/surrounding land types—farmland, wetlands, watercourses, EPA info); and (d) transportation options available around the geographic location (e.g., busses, subways).

Additionally, in preparation for analysis and application of design options, the embodiment may obtain certain performance criteria or operational properties of the architectural structure before performing such analysis or application. These criteria or properties may be acquired from a user or, alternatively, from a prepared listing of criteria or properties (e.g., stored within a file). Examples of operational properties include, but are not limited to, principal use of the architectural structure (e.g., house, office, apartment, library), average occupancy, start and stop time of occupancy, room types (e.g., office, auditorium, living room, kitchen, bathroom), lighting per a room (also referred to as lux levels), and calculated light distribution within the interior of the architectural structure and on the exterior of the architectural structure.

Following the preparation operations, the embodiment may perform operations in which geometric data regarding an architectural structure stored within the 3D concept design is obtained. Some embodiments perform this operation by converting the architectural structure to three-dimensional (3D) data native to the embodiment environment.

Additionally, some embodiments may further extract the architectural structure from the 3D concept design before gathering the geometric data regarding the architectural structure.

Using the geometric data and performance criteria/operational properties of the architectural structure along with location-related data, the embodiment may suggest and apply design options to the architectural design that improve aspects of its construction or performance. For example, with the application of select design options, the embodiment may analyze and determine that the selected design options would result in certain features for the architectural structure that lower construction cost, lower operational cost, lower maintenance cost, increase compliance or rating with a building standard or certification system (e.g., LEED®, CSH, BREEAM), or improve sustainability. Design options include, but are not limited to, a change to: (i) the architectural structure; (ii) an equipment choice for the architectural structure (e.g., water heating, fan/pump/motor); (iii) an energy source choice(e.g., nuclear, coal, gas, off-site renewable, on-site renewable, wind turbines, fuel cells, solar, and hydropower) for the architectural structure; (iv) a water source choice (e.g., rainwater, water main) for the architectural structure; (v) a heating choice for the architectural structure; (vi) a cooling choice for the architectural structure; and (vii) a construction choice for the architectural structure (e.g., construction type, wall type, fenestration type, roof type, insulation).

Furthermore, within certain embodiments, sets of selected design options may be grouped together as a design concept, where, through a design concept, a given architectural structure may have a plurality of different design options applied to it and then analyzed. Additionally, in some embodiments, different design concepts may be individually applied to a given architectural structure, analyzed for their individual impact/benefit on the architectural structure, and compared against each other. Overall, through the use of design options and design concepts, a user is able to develop custom design concepts that meet the desired goals and objectives of the architectural project.

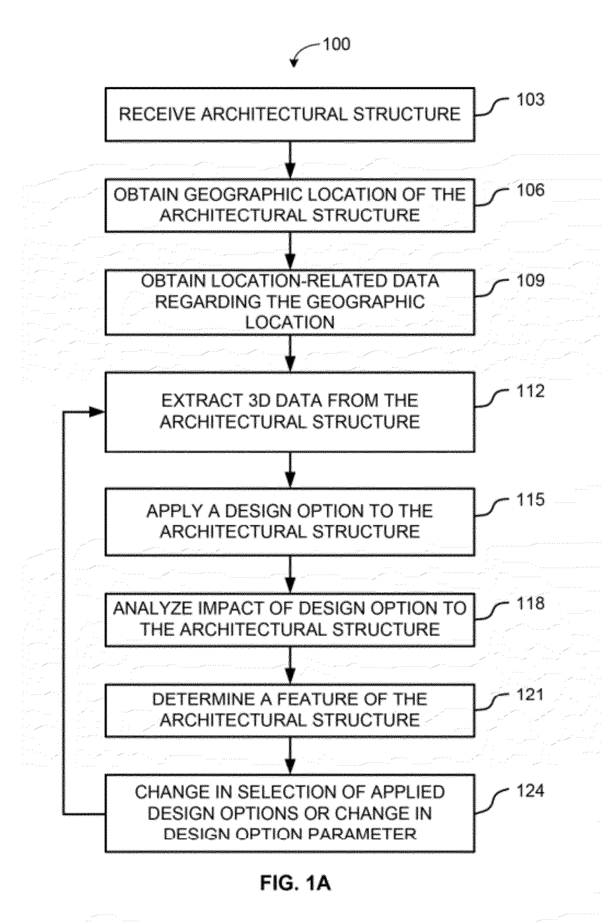

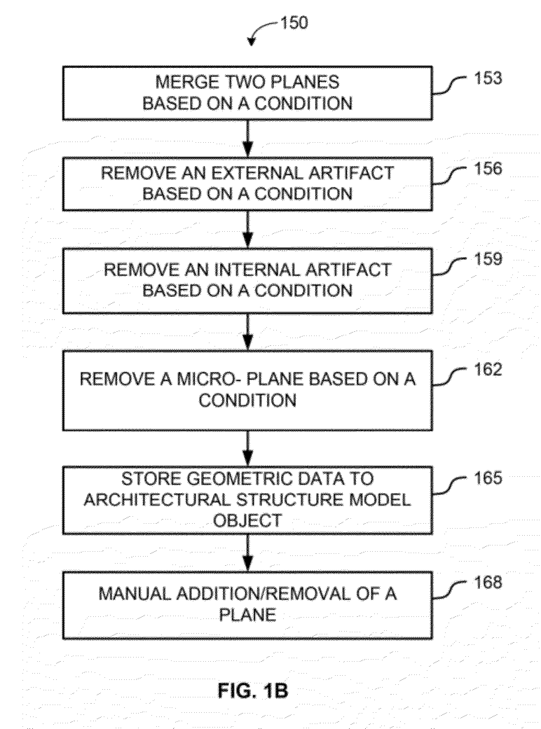

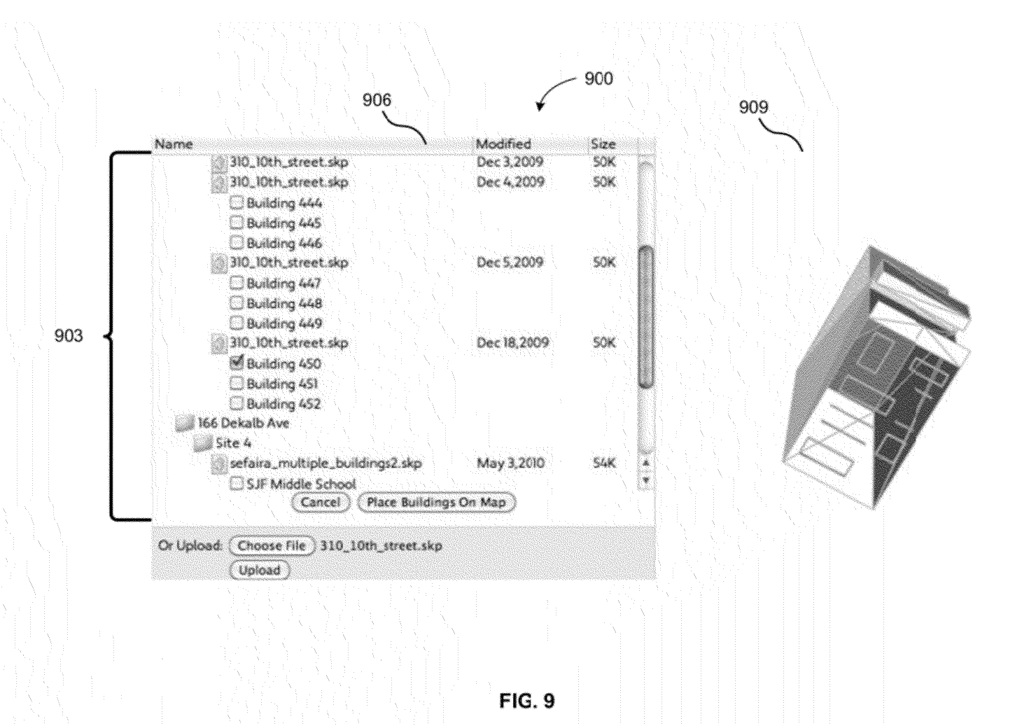

FIG. 1A provides an illustration of a method 100 for analyzing and designing an architectural structure in accordance with one embodiment of the present invention. The method 100 begins at operation 103, where an architectural structure is received for analysis and processing. As described above, the architectural structure may originate from a 3D concept design (e.g., Google® SketchUp®), which may contain one or more architectural structures from which a user may select to analyze. Where a 3D concept design comprises a plurality of architectural structures, the architectural structure is considered received by method 100 when a user selects at least one architectural structure for processing. More with respect to selecting an architectural structure is discussed with respect to FIG. 9 of this document.

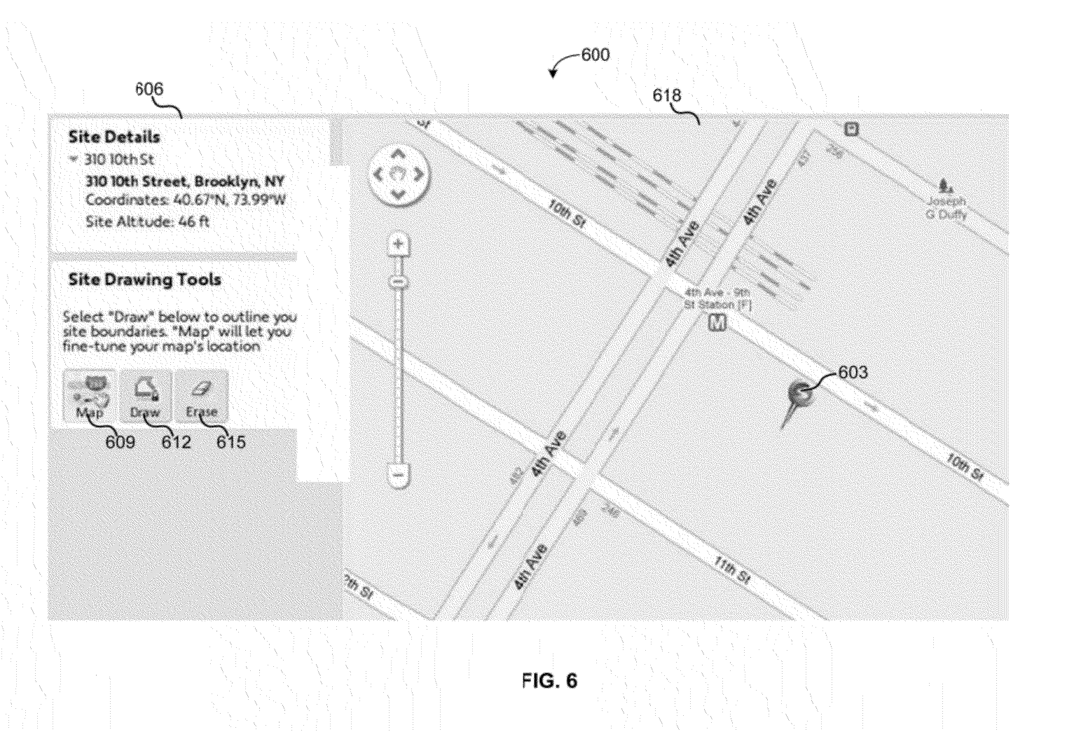

Subsequent to receiving the architectural structure, method 100 obtains the geographic location of the architectural structure at operation 106. For example, the geographic location may be obtained once a user places an architectural structure at a location on a geographic map (e.g., world map). In other examples, this may occur when a user defines a project site for the architectural structure and places the structure on the project site. Once the project site is defined, the geographic coordinates for the project site provide the geographic location of the architectural structure. More with respect to obtaining a geographic location and defining a project site is discussed later with respect to FIGS. 6-8 of this document.

Using the geographic location, operation 109 obtains location-related data regarding the geographic location. As noted above, such location-related data may include, among other things, (i) climate data (e.g., rainfall, solar patterns, prevailing winds) for the geographic location, (ii) altitude information for the geographic location, (iii) resource and utility options available at the geographic location (e.g., water source, energy source), (iv) data about surrounding and neighboring architectural structures, environmental information for the geographic location, zoning and code data at and around the geographic location, (v) demographic information for the geographic location, (vi) development information for the geographic location, and transportation options available around the geographic location. After reading this description, those of ordinary skill in the art would appreciate that other location-related data may also be utilized by an embodiment in accordance with the invention.

Method 100 continues by extracting 3D geometric data from the architectural structure at operation 112. In some embodiments, the architectural structure comprises a plane, a wall, or a fenestration (e.g., window, doorway, etc.). Accordingly, in such embodiments, the geometric data gathered is from the planes, walls, and fenestrations of the architectural structure.

In some embodiments, the method extracts the 3D geometric data from the architectural structure into an architectural structure model object that is used to store the 3D geometric data and other related data gathered from an architectural structure. For example, where the architectural structure received at operation 103 originates from a 3D concept design created using a 3D design tool, such as Google® SketchUp®, the 3D concept design (e.g., SketchUp® file) may be first parsed to extract the desired 3D geometric data of the architectural structure. In some embodiments, this parsing may be utilized to minimize the amount of geometric data that needs to be analyzed by the embodiments for a given architectural structure. For example, the parsing may filter out artifacts within the 3D conceptual design that have little to no bearing on the architectural structure's performance aspects (e.g., energy performance) being analyzed by the embodiments (e.g., steps inside a building, parked cars, and driveways would be filtered during extraction of geometric data from the 3D conceptual design), and further simplify the 3D geometric data extracted from an architectural structure, thereby reducing the analysis (i.e., computational) time.

FIG. 1B illustrates an example extraction method 150 in accordance with an embodiment of the present invention. Specifically, method 150 illustrates an example method for simplifying 3D geometric data extracted from an architectural structure stored within a 3D conceptual design (e.g., originating from a 3D design tool). Method 150 begins with operation 153, where two or more planes are merged together based on a condition. For example, two or more planes may be merged when they are adjoining planes and they are coplanar within acceptable numerical tolerance. In another example, two or more planes may be merged when they are adjoining planes have the same material textures applied to them. It should be noted that in some embodiments the conditions utilized by the method 150 are implemented as rules.

During operation 156, an external artifact is removed from the 3D geometric data based on a condition. An external artifact may, for example, be a plane external to the architectural structure (e.g., driveway, bush, fence, etc.). In some embodiments, external artifacts are those artifacts outside the architectural structure that have little to no bearing on the architectural structure's performance aspects (e.g., energy performance) being analyzed by an embodiment.

Next, during operation 159, an internal artifact is removed from the 3D geometric data based on a condition. An internal artifact may, for example, be a plane internal to the architectural structure (e.g., internal walls, stairwells, etc.). In accordance with some embodiments, internal artifacts are those artifacts inside the architectural structure that have little to no bearing on the architectural structure's performance aspects (e.g., energy performance) being analyzed by an embodiment.

At operation 162, a micro-plane is removed from the 3D geometric data based on a condition. In some embodiments, a micro-plane is a plane considered subordinate to a another plane. Depending on the embodiment, the micro-plane may be defined by the condition itself, and the condition may be user-defined. For example, a micro-plane may be defined by the percentage of total number of planes.

At operation 165, the 3D geometric data is stored within an architectural structure model object. Additionally, because some architectural structures have windows which are nested inside walls and the walls are further nested inside planes, in some embodiments the architectural structure model object comprises a data tree, such as a quadtree (i.e., a data tree with exactly four children), that can be utilized to partition two-dimensional (2D) space such that properties regarding the architectural structure can be efficiently retrieved.

Following operation 165, at operation 168 method 150 allows a user to manually add or remove a plane from the 3D geometric data as stored within the architectural structure model object. Depending on the embodiment, operation 168 may be optional and be utilized by a user to add or remove planes that preceding operations (e.g., 156, 159, 162) missed.

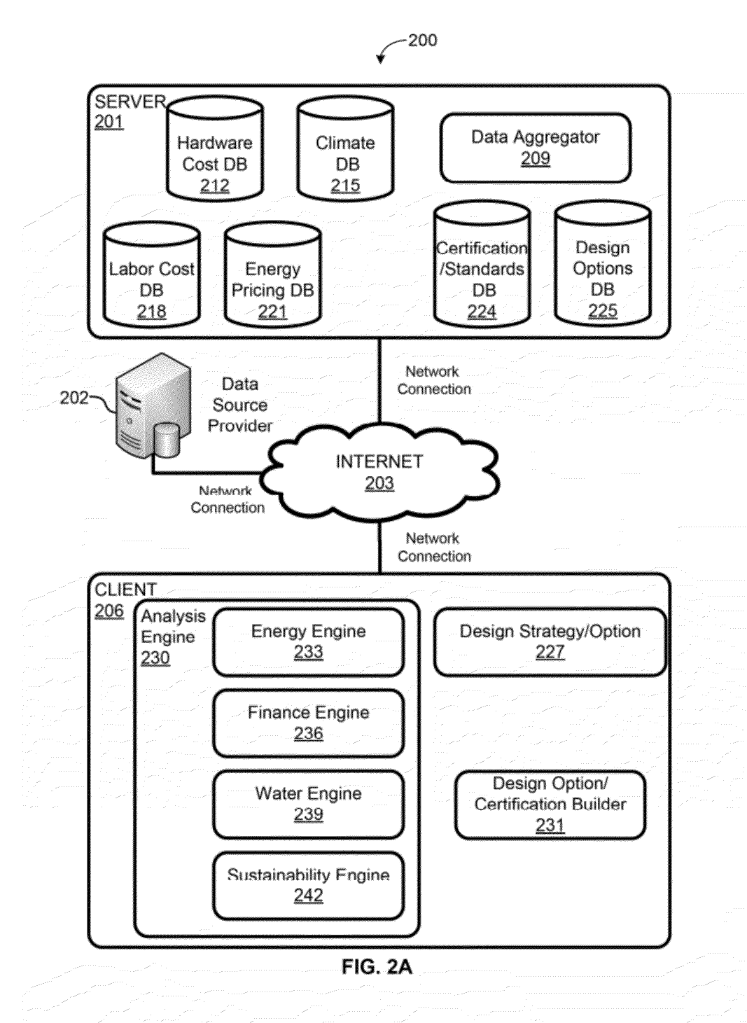

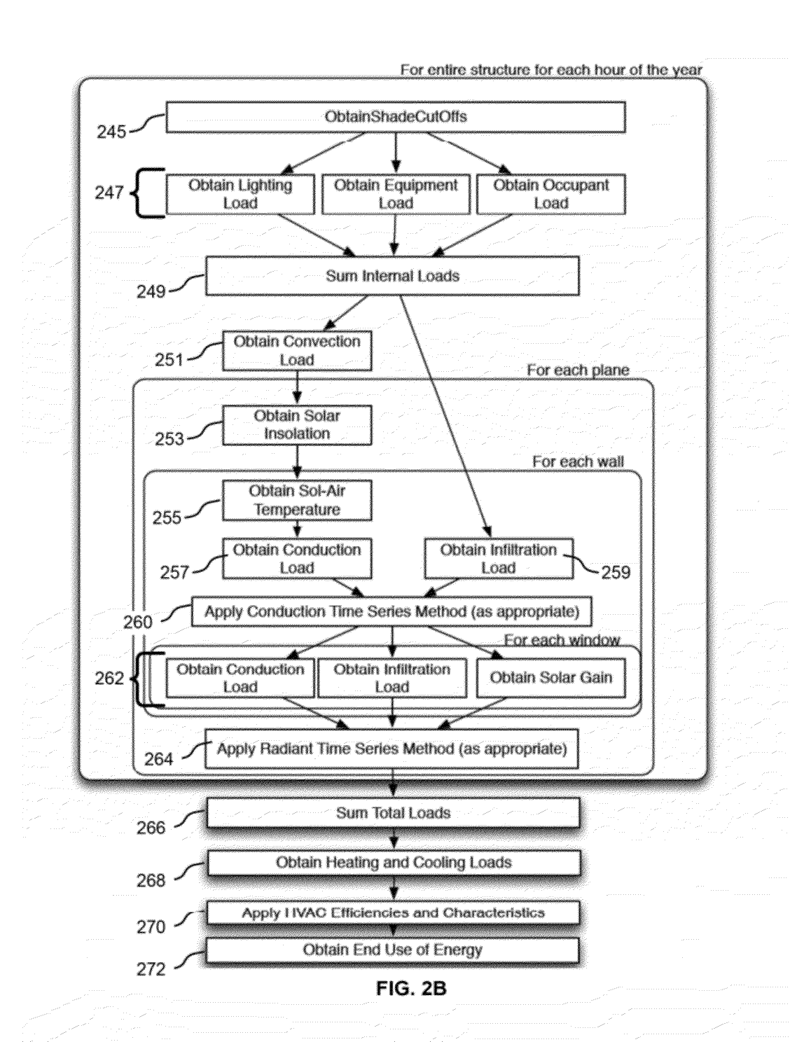

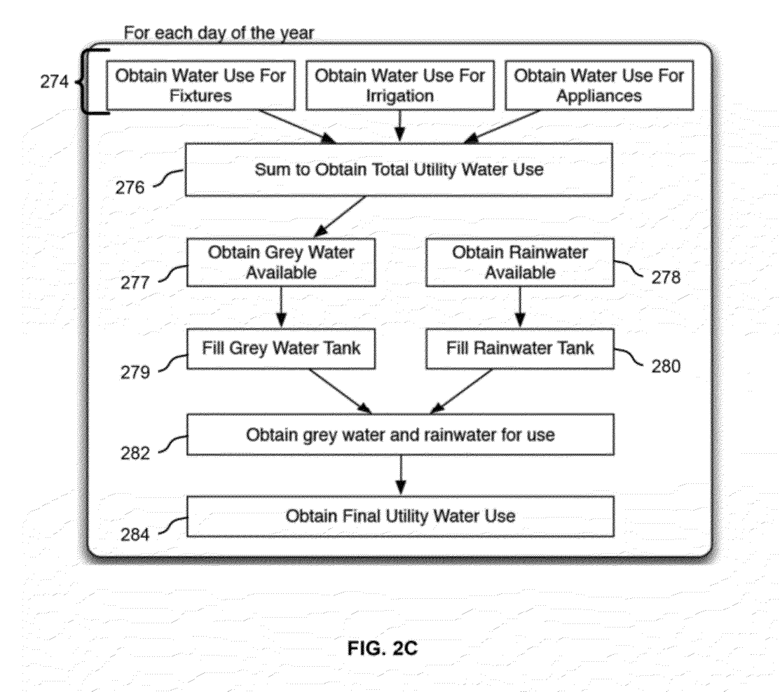

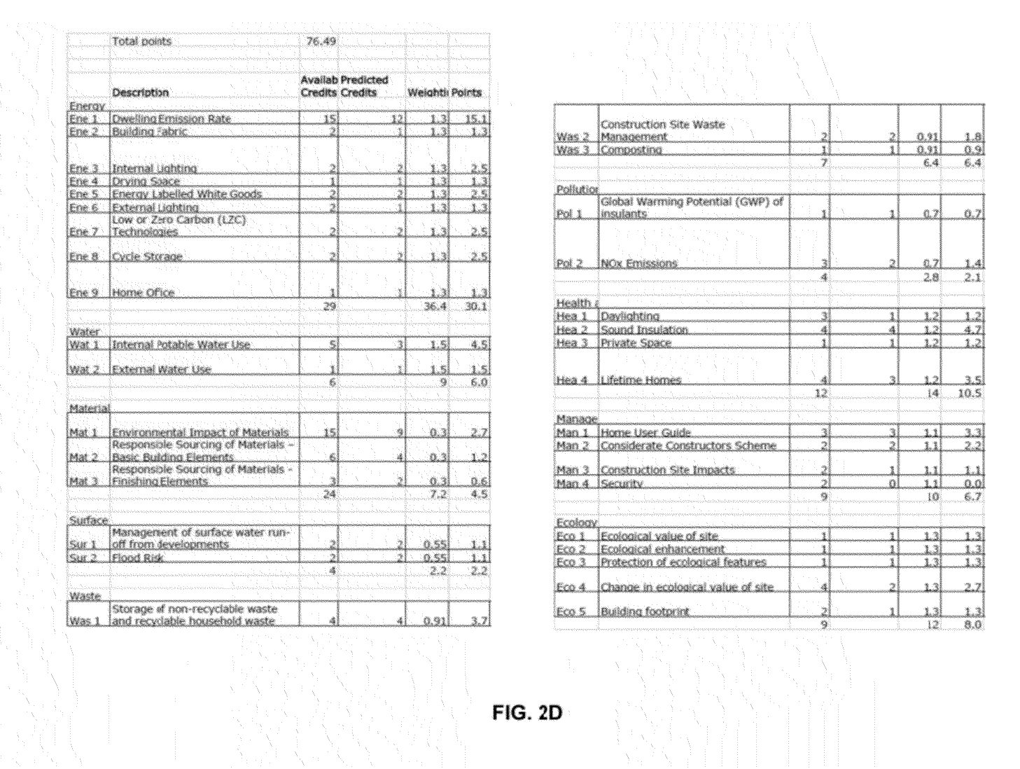

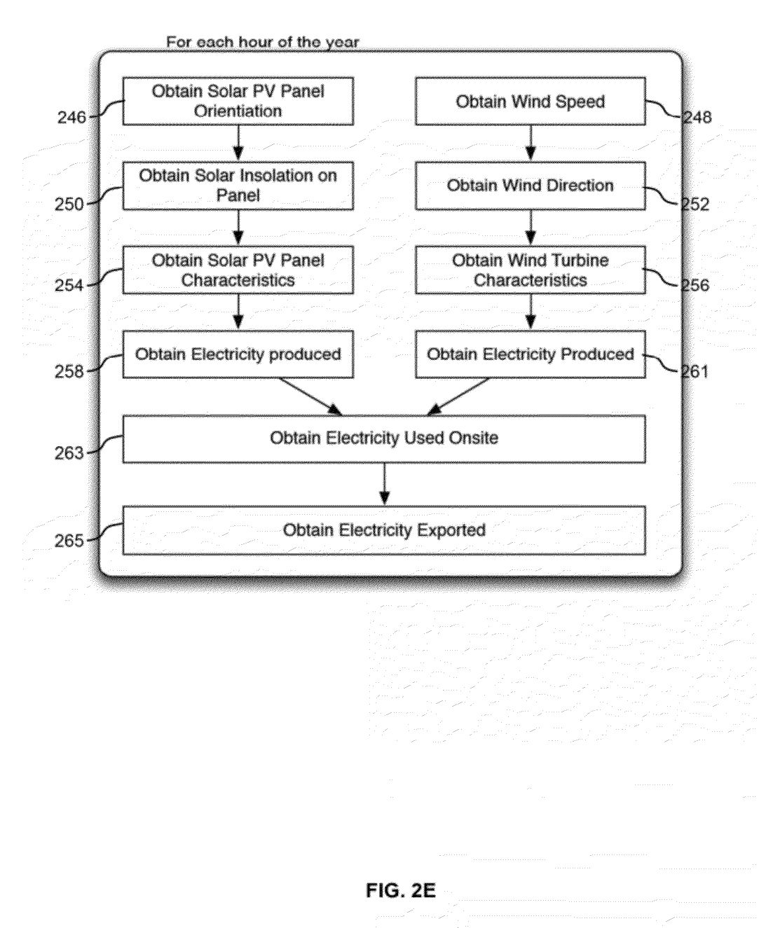

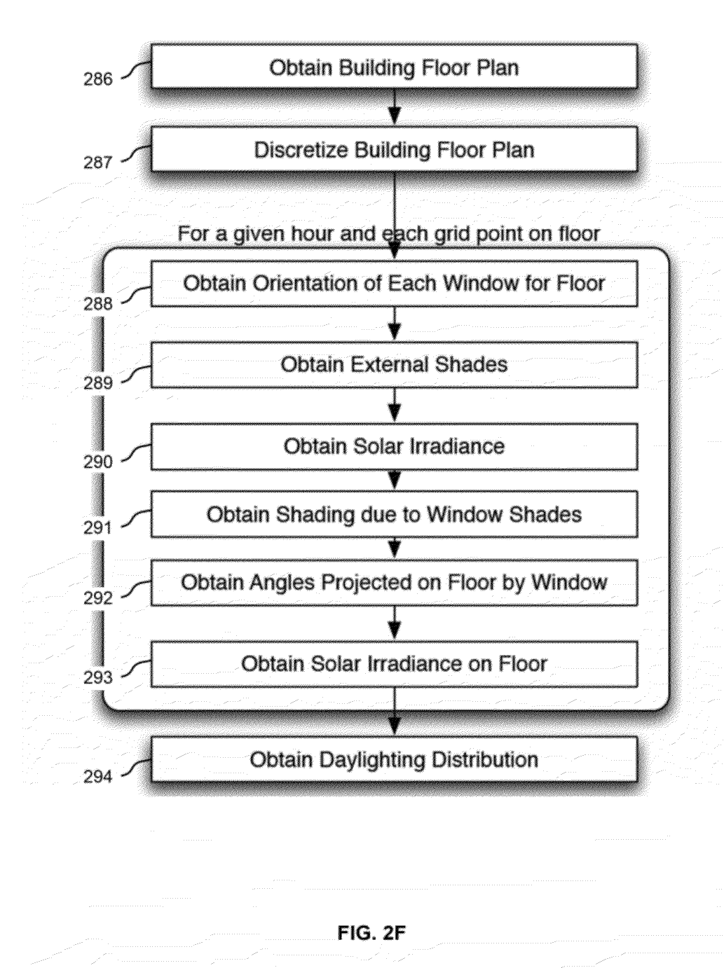

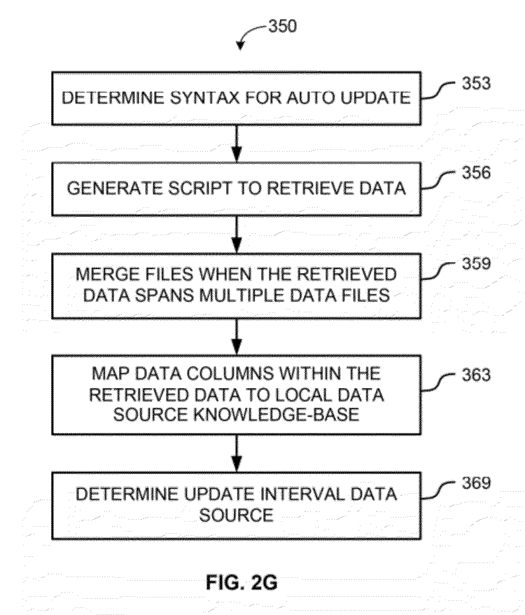

Continuing with reference to FIG. 1A, once the 3D geometric data extracted, operation 115 applies a design option to the architectural structure. As noted before, a design option may include, but is not limited to, a change to the architectural structure, to an equipment choice for the architectural structure, to an energy source choice for the architectural structure, to a water source choice for the architectural structure, to a heating choice for the architectural structure, to a cooling choice for the architectural structure, and to a construction choice for the architectural structure. In some embodiments, the application of a selected design option to a given architectural structure may be the result of a user applying the selected design option to a plurality of the architectural structures on a project site, and the given architectural structure is one of the plurality. Additionally, in some embodiments, applying a design option to an architectural structure entails mapping the design option to the 3D geometric data of the architectural structure (e.g., mapping a design option parameter to a geometric element of the architectural structure). Also, it should be noted that in some embodiments, in addition to predefined design options, the system provides user with the ability to create and apply custom design options to architectural structures as well. More with respect to applying design options is discussed later with respect to FIGS. 2, 15 and 16 of this document.

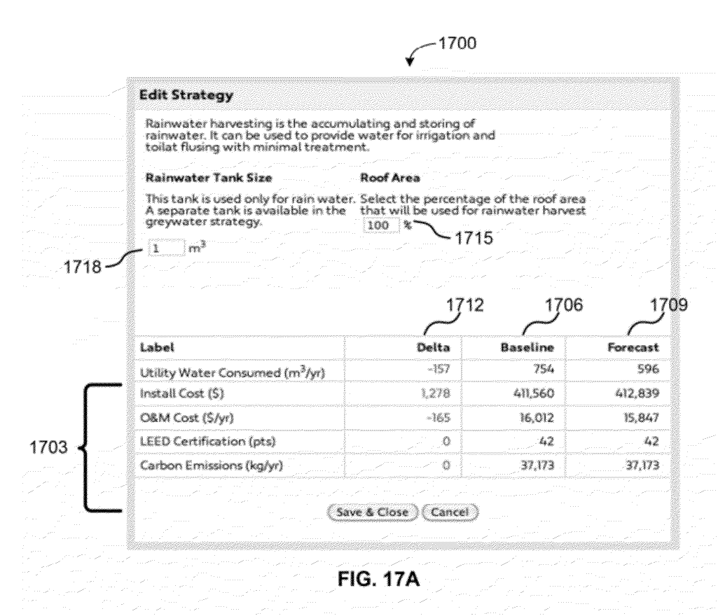

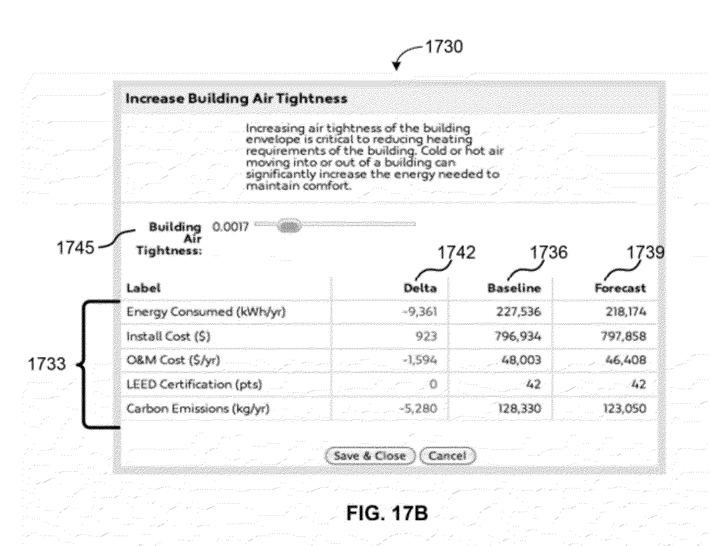

Further, design option in some embodiments may comprise a design option parameter configured to control the amount of change effectuated by the design option to the architectural structure. Effectively, such design option parameters allow a user to adjust and modify how a design option impacts an architectural structure. With respect to those embodiments using design concepts, where a design option is applied as part of a plurality of design options within a design concept, the design concept may comprise variables (i.e., design concept variables) that store the adjusted values for the parameters of design options contained therein. In doing so, the user is provided the ability to apply a preconfigured set of design options to a number of architectural structures. More with respect to adjusting design option parameters is discussed later with respect to FIG. 17 of this document.

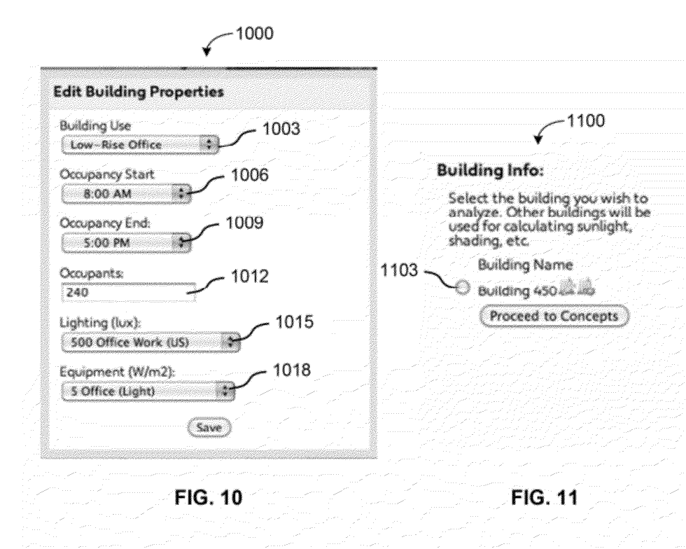

In addition to the design option parameters, in some embodiments, a user is also able to edit and adjust structure properties of an architectural structure. Structure properties include, but are not limited to, those relating to an operation of the architectural structure, a resource associated with the architectural structure, an equipment item associated with the architectural structure, or construction of the architectural structure. Specific examples of operation structure properties include occupancy, times of occupancy, room types, and principal use. Specific examples of resource structure properties include energy source options, cooling options, heating options, water options, and other utility choices. Specific examples of equipment structure properties include equipment efficiency types (e.g., coefficient of performance (COP), energy efficiency ratio (EER), seasonal EER, heating seasonal performance factor (HSPF)), lighting density (i.e., lux), equipment power density, and other fixtures used in the architectural structure. Specific examples of construction type include structure type (e.g., concrete), wall type (e.g., curtain) fenestration type (e.g., single glass window), roof type (slope frame), floor type (e.g., low weight concrete), fill in insulation (e.g., polyisocyanurate), insulation (e.g., blanket), floor finish (e.g., wood, tile), color of interior walls, thermal mass, thermal transmissivity, and reradiating properties of construction materials. More with respect to editing and adjusting structure properties is discussed later with respect to FIGS. 10, and 18-21 of this document.

Next, during operation 118, method 100 analyzes the impact of applying the design option to the architectural structure. When analyzing the impact of an applied design option, certain embodiments take into consideration the 3D geometric data of the architectural structure and the location-related data. For example, in some embodiments, analyzing the impact of a design option on an architectural structure may comprise utilizing a formula to calculate the effects of the design option on the architectural structure. For a given design option being applied to an architectural structure, a formula being used to analyze the impact of the applied design option on the architectural structure may utilize the design option parameters, location-related data, 3D geometric data, structure properties, or some combination thereof. For example, with respect to location-related data, information regarding neighboring buildings could be useful in determining if any of the buildings surrounding an architectural structure cast a shadow on the architectural structure, or alternatively, abut the architectural structure such that a wall of the architectural structure is blocked from sun light. By taking such information into account, a formula or collection of formulae being evaluated under operation 118 can more accurately determine what impacts selected heating-related and cooling-related design options have on the architectural structure.

Furthermore, when analyzing the impact of an applied design option, some embodiments are configured to make certain informed assumptions during the analysis operation. By doing so, such embodiments are capable of providing an estimated impact analysis in less amount of time than more accurate, detail-orientated embodiments (i.e., embodiments that make fewer assumptions or no assumptions when analyzing). More with respect to the analysis is discussed later with respect to FIGS. 2A-2F of this document.

At operation 121, method 100 concludes with the determination of features present in the architectural structure based on the analysis performed during operation 118. Such features include, but are not limited to, (i) energy consumption of the architectural structure, (ii) water consumption of the architectural structure, compliance of the architectural structure with a construction standard, (iii) a thermal characteristic of the architectural structure, (iv) carbon footprint of the architectural structure, (v) indoor environment quality of the architectural structure, (vi) a construction material utilized in the architectural structure, (vii) an equipment item utilized by the architectural structure, (viii) a construction cost of the architectural structure, (ix) an operational cost of the architectural structure, and (x) a maintenance cost of the architectural structure.

Further, with respect to features and compliance of building and architectural standards/certifications, some embodiments of the present invention can provide a standards/certification rating (i.e., score or points) for the architectural structures based on the impact of selected design options applied to the architectural structure. For example, in the context of sustainability, applied design options directed toward improving sustainability may affect the architectural structure's compliance or rating with respect to well-known green rating/certification systems, such as LEED®, CSH, or BREEAM. More with respect to features and certifications is discussed later with respect FIGS. 2A, 12-14 of this document.

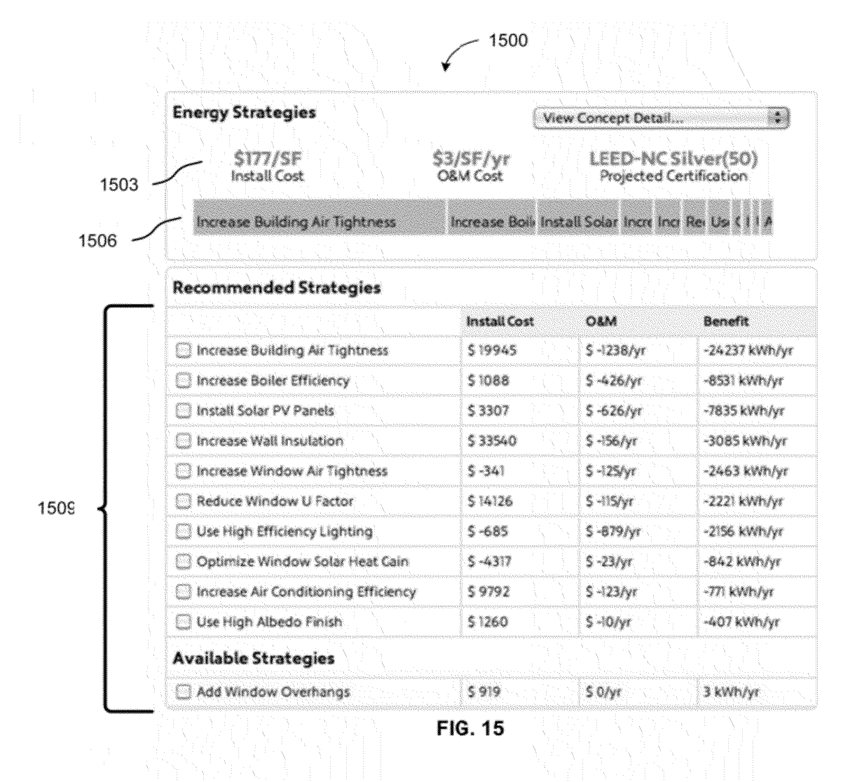

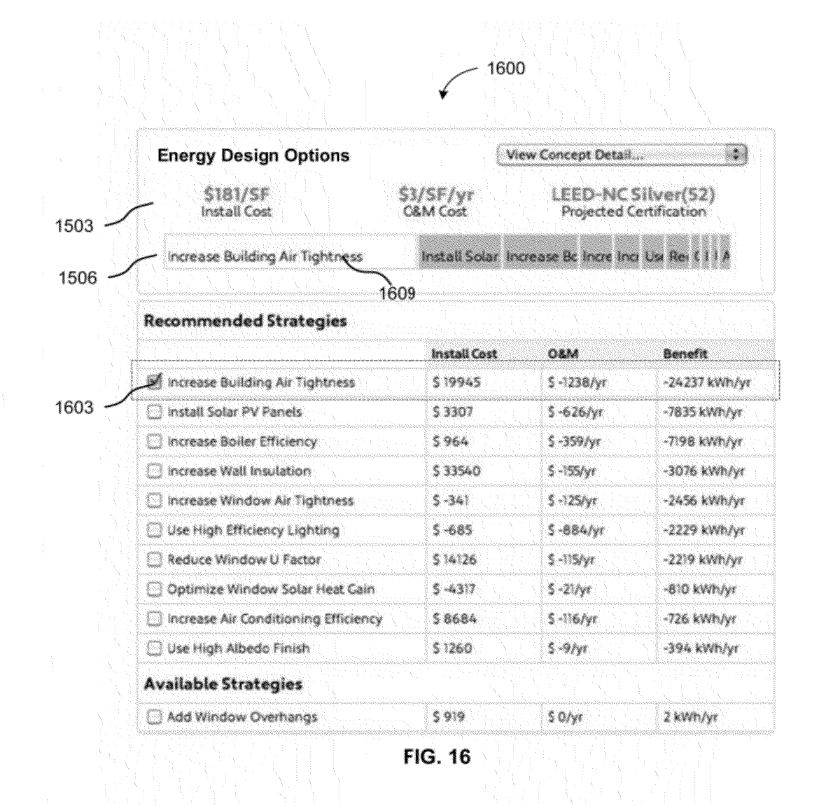

Continuing with operation 124, in some embodiments, the operations of 115, 118 and 120 are repeated, sometimes at real or near-real time, either when a user selects or deselects a design option for application to the architectural structure, or when a user changes a design option parameter. For example, if a user were to deselect a particular design option that is currently being applied to the architectural structure, operations 115, 118, and 120 would be performed again, and the results outputted by those operations would be updated accordingly. Additionally, as noted before, a change in selection of applied design options or a change in parameter for a given design option may have an impact on other design options currently being applied. By re-performing operation 115, 118, and 120, embodiments can ensure that a change to a given design option will be properly and appropriately cascaded to other applied design options impacted by the given design option. More with respect to design option selection and de-selection is discussed later with respect FIGS. 15 and 16 of this document.

FIG. 2A is a diagram illustrating an example system 200 in accordance with an embodiment of the present invention. The illustrated system 200 comprises a server 201, a client 206, and a data source provider 202, all connected to each other through the Internet 203. Although the illustrated system 200 is shown using the Internet 203 as its method for communication, it would be well understood by those of skill in the art that system 200 could be implemented entirely on a private network (e.g., intranet) or any other communication network (e.g., extranet) in accordance with other embodiments of the present invention.

The illustrated example server 201 comprises a data aggregator 209, multiple databases (hardware cost 212, climate 215, labor cost 218, and energy pricing 221) that collectively store the data source/knowledge-base information used during impact analysis of design options and feature determination (e.g., operations 118 and 120), the design options database 225 that stores available design options (both, those that are predefined and those that are user-created), and a certification/standards database 224 that stores information that utilized when evaluating an architectural structure's compliance or rating in view of a given certification or standard (e.g., LEED® score, determined as a feature of the architectural structure). Particularly, in some embodiments, the information stored on the certification/standards database 224 is utilized to map the impacts of selected design options to specific considerations of a given certification or standard.

In the illustrated embodiment, the data aggregator 209 is utilized by the server 201 to automatically scrape (i.e., gather) data for the data source/knowledge-base databases (212, 215, 218, 221), from one or more data source providers 202. Examples of data source providers from which the data aggregator 209 can collect data may include: the U.S. Department of Energy for commercial building information (e.g., electric use, natural gas use, and use intensities); the Bureau of Labor Statistics (BLS) for labor information (e.g., costs); the Environmental Protection Agency (EPA) for local environmental information; local transit databases for community transportation options and locations; the U.S. Energy Information Administration (EIA) for current energy prices and projections; and the National Oceanic and Atmospheric Administration (NOAA)/National Weather Service for climate data; and National Renewable Energy Lab for solar and temperature data information. Depending on the embodiment, once the data is retrieved from a specific source (e.g., Bureau of Labor Statistics), it is mapped and stored to an appropriate database (e.g., labor cost database 218) for retrieval during design option impact analysis operations and feature determination operations. More with respect to data aggregators is discussed later with respect to FIG. 2G.

Continuing with reference to FIG. 2A, client 206 is configured with an analysis engine 230, which is responsible for analyzing the impact of selected design options on an architectural structure in accordance with embodiments of the present invention. To assist in its analysis, the analysis engine 230 comprises an energy analysis engine 233, a finance analysis engine 236, a water analysis engine 239, and a sustainability engine 242, a design option/option module 227, and a design option/certification builder 231.

The energy analysis engine 233 is responsible for analyzing the energy impact caused on the architectural structure by the selected design options. According to some embodiments, the energy analysis engine 233 may utilize a model such as the Radiant Time Series Method, which can be performed based on: hour-by-hour simulation, complete envelope and vent analysis, daylighting and shading, customizable schedule, or Heating, Ventilating, and Air Conditioning (HVAC) sizing and usage. In additional embodiments, the energy analysis engine 233 may utilize standards and codes such as American Society of Heating, Refrigerating and Air Conditioning Engineers (ASHRAE) Standard 90.1 (Energy Standard for Buildings Except Low-Rise Residential Buildings), Standard 189.1 (Standard for the Design of High-Performance Green Buildings), or Standard 62 (Ventilation for Acceptable Indoor Air Quality); California Title 24 (California's Energy Efficiency Standards for Residential and Nonresidential Buildings); Part L United Kingdom (UK) Building Standard; PassivHaus; International Energy Conservation Code; or extended local (regional) codes. With respect to validation, analysis engine 233 may utilize eQUEST® 3.63b (DOE 2.2), which is based on ASHRAE 140 (“Standard Method of Test for the Evaluation of Building Energy Analysis Computer Programs”).

Turning now to FIG. 2B, provided is a flowchart of an example energy analysis engine (e.g., 233) in accordance with an embodiment of the present invention. As illustrated, for a given architectural structure, the energy analysis engine performs the following operations for each hour of a given year. After obtaining the shade cut offs for the given architectural structure (operation 245), the energy analysis engine obtains the lighting load, equipment load and occupant load for the given architectural structure (operation 247). These are then summed up as the internal load at operation 249.

Next, after obtaining the convection load for the given architectural structure at operation 251, the energy analysis engine obtains: the solar insolation for each plane within the given architectural structure based on the convection load (operation 253); the sol-air temperature for each wall based on the solar insolation (operation 255); the conduction load of each wall based on the sol-air temperature (operation 257); and the infiltration load of each wall, at operation 259, based on the sum of internal loads (calculated at operation 249). Using the conduction load of operation 257 and the infiltration load of operation 259, the analysis engine applies the Conductive Time Series Method to each wall as appropriate (operation 260). Operation 262 uses the results of the Conductive Time Series Method for each wall to obtain, for each window of each wall, a conduction load, infiltration load, and solar gain (operation 262). The foregoing information is then utilized in the Radiant Time Series Method to obtain the load of each plane of the architectural structure (operation 264). The resulting loads from operation 264 and operation 249 are summed up in operation 266. Next, the energy analysis engine obtains the heating and cooling loads for the given architectural structure at operation 268. Subsequently, the energy analysis engine applies Heating, Ventilating, and Air Conditioning (HVAC) efficiencies and characteristics to the obtained heating and cooling loads at operation 270, and uses the results of this application to obtain the end use of energy for the given architectural structure at operation 272.

Returning to FIG. 2A, the finance analysis engine 236 is responsible for analyzing the cost impact (e.g., operational costs, maintenance costs, monthly costs, yearly costs, installation costs) caused on the architectural structure by the selected design options. According to some embodiments, the energy analysis engine 233 may utilize models relating to payback analysis, parameterized cost, installation cost analysis, or operation and maintenance cost analysis.

Continuing with reference to FIG. 2A, the water analysis engine 239 is responsible for analyzing the water-related impacts caused on the architectural structure by the selected design options. According to some embodiments, the water analysis engine 239 may utilize a rainwater model, a greywater model, an irrigation requirements model, a stormwater model, a model based on cistern sizing, or a model based on rainwater capture area sizing.

Referring now to FIG. 2C, provided is a flowchart of an example water analysis engine (e.g., 239) in accordance with an embodiment of the present invention. As illustrated, for a given architectural structure, the water analysis engine performs the following operations for each day of a given year. At operation 274, the water analysis engine obtains the water use of fixtures, irrigation, and appliances for a given architectural structure, and sums up the total utility water usages at operation 276. From this total, based on its total water as calculated at operation 276, the water analysis engine obtains the greywater available to the given architectural structure (operation 277); this available greywater is filled into the greywater tank at operation 279. Similarly, operation 278 obtains the rainwater available to the given architectural structure, which the water analysis engine then fills into the rainwater tank at operation 280. Operation 282 obtains the total greywater and rainwater available for use based on operations 279 and 280. The water analysis engine concludes by obtaining the final utility water usage for the given architectural structure at operation 284.

Returning to FIG. 2A, the sustainability engine 242 is responsible for evaluating the compliance or rating of the architectural structure based on the impact of selected design options. According to some embodiments, the sustainability engine 242 may utilize models relating to carbon footprint analysis, embedded carbon analysis, resource mix analysis, onsite generation analysis (e.g., wind or photovoltaic-based power), or Combined Heat & Power (CHP) feasibility analysis. With respect to certification standards, in additional embodiments, the sustainability engine 242 may utilize standards and ratings based on Leadership in Energy & Environmental Design (LEED®) NC 2009, Code for Sustainable Homes (CSH), Building Research Establishment Environment Assessment Method (BREEAM), PassivHaus, or Net Zero Energy Building.

FIG. 2D is a table illustrating an example calculation of certification credit in accordance with an embodiment of the present invention. According to some embodiments of the present invention, the table of credit calculations illustrates how a credit, rating or score for a given architectural structure may be calculated by a sustainability engine (e.g., 242) in view of a given certification or standard. As illustrated, for each (energy, water, material, surface, waste, pollution, health, management, and ecology) scoring factor listed in the table, there exists an available amount of credit, a predicted amount of credit based on the analysis provided (e.g., by various analysis engines), the weight of the scoring factor to the overall calculation, and the actual points scored based on the predicted score multiplied by the scoring factor weight. In the illustrated embodiment, the table suggests that the total predicted score for the given architectural structure would be 76.49. In some embodiments, calculations such as these could be utilized by a sustainability engine when determining an architectural structure's compliance or rating with respect to a selected certificate or standard that has similar scoring factors.

Although not shown in FIG. 2A, in some embodiments the analysis engine 230 may further comprise an onsite generation analysis engine used to determine the impacts of design options relating to onsite power generation (e.g., wind or photovoltaic-based power). For example, FIG. 2E provides a flowchart of an example onsite generation analysis engine in accordance with an embodiment of the present invention. Referring now to FIG. 2E, for each hour of a given year, the onsite generation analysis engine performs the following operations. For a solar photovoltaic (PV) panel, the example onsite generation analysis engine first obtains the solar photovoltaic (PV) panel orientation (operation 246), the solar insolation on the solar PV panel (operation 250), the characteristics of the solar PV panel (operation 254), and the electricity produced by the solar PV panel (operation 258). With respect to the wind, the onsite generation analysis engine obtains the wind speed (operation 248), the wind direction (operation 252), the characteristics of the wind turbine for the architectural structure (operation 256), and the electricity produced by the wind turbine (operation 261). Subsequently, at operation 263, the onsite generation analysis engine obtains the electricity used by either the given architectural structure or, alternatively, the entire site upon which the given architectural structure resides. Using the calculated total electricity usage of operation 263, the electricity produced by the solar PV panel as calculated by operation 258, and the electricity produced by the wind turbine as calculated by operation 261, at operation 265, onsite generation analysis engine, is able to obtain the total electricity available from the onsite power generation that can be exported by the given architectural structure or the site. In some embodiments, such a calculation can be used to determine the payback period for the given architectural structure.

Additionally, although not shown in FIG. 2A, in some embodiments the analysis engine 230 may further comprise a daylighting analysis engine used to determine the impacts of design options based on daylight. For example, FIG. 2F provides a flowchart of an example daylighting analysis engine in accordance with an embodiment of the present invention. Referring now to FIG. 2F, the illustrated daylighting analysis engine begins at operation 286 by obtaining the floor plan for a given architectural structure, which is then discretized at operation 287. Then, for a given hour at each grid point on the discretized floor plan, the daylighting analysis engine obtains the following information based on the discretized floor plan: the orientation of each window for a given floor (operation 288); the external shades of the given architectural structure (operation 289); the solar irradiance (operation 420); the shading due to window shades (operation 421); angles projected on the floor by the window (operation 422); and the solar irradiance on the floor (operation 423). Based on the foregoing information, at operation 424, the daylighting analysis engine can obtain, for each grid point on the floor, the daylighting distribution for the given architectural structure.

Returning to FIG. 2A, in some embodiments, the analysis engine 230 may include further components such as an acoustic analysis engines used to determine the acoustics features of the architectural structure based on the applied design options; and a materials model used by the various analysis engines in determining the impacts of design options based on materials.

Additionally, in some embodiments, the design option/option module 227 facilitates: (i) access to design options stored on the design options database 225; (ii) the selection and de-selection of design options to be applied to an architectural structure; and (iii) parameter modification of design options. Meanwhile, in further embodiments, the design option/certification builder module 231 allows a user to create user-defined (i.e., custom) design options, design concepts, building certifications or standards that can later be applied to or evaluated against architectural structures.

Furthermore, in some embodiments, example cost model formulae such as the following may be utilized by analysis engines in accordance with the present invention:

| Component | Function (All SI Units) |
|---|---|
| Base Cost | (323 + 5 * wallType) * floorArea |
| Insulation Cost | (10.76 * 7.888 * rValue + 4.540) * totalWallArea |
| Lighting Cost | (40 − LPD)/10 * floorArea * 14.0/5 |
| Equipment Cost | 1.4 * (40 − EPD) * floorArea |
| Window Cost | (8.7 * window Area + 47.76) * window Area + |
| | 300123/(window area * window shgc) + 900143 * |
| | window rValue/window Area |
| Extemal Projections | 328 * total Shading Length |
| Cooling Equipment | 900 * maximum cooling demand * COP/3517 |
| Cost | |
| Heating Equipment | 1203.2 * COP * COP |
| Cost | |
| Water Fixture Cost | 1.6 * 30/(water closet flow * 266.66) * water closet |
| | count + 1.6 * 30/(shower flow rate * 266.66 * 60) * |
| | shower count + 1.6 * 30/(kitchen faucet flow * |
| | 266.66) * kitchen faucet count + 1.6 * 30/(lavatory |
| | faucet * 266.66 * 60) * lavatory count |
| Appliance Cost | 800 * 30/(dishwasher flow * 266.66) * dishwasher |
| | count + 800 * 30/(clothes washer flow * 266.66) * |
| | clothes washer count |
| Greywater cost | 52500/12000 * tankSizeGrey |
| Rainwater Cost | 33000/25000 * tankSizeRain |
| Irrigation Cost | 6500/95 * irrigation efficiency |

Example cost components taken into consideration by these and other cost model formulae may include, but are not limited to, the following: in terms of finish types, sub flooring, finish flooring, and interior walls; in terms of the structure, foundation type, framing, insulation, exterior, roof, and wall type; in terms of glazing, glazing type, framing type, and operable type; in terms of mechanical, electrical and plumbing (MEP), cooling, air handler, heating, plumbing, fixtures, and hot water; in terms general components, floor area, number of floors, and building size; and in terms of domestic water, fixtures, rainwater capture, plumbing, greywater storage tank, and rainwater storage tank.

FIG. 2G is a flowchart illustrating an example data aggregator method 350 for automatically scraping (i.e., gathering) data from multiple data sources in accordance with an embodiment of the present invention. In particular, in some embodiments, method 350 is configured to scrape data (e.g., location-related data or cost-related data) from data source providers (i.e., hosts) residing on a public network, such as the Internet. As noted before, some examples of data source providers include the U.S. Department of Energy, the Bureau of Labor Statistics (BLS), the Environmental Protection Agency (EPA), the U.S. Energy Information Administration (EIA), and the National Oceanic and Atmospheric Administration (NOAA)/National Weather Service.

In some embodiments, in order to initiate data scraping, a user (e.g., architect) first locates a data source provider that makes available information (e.g., location-related data or cost-related data) relevant to and utilized by analysis and determination operations (e.g., 118 and 120) in accordance with certain embodiments described herein. After locating a data source provider, and downloading a sample data source file, the user selects key columns from which data will be scraped, and creates a mapping between the data source column data to a specific database that serves as the data source/knowledge-base for certain embodiments of the present invention. Depending on the data source provider, the resulting data source file may be formatted in one of many, well-known formats, such as comma or character-separate values (CSV), or a known proprietary format.

Once the setup has been completed, at operation 353, method 350 determines the syntax based on the address or universal resource identifier (URI) (e.g., universal resource locator—URL) for obtaining data and updated data from a data source provider on an automatic basis. In some embodiments, the syntax is specifically configured to access data and updated data over a network (e.g., intranet, extranet, Internet). Upon determining the address and syntax, method 350 generates a script (operation 356) that, when performed, automatically retrieves data (e.g., scrapes or downloads) data from the designated data source provider. In some embodiments, the script is a set of instructions that, when executed by a computer system, cause the processor of the computer system to perform certain operations (e.g., automatically scrape/download data from a data source provider). Depending on the embodiment, the script may take the form of a shell script (e.g., Bourne Again Shell (BASH) script, Korn Shell (KSH) Script), interpreted script (e.g., PHP script, Ruby script, PERL script), or some compiled program (e.g., C/C++ based).

Optionally, the method 350 may perform a merge at operation 359 when the data retrieved is determined to span multiple data files and, therefore, would require a merger before its use. Next, at operation 363, method 350 creates a mapping between the data columns of the retrieved data and the data source/knowledge database utilized by certain embodiments of the present invention. For example, with respect to a data source file from the U.S. Energy Information Administration (EIA), key data columns within the data source file that contain energy pricing information will be mapped to a table within an energy pricing database (e.g., 221).

Then, at operation 369, method 350 determines the update interval for a specific data source provider. In some embodiments, this interval determination may be based on monitoring the frequency of data source updates performed by a specific data source provider, within a given period. For example, operation 369 may scrape data from a data source provider daily for one month and then, based on those daily scrapings, determine how often the data source provider updates its data on a day-to-day basis within a given month. Once the update interval has been determined, various embodiments utilize the update interval with a data aggregator (e.g., 209) to configure when the data aggregator should automatically scrape data from a specific data source provider (e.g., CRON job on a UNIX-based system).

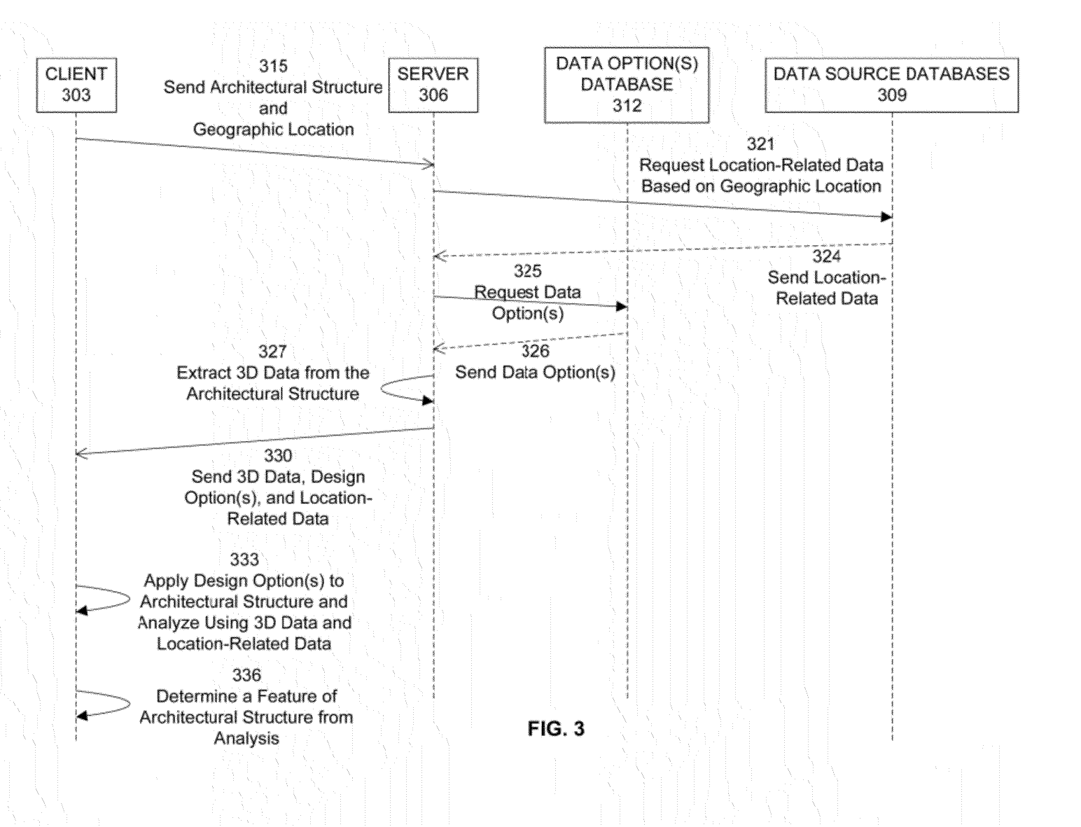

FIG. 3 is a sequence diagram illustrating the sequence of operations performed by an example system in accordance with an embodiment of the present invention. The sequence begins with the client 303 sending (operation 315) an architectural structure and its geographical location to a server 306, which is configured to receive and process such data. As discussed earlier, the server 306 may receive a 3D concept design from the client 303, from which the server 306 is able to extract one or more architectural structures for selection. About the geographic location, the client 303 may have sent the information in the form of geographic coordinates or a mailing address, which may be selected when the project site is defined.

The server 306 processes the geographic location, and requests (operation 321), from its data source databases 309, location-related data that is based on the geographic location provided. The data source databases 309 then return (operation 324) such data to the server 306. Thereafter the server 306 requests (operation 325) from the data opinions database 312 data options that are applicable to the received architectural structure. Depending on the embodiment, the data options sent (operation 326) back to the server 306 may be predefined or user-defined.

Subsequently the server extracts (operation 327) 3D geometric data from the architectural structure received by the server 306 from the client 303. As noted before, in some embodiments, the architectural structure comprises a plane, a wall, and a fenestration, from which 3D geometric data can be gathered. Additionally, in some embodiments, the server extracts may extract 3D geometric data into an architectural structure model object, as described above with respect to operation 112 of method 100.

The server 330 then sends (operation 330) the 3D geometric data, the design options, and the location-related data to the client 303. The client 303, in turn, applies (operation 333) the design options to the architectural structure using the 3D dimensional data, and analyzes the impact of those applied design options using the 3D dimensional data and the location-related data. From the analysis data that is produced (operation 333), client 303 determines (operation 336) features of the architectural structure, such as the total cost-benefit or return-on-investment for applying the selected design options to the architectural structure.

It should be noted that although the operations illustrated in FIG. 3 are shown in a specific sequence, those of ordinary skill in the art would readily appreciate that other embodiments of the invention can implement an alternate sequence of operations without departing from the scope of the present invention.

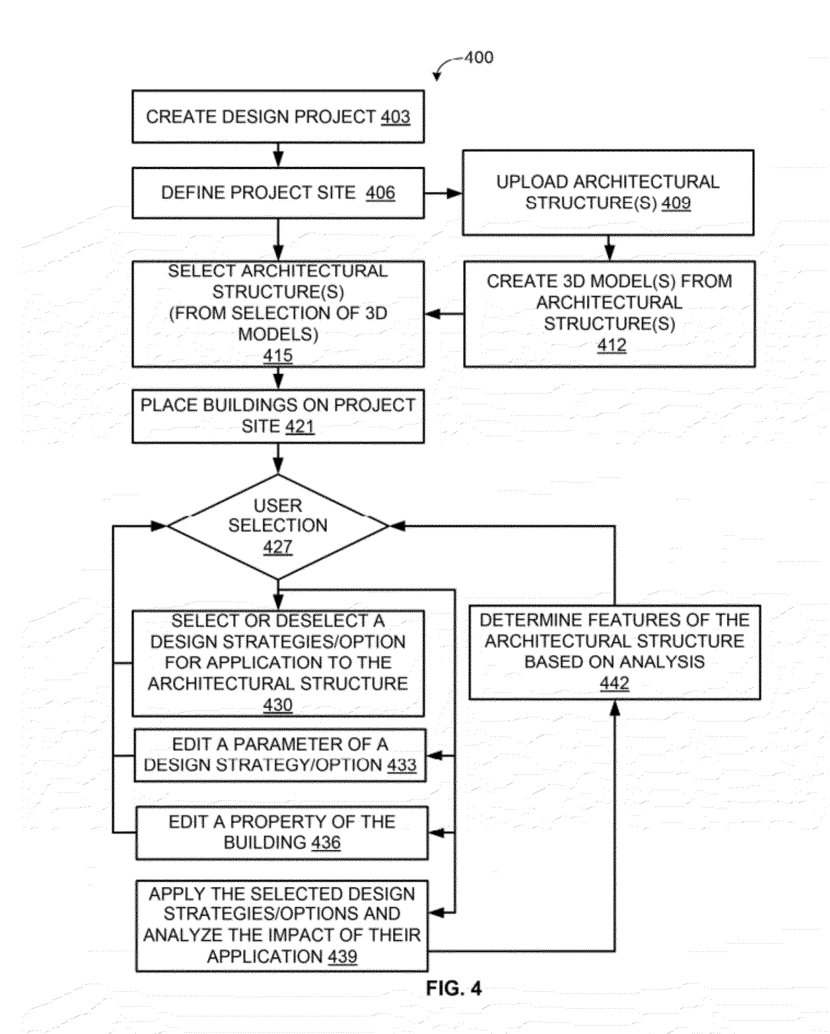

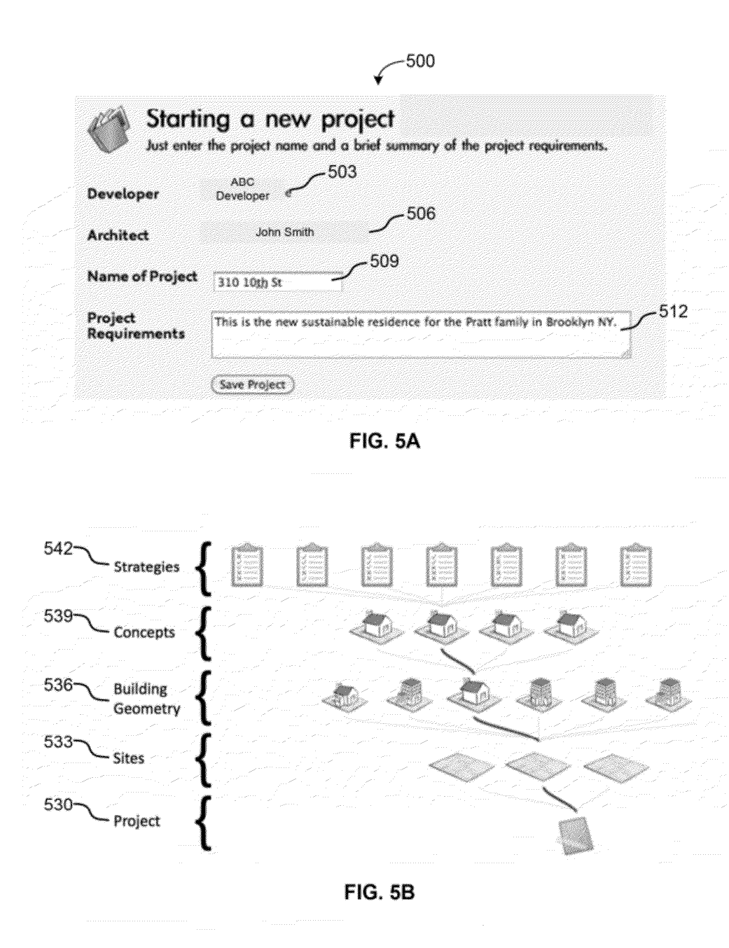

FIG. 4 is flowchart illustrating an example method 400 in accordance with an embodiment of the present invention. The method 400 begins with the creation of a design (e.g., architectural) project at operation 403 during which, in some embodiments, the project title is entered, the project developer is entered, and the architect for project is entered. In some embodiments, a brief description of the project goals/requirements may also be entered and listed. FIG. 5A provides a screenshot 500 illustrating an example implementation of operation 400, where the project developer 503 and project architect 508 are listed, and fields 509 and 512 are provided for the user's respective entry of the design project name and project requirements.

FIG. 5B is a diagram illustrating an example project 530 composition in accordance with an embodiment of the present invention. As illustrated in the diagram, project 530 comprises of one or more (project) sites 533, with each site 533 comprising building geometry 536 (i.e., three-dimensional data) for one or more architectural structures (e.g., homes, office buildings). Using the building geometry 536 of an architectural structure, some embodiments of the present invention can apply a design concept 539 to the architectural structure, where the design concept 539 comprises one or more design options/strategies 542.

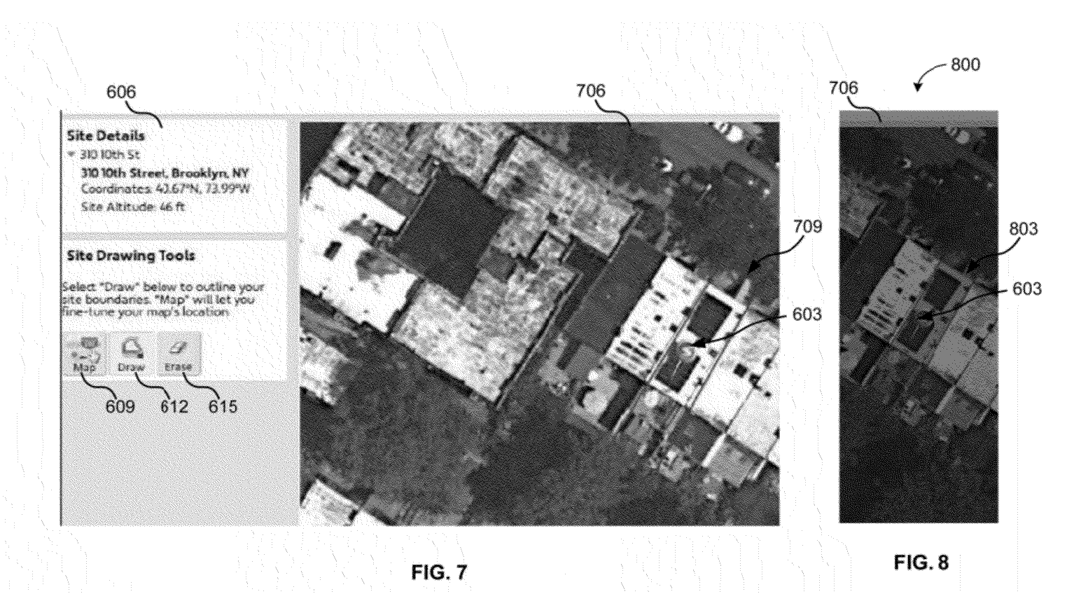

Returning to FIG. 4, at operation 406, a user defines a project site for the architectural structure. As noted before, in some embodiments, the geographic location is obtained once a user defines a project site for the architectural structure and places the architectural structure on the project site, the project site providing the geographic coordinates for the geographic location. FIGS. 6-8 provide screenshots of example implementations for defining a project site in accordance with an embodiment of the present invention. Specifically, FIG. 6 shows map 618 through which a user can select a project site 603 after selecting the map button 609. Once a project site 603 is selected, the project site detail window 606 is updated with the street/mailing address of the project site 603 (where applicable), the geographic coordinates of the project site 603, and the altitude of the project site 603. Also shown in FIG. 6 are a draw button 612 and an erase button 615, through which a user can draw the project site boundaries. More with respect to the drawings boundaries is provided with respect to FIGS. 7 and 8.

Turning now to FIG. 7, shown is an example interface configured to allow a user define a project site. Similar to FIG. 6, the example interface comprises a project site detail window 606, a map button 609, a draw button 612, and an erase button 615. Additionally, the interface comprises an aerial image map 706 of the project site 603. In this screenshot example, the user has already begun drawing a project site boundary 709 around the project site. FIG. 8 shows the aerial image 706 with the project site boundary 709 completed, and the project site 803 filled in to visually indicate that its definition has completed.

Continuing with FIG. 4, after defining the project site at operation 406, a user may choose to upload (409) one or more architectural structures (e.g., buildings) to a system in accordance with one embodiment of the invention, which results in the creation of a 3D model for each the architectural structure at operation 412, or select (415) which architectural structures from the 3D models they wish to add to the project site. If the user selects an architectural structure at operation 415, they subsequently place the architectural structure on the project site at operation 421. Moving to FIG. 9, screenshot 900 illustrates a selection interface 906 and 3D model preview window 909, from which a user may select an architectural structure to add to the project site. Interface 906 provides a listing 903 of the available architectural structures from which a user may select and add to a project site. As shown, through selection interface 906, a user can add one or more buildings to the project site at a given time.

With continued reference to FIG. 4, once an architectural structure is added to the project site, the structure may be placed or oriented on the project site at operation 421. Subsequently, a user selects (427) from one of the following: (a) select or deselect a design strategies/option for application to the architectural structure (430), (b) edit a parameter of a design strategy/option (433), (c) edit a property of a building (436), (d) apply the selected design strategies/options to the architectural structure and analyze their impact on the architectural structure (439). Once a user chooses to apply the selected design options to the architectural structure and analyze their impact, the features of the architectural structure are determined at operation 442, based on the analysis performed during operation 439, and the results dependent on those features are updated.

FIG. 10 is a screenshot 1000 illustrating an example of operation 436 for editing a building (i.e., structure) property in accordance with an embodiment of the present invention. In the illustrated example, the building (i.e., structure) properties that can be edited by the user include building use 1003, occupancy start time 1006, occupancy end time 1009, occupancy number 1012, lighting density (lux) 1015, and equipment density (W/m2) 1018.

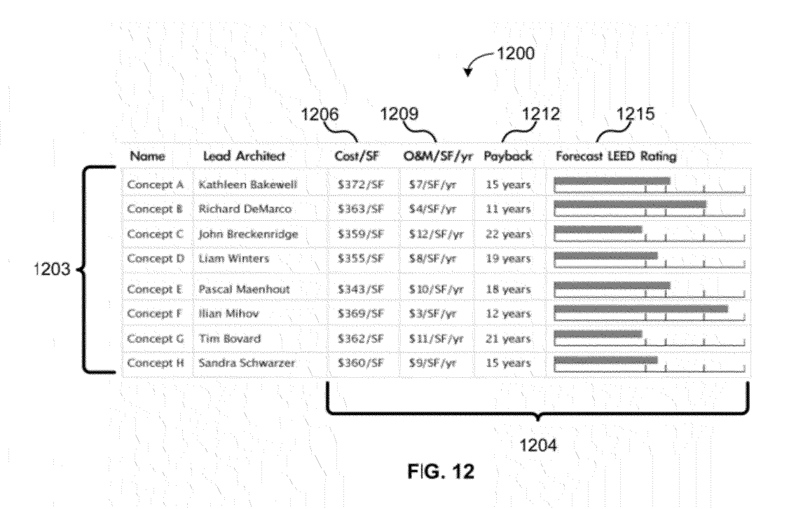

FIG. 11 is a screenshot 1100 illustrating an example interface 1103 for selecting a building (i.e., architectural structure) to be analyzed in accordance with an embodiment of the present invention. As noted in the Figure, in some embodiments, when a single building (i.e., architectural structure) is selected for analysis, the other buildings (i.e., other architectural structures) on the project site not targeted for analysis will be considered and utilized in analyzing the impact of selected design options on the architectural structure.

FIG. 12 is a screenshot 1200 illustrating an example report on design concepts applied to an architectural structure in accordance with an embodiment of the present invention. In particular, for some embodiments, results such as those shown in FIG. 12 are produced after a determination of features has been performed (e.g., 442). In the illustrated report, a listing of design concepts (i.e., Concept A-H) applied to one or more architectural structures is displayed 1203. Accompanying the listing of design concepts 1203 are the resulting features 1204 from each of the design concepts. The features shown include cost per square foot 1206 for implementing the design concept shown, the operational and maintenance cost 1209 after the design concept is implemented, the payback period in years before the design concept pays for itself 1212, and a forecast on certification rating 1215 as a result of applying the design concept. In this particular example, the projected certification rating 1218 for applying design Concept A to the buildings (i.e., architectural structures) is listed as LEED® NC: 44-Certified.

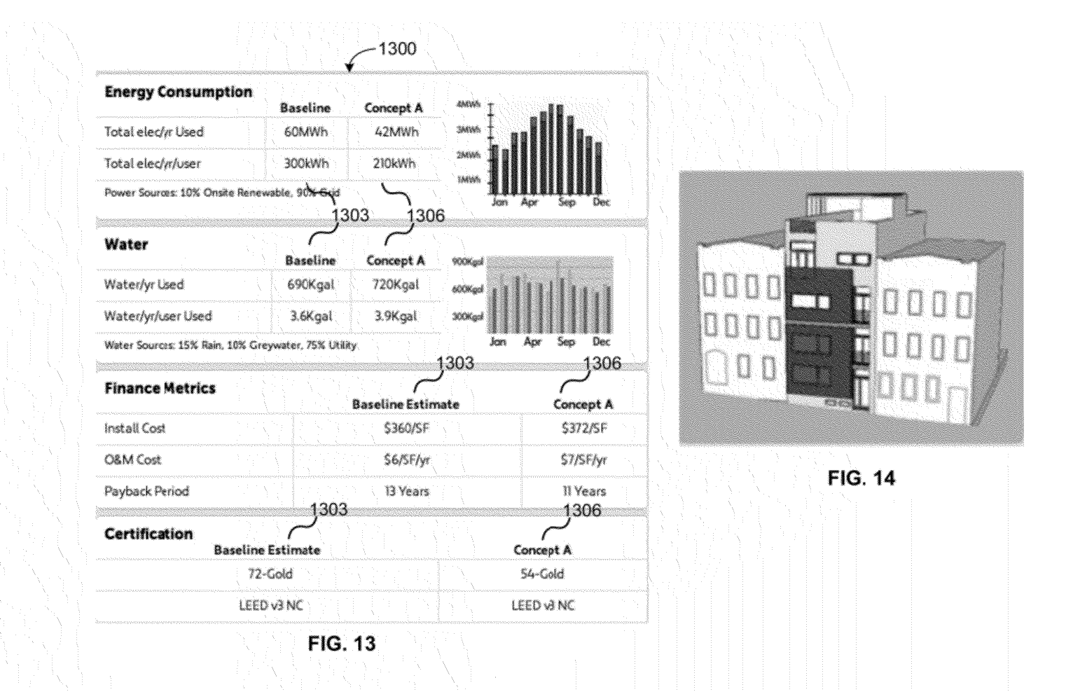

FIG. 13 is a screenshot 1300 illustrating an example summary performance report on an architectural structure being analyzed under a design Concept A in accordance with an embodiment of the present invention. As illustrated, energy consumption and water consumption per a year and per a user for the architectural structure are provided under two conditions: (1) when no design options are being applied 1303 (i.e., Baseline); and (2) when design options within design Concept A are being applied 1306. Similarly, finance metrics for the architectural structure are also provided with respect to install cost, operation and maintenance cost, and payback period under the two conditions. The same is provided with respect to the architectural structure's certification score/points and rating. In some embodiments, reports such as the one illustrated in FIG. 13 may be accompanied with a preview of a three-dimensional model that is being analyzed. FIG. 14 is a screenshot illustrating an example of such a three-dimensional model.

FIG. 15 is a screenshot 1500 illustrating an example overview of energy design options 1509 that may be applied to an architectural structure in accordance with an embodiment of the present invention. Illustrated in the top field 1503 are the install cost per square feet for the selected options, operation and maintenance cost per a year for the selected options, and a projected certification rating based on the application of select design options. As shown, the values shown reflect the effects of other design options that are currently being applied on the architectural structure. Also displayed is a scale 1506, which provides visually indication of which energy design strategies/options have the largest benefit on the architectural structure (i.e., the larger the block the larger the benefit). In some embodiments, the design options may be listed in accordance with their rank or priority, based on such considerations as their benefit, cost, or overall impact to the architectural structure.

FIG. 16 is a screenshot 1600 that illustrates an example of an effect of applying an energy design option shown in FIG. 15. Specifically, FIG. 16 illustrates an example of how screenshot 1500 changes when the “Increase Building Air Tightness” design option 1603 is selected by a user. As shown, once option 1603 is selected for application, the value for install cost per square foot increases based on the install cost of option 1603, but the value for operation and maintenance cost remains the same. In addition, due to the energy savings per year that results from applying option 1603, the projected LEED® certification rating for the architectural structure increases by two points (i.e., from 50 to 52). Additionally, for easy visual indication of which energy design strategies/options are currently selected and which are providing the most benefit, the scale 1506 has been visually flagged at 1609 to indicate that the “Increase Building Air Tightness” design option 1603 is currently implemented. As described above, in some embodiments, the value updates reflected in FIG. 16 may be facilitated by the reapplication of all selected design options, reanalysis of impacts caused by the selected design options, and determination of features based on that analysis (e.g., operation 115, 118, and 120 of FIG. 1A) after the selection of option 1603.

FIG. 17A is a screenshot 1700 illustrating an example operation for editing a design option parameter in accordance with an embodiment of the present invention. In particular, the illustrated design option concerns rainwater harvesting as a specific water source choice for a given architectural structure. As shown, the parameters available for edit for the rainwater harvesting design option include enabling the rainwater harvesting 1718 for irrigation and toilet flushing purposes, and setting the percentage of the roof area 1715 that would be utilized for rainwater harvesting. To better inform the user on the impacts of the design option, features 1703 (i.e., utility water consumed, install cost, operation and maintenance cost, LEED® certification rating, and carbon emissions) of the architectural structure based on the rainwater design option are provided to the user. Specifically, the features 1703 are shown in terms of the rainwater design option not being applied 1706 (i.e., Baseline impact when the design option is not applied), in terms of the rainwater design option being applied 1709 (i.e., Forecast impact of the design option being applied), and in terms of the delta between the two 1712 (i.e., the benefit or detriment).

FIG. 17B is a screenshot 1730 illustrating an example operation, in accordance with an embodiment of the present invention, that edits a design option parameter relating to building air tightness. As depicted by screenshot 1730, the example operation allows a user to modify the building air tightness ratio 1745 of an architectural structure. For the user's information, the impacts of the building air tightness design option on the architectural structure are presented as features 1733 (i.e., energy consumed, install cost, operation and maintenance cost, LEED® certification rating, and carbon emissions). Similar to FIG. 17A, the features 1733 are shown in terms of the building air tightness design option not being applied 1736 (i.e., Baseline impact when the design option is not applied), in terms of the building air tightness design option being applied 1739 (i.e., Forecast impact of the design option being applied), and in terms of the delta between the two 1742 (i.e., the benefit or detriment).

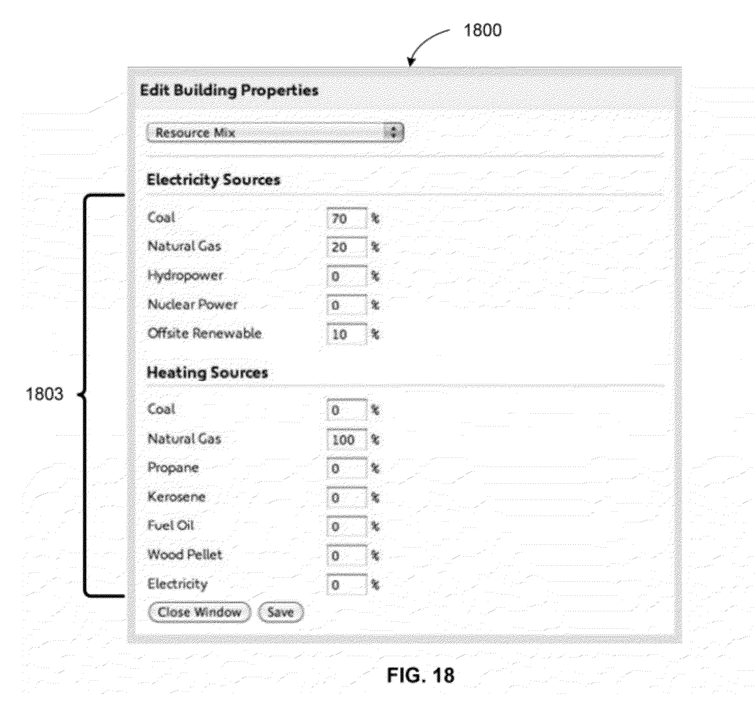

Referring now to FIGS. 18-21, provided are screenshots illustrating example operations for editing various structure properties in accordance with an embodiment of the present invention. As described above, once a design option parameter is edited, a structure property modified, or a design option selected or deselected, certain embodiments of the present invention are configured to reapply the selected design options to the architectural structure with the structure property changes, reanalyze the impact of applying the design options to the architectural structure, and re-determine the features of the architectural structure based on the analysis operation.

With respect to resource structure properties, fields 1803 of FIG. 18 allow a user to determine the mix of electricity sources and heating sources they want to utilize for the architectural structure. For example, as illustrated in FIG. 18, a user may set the resource structure properties such that energy sources powering the architectural structure is 70% coal-based, 20% natural gas-based, and 10% offsite-renewable, and such that heating sources for the architectural structure are 100% provided by natural gas. Upon committing these changes to the system (e.g., save), certain embodiments of the present invention are configured to reapply to the architectural structure all the selected design options along with the changed resource structure properties, to the architectural structure, reanalyze the impact of applying the design options to the architectural structure, and re-determine the features of the architectural structure based on the analysis operation.

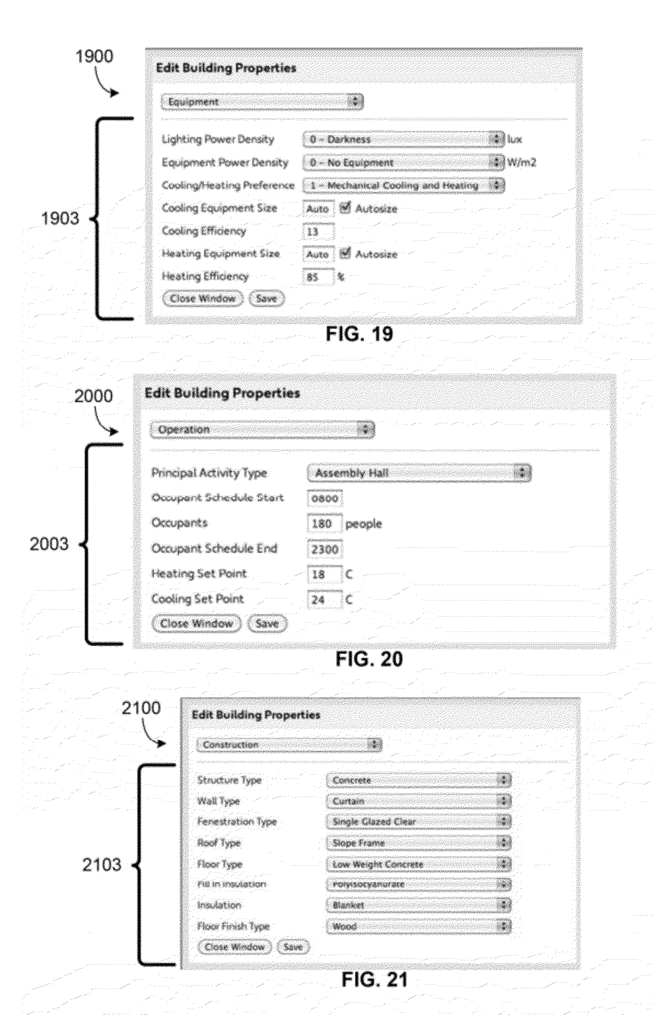

Likewise, for equipment structure properties, interface 1903 of FIG. 19 allows a user to change the light power density, equipment power density (W/m2), cooling and heating preferences, cooling equipment size, cooling efficiency, heating equipment size, and heating efficiency. As shown in FIG. 19, the user has chosen darkness of lighting power density, no equipment for equipment power density, mechanical cooling and heating for cooling/heating preference, autosizing for cooling equipment, cooling efficiency Seasonal Energy Efficiency Ratio (SEER) of 13, autosizing for heating equipment, and heating efficiency at 85%. Similar to the resource structure properties of FIG. 18, once the changes to the equipment structure properties have been committed to the system, certain embodiments of the present invention are configured to reapply to the architectural structure all the selected design options along with the changed equipment structure properties, reanalyze the impact of applying the design options to the architectural structure, and re-determine the features of the architectural structure based on the analysis operation.

In terms of operation structure properties, similar to FIG. 10, interface 2003 of FIG. 20 provides a user with the ability to set the principal activity type of the architectural structure (e.g., assembly hall, commercial building, and retail sales), occupant schedule start, occupant schedule end, and number of occupants. Unlike FIG. 10, interface 2003 also allows a user to set the heating set point and cooling set point. For example, as illustrated in FIG. 20, the user has chosen the architectural structure's principal activity type to be an assembly hall, the occupant schedule start to be 8 AM, the occupant schedule stop to be 11 PM, the occupancy to be 180 people, the heating set point to be 18° C., and the cooling set point to be 24° C. As with FIGS. 18 and 19, when these changes to the operation structure properties are committed to the system, certain embodiments of the present invention are configured to reapply to the architectural structure all the selected design options along with the changed operation structure properties, reanalyze the impact of applying the design options to the architectural structure, and re-determine the features of the architectural structure based on the analysis operation.

Turning now to FIG. 21, in terms of construction structure properties, example interface 2103 is provides a user with the ability to set the structure type, wall type, fenestration type, roof type, floor type, fill in insulation type, insulation type, and floor finish type. For example, in FIG. 21, the user has selected concrete for structure type, curtain for wall type, single glazed clear for fenestration type, slope frame for roof type, low weight concrete for floor type, polyisocyanucrate for fill in insulation type, blanket for insulation type, and wood for floor finish type. Once a user commits these changes to the construction structure properties, certain embodiments of the present invention are configured to reapply to the architectural structure all the selected design options along with the changed construction structure properties, reanalyze the impact of applying the design options to the architectural structure, and re-determine the features of the architectural structure based on the analysis operation.

It should also be noted that the foregoing list of structure properties is in no way limiting; one of ordinary skill in the art after reading this description would appreciate that other structure properties may be utilized in accordance with embodiments of the present invention.

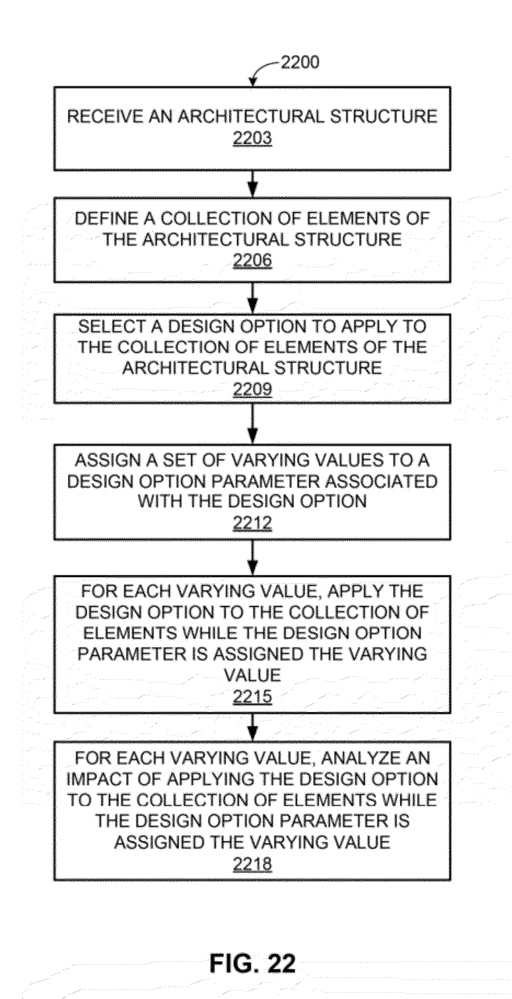

FIG. 22 provides a flowchart illustrating an example method 2200 for performing parametric analysis on an architectural structure in accordance with an embodiment of the present invention. The method 2200 begins at operation 2203, where an architectural structure is received for analysis. In some embodiments, the architectural structure may first be created on a client and then uploaded to a server that performs that architectural structure analysis. For example, the architectural structure may be created in the form of a design model, which may comprise three-dimensional (3D) data describing the structure and elements of the architectural structure (i.e., describing the geometry of the architectural structure). The design model may be contained in a 3D design tool file, such an AutoCAD® file or a Google® SketchUp® file, which once uploaded to the server can be accessed by an embodiment to perform architectural structure analysis.

For various embodiments, the architectural structure may also be created on the server remotely from the client. For example, a user at the client may access the server through a website comprising a plugin (e.g., Google® SketchUp® plugin) that enables the user to create and/or modify a design model of the architectural structure residing on the server, and then store the created/modified design model for subsequent architectural structure analysis.

In operation 2206, a collection of elements of the architectural structure may be defined. Depending on the embodiment, elements of the architectural structure may include, without limitation, walls, festrations, façade, and structural arrangement. In some embodiments, operation 2206 may enable application of a specific design option to one or more particular elements (i.e., a collection of elements) of the architectural structure, without the need of having the design option apply to the entirety of the architectural structure. Thereafter, the architectural structure as a whole can be analyzed for impacts resulting from the application of the specific design option to the one or more elements.

In various embodiments, a user may define a collection of elements of the architectural structure while a design model of the architectural structure is being created, or after the design model has already been created. Generally, a user can define the collection through a graphical user interface (GUI), possibly that of an architectural design tool. In some instances, the user may define collections of elements using the architectural design tool that was used to create the design model of the architectural structure.

During operation 2209, one or more design options may be received for application on the collection of elements of the architectural structure. Depending on the embodiment, the design options may be received by way of user selection or by way of a predetermined set of design option selection stored in a computer file. As noted herein, examples of design options may include changes to orientation of building, size of fenestrations of the architectural structure, wall insulation, glazing on windows, wall conductance, and the like.

At operation 2212, a set of varying values may be assigned to a design option parameter associated with the one or more design option selected during operation 2209. For example, where a design option—design option A—is to be applied to the architectural structure for impact analysis, the design option parameter associated with design option A (i.e., design option parameter A) may be assigned a set of varying values comprising the values of 1, 2 and 3 (i.e., {1, 2, 3}), thereby resulting in design option A being applied to the architectural structure in a parametric manner.

As noted herein, values assigned to a design option parameter may control the effects of an associated design option on an architectural structure. A set of varying values may comprise one or more unique or non-unique values. Generally, a set of varying values differs from a static value in that once a static value is assigned to a design option parameter, the static value remains the same for that design option parameter (e.g., between analysis iterations) until such time as the user facilitates a change in the static value (e.g., manually or by way of a seed value template of values, which is discussed below). In contrast, once a set of varying values is assigned to a design option parameter, the design option parameter may be assigned any value from the set of varying values as a design option associated with the design option parameter is applied to the architectural structure. The particular value to be selected from the set of varying values and assigned to the design option parameter may change from analysis iteration to analysis iteration. For example, the particular value selected and assigned to the design option parameter may depend on the current assignment combination being applied on the set of design option parameters by the current analysis iteration being performed on the architectural structure.

Depending on the embodiment, the set of varying values may be defined by a range of values and an associated interval value (i.e., step value, or pre-determined delta) that determines from the range one or more values in the set of varying values. For example, design option parameter A may be assigned a range 2 to 10 with an associated interval value of 2, thereby resulting in the following set of varying values: {2, 4, 6, 8, 10} (assuming the range includes the minimum and maximum values). In some embodiments, the set of varying values may be defined by a formula or algorithm that determines one or more values in the set of varying values. For instance, design option parameter A may be assigned an algorithm that randomly generates values base don a seed value. Those of skill in the art will appreciate that the formula or algorithm may be those known in the art.

To save time and increase user convenience, during setup of a parametric analysis on an architectural structure), a default set of varying values may be received for a particular design option parameter (or a particular type of design option parameter) via a max/min template of values. Further, a default static value may be received for a particular design option parameter (or a particular type of design option parameter) from a seed value template of values. Once a design option parameter is assigned a default static value or default set of values from a template of values, a user may adjust such the static value or set of values as they wish.

In operation 2215, for each current varying value from the set of varying values, the design option is applied to the collection of elements while the design option parameter associated with the design option is assigned the current varying value (e.g., through via collection of elements). Then, during operation 2218, for each current varying value from the set of varying values, the architectural structure is analyzed for impacts caused by the application of the design option while the design option parameter is assigned the current varying value. Depending on the embodiment, the impact analysis of the architectural structure may involve some or all of the architectural structure.

Accordingly, in the example where design option A is to be applied with design option parameter A being assigned the set of varying values {1, 2, 3}, the method 2200 may apply, and subsequently analyze the impact of, design option A on the architectural structure three times as a consequence of the three different assignment scenarios. Specifically, during one analysis iteration design option parameter A is assigned the value of 1, during another analysis iteration design option parameter A is assigned the value of 2, and during another analysis iteration design option parameter A is assigned the value of 3. During operation 2215, design option A may be applied to each element in the collection of elements. Further, during operation 2218, either some or all of the architectural structure may be analyzed for an impact caused by the application of design option A to the architectural structure.

Though FIG. 22 is shown and described in the context of collections of elements, those skilled in the art will appreciate that the method 2200 may also be performed on an architectural structure as a whole. Additionally, while FIG. 22 is shown to apply and analyze the architectural structure for a single design option and a single design option parameter, those skilled in the art will appreciate that this does not preclude some embodiments from using two or more design options when performing operations, where each design option having one or more associated design option parameters.

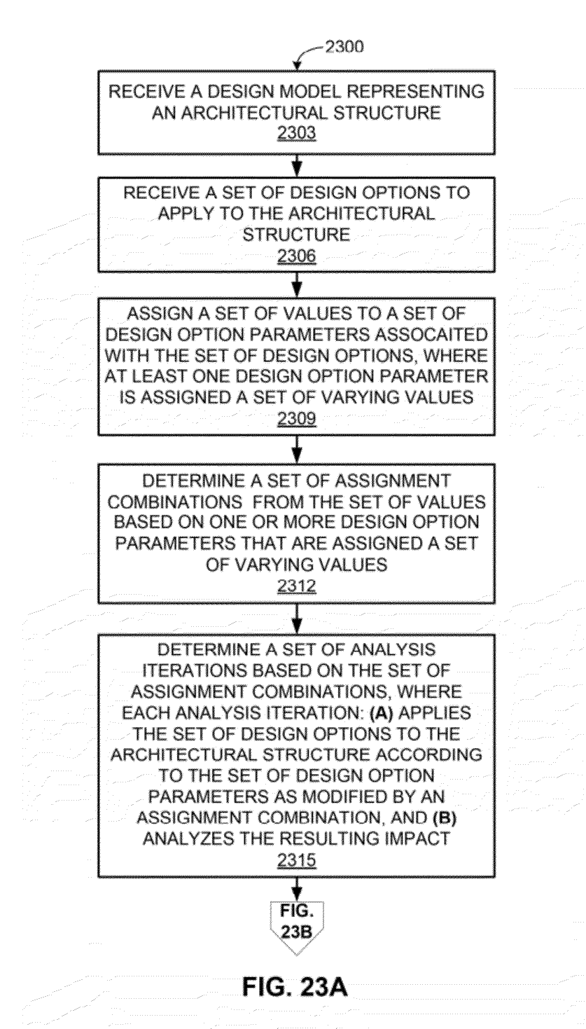

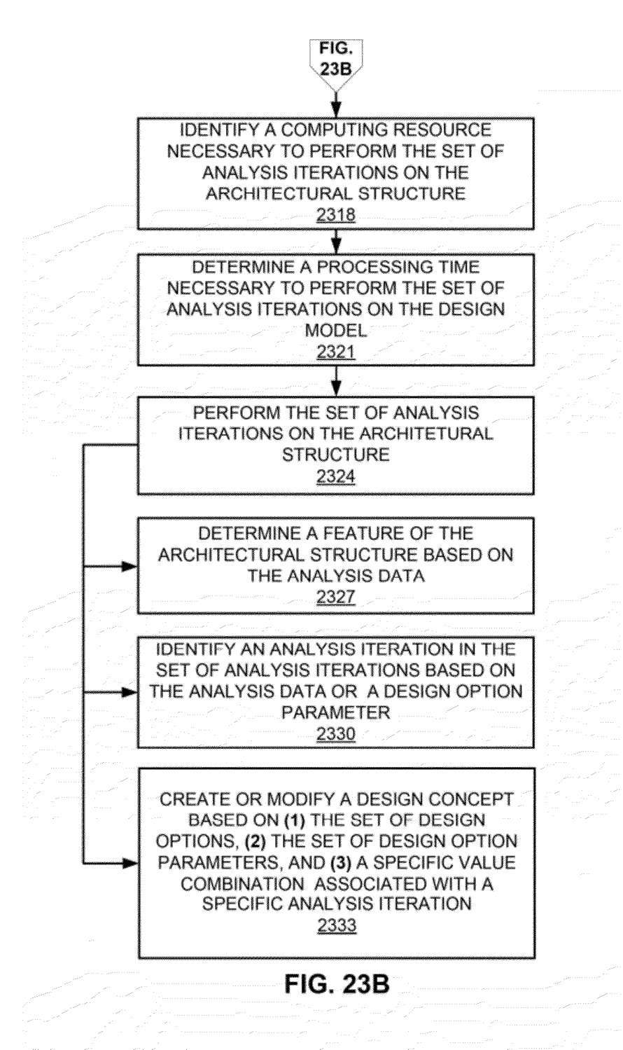

FIGS. 23A-23B provide a flowchart illustrating an example method 2300 for performing parametric analysis on an architectural structure in accordance with an embodiment of the present invention. The method 2300 begins at operation 2303, where a design model representing an architectural structure is received for analysis. In various embodiments, the design model may first be created on a client and then uploaded to a server that performs that architectural structure analysis. The design model may comprise three-dimensional (3D) data describing the structure and elements of the architectural structure. The design model may be contained in a design tool file, such a Google® SketchUp® file, which once uploaded to the server can be accessed to perform architectural structure analysis.

In operation 2306, a set of design options may be received that is to be applied to the architectural structure. In some embodiments, the set of design options may be received as one or more user selections of design options. Additionally, in some embodiments, a listing of design options may be presented to the user to facilitate the user selection. For example, a listing of design options A-F could be presented to a user through a web page that uses a collapsible design options menu and checkboxes, and the user may select to apply three design options—design option A, design option B, and design option C—to the current architectural structure. Through the listing of design options, a user may visually determine which design options are available for, or applicable to, the current architectural structure. Those of ordinary skill in the art will appreciate that the listing of design options may be graphically presented to a user in a number of ways including, for example, a data tree, a collapsible menu, a drop down menu, a check box, and the like. Depending on the embodiment, such graphical presentations may be delivered to the user through a number of graphical user interfaces (GUI) including, without limitation, those embedded in web pages or those commonly found in software applications.

Depending on the embodiment, the set of design options may be applied to the entire architectural structure or may be applied to only certain elements/portions of the architectural structure. For instance, a design model for an architectural structure may have certain elements or portions of the design model grouped into collections of elements (i.e., groupings), thereby allowing one or more design options from the set of design options to be specifically applied to designated collections rather than the entirety of the architectural structure. In this way, some embodiments may enable impact analysis of an entire architectural structure even under scenarios where design options are applied to only certain parts of the architectural structure.

At operation 2309, a set of values may be assigned to a set of design option parameters associated with the set of design options, where at least one of the design option parameters is assigned a set of varying values. For example, where design option A, design option B, and design option C are selected by a user for application to the current architectural structure, the design option parameter associated with design option A (i.e., design option parameter A) may be assigned a set of varying values containing the values of 1 and 2 (i.e., {1, 2}), where the design option parameter associated with design option B (i.e., design option parameter B) may be assigned a set of varying values containing the values of 3 and 4 (i.e., {3, 4}), and the design option parameter associated with design option C (i.e., design option parameter C) may be assigned the static value of 5 (i.e., {5}).

As noted herein, once a value is assigned to a design option parameter associated with a design option being applied to the architectural structure, the value may control the degree with which the design option is being applied to the architectural structure. In assigning each of one or more design option parameters with a set of varying values, design options associated with such design option parameters can be applied to the architectural structure for parametric analyzed while under the control of varying values.

For some embodiments, a set of varying values may be defined by a list of static values (e.g., an array of values), by a range of values between a min value and a max value where values in the set may be determined from the range using an interval value (i.e., step value), or by a formula, which may produce the set of varying values based on a set of input values to the formula. Depending on the embodiment, the min value, the max value, or the interval value (i.e., step value) for a range may be a static value (e.g., step value of 3, resulting in every 3rd value within the range being tin the set of varying values) or may be formula-based that determines the min, the max value, or the interval value.

As noted herein, the value assigned to a design option parameter may be a discrete value (e.g., Light, Medium, Heavy) rather than just numerical value. In embodiments where a design option parameter is configured to be assigned discrete values (e.g., Light, Medium, Heavy), the set of varying discrete values may be defined by a list of discrete values (e.g., an array of discrete values), by a range of values between a min discrete value and a max discrete value, or by a formula, which may produce the set of varying discrete values based on a set of input values to the formula.

Additionally, in certain embodiments, a range for a set of varying values may be may be determined in accordance with a template (often referred to herein as a “min/max value template”) that provides the method of determination for the range (e.g., provides the min value, the max value, and the interval value for a range). Such a template may further provide a particular design option parameter with a specific range determination method based on that design option parameter's type (e.g., the design parameter option configured to be assigned a percentage value) or based on the design option to which the design option parameter is associated (e.g., each of the min value, max value, and interval value for a range of varying values to be assigned to the design option of window glazing is based on a formula).

As noted herein, in order for a set of design option parameters associated with corresponding design options being applied to an architectural structure, some design option parameters may be assigned sets of varying values (sometimes referred to herein as “unlocked design option parameters”), and while each of the others design option parameters may be assigned a static value (sometimes referred to herein as “locked design option parameters”). In some such embodiments, the static values for the locked design option parameters may be provided by a template (often referred to herein as a “seed value template”), thereby affording a user with the convenience of not having to manually assign a static value for each of the locked option parameters. Depending on the embodiment, a seed value template may further provide a specific design option parameter with a specific static value based on that design option parameter's type (e.g., the design parameter option configured to be assigned a percentage value) or based on the design option to which the design option parameter is associated (e.g., the static value to be assigned to the design option of window glazing is 5%).

During operation 2312, a set of assignment combinations may be determined from the set of values based on one or more design option parameters that are assigned a set of varying values. In some embodiments, the set of assignment combinations include sets of value assignments, each value assignment corresponding to a different design options being applied to the architectural structure. For instance, assuming that design option parameter A is assigned a set of varying values containing the values of 1 and 2, design option parameter B is assigned a set of varying values containing the values of 3 and 4, and design option parameter C is assigned the static value of 5, operation 2312 may determine that the set of assignment combinations to be {{A:1, B3,C: 5},{A:2, B:3,C: 5},{A:1, B:4,C: 5},{A:2, B:3,C: 5}}, where each set constitutes a set being respectively assigned to design option parameters A, B, and C for single analysis iteration (i.e., single application of design options A, B, and C, and analysis of the ensuing results).

In operation 2315, a set of analysis iterations may be determined based on a set of assignment combinations, which may have been determined during operation 2312. During each analysis iteration, each design option in the set of design options (selected for application to the architectural structure) may be applied to the architectural structure while the design option parameters corresponding to (i.e., associated with) those design options of the set are assigned (i.e., modified by) an assignment combination from the set of assignment combination. Stated another way, during a given analysis iteration, the set of design options selected for application to the architectural structure may be applied to the architectural structure according to the set of (associated) design option parameters as modified by an assignment combination from the set of assignment combinations.

In addition to the application of each design option from the set of design options to the architectural structure, during operation 2315 each analysis iteration may also analyze the impact that results from the application of the set of design options while the design option parameters, which correspond to design options of the set, are assigned an assignment combination from the set of assignment combinations.

For example, where the set of assignment combinations is determined to be {{A:1, B:3,C: 5},{A:2, B:3,C: 5},{A:1, B:4,C: 5},{A:2, B:3,C: 5}}, during operation 2315 the set of analysis iterations could be determined to include four analysis iterations. Specifically, there may be (a) one analysis iteration where design option parameter A is assigned the value of 1, design option parameter B is assigned the value of 3, and design option parameter C is assigned the value of 5; (b) another analysis iteration where design option parameter A is assigned the value of 2, design option parameter B is assigned the value of 3, and design option parameter C is assigned the value of 5; (c) another analysis iteration where design option parameter A is assigned the value of 1, design option parameter B is assigned the value of 4, and design option parameter C is assigned the value of 5; and (d) another analysis iteration where design option parameter A is assigned the value of 1, design option parameter B is assigned the value of 3, and design option parameter C is assigned the value of 5.

In operation 2318, a computing resource necessary to perform the set of analysis iterations on the architectural structure is identified. Computing resources that may be identified for a set of analysis iterations may be virtual or physical in nature and may include, without limitation, memory resources (e.g., volatile memory, such as random access memory [RAM], and non-volatile memory, such as a hard disk), processing resources (e.g., central processing units, virtual computer instances on a cloud computing platform), and network resources (e.g., network bandwidth. For instance, when performing a given set of analysis iterations having a certain number of analysis iterations and involving a certain number of design options being applied to specific portions of the architectural structure, it may be determined (e.g., estimated) that a particular amount of persistent storage space is required to store the results from the analysis iterations performed (i.e., store the resulting analysis data). In another example, it may be determined that a certain amount of processing resources are needed in order to perform the set of analysis iterations within a predetermined time value (i.e., predetermined processing time).

In some embodiments, to identify computing resources needed to perform the set of analysis iterations. a predetermined standard time value (e.g., defined in seconds, minutes, hours, days, etc.) may be imposed as a standard constraint on the performance of each analysis iteration in the set of analysis iterations (e.g., each analysis constraint should not take longer than an hour to perform). Alternatively, for some embodiment, the predetermined standard time value may be imposed as a standard constraint imposed on the entire set of analysis iteration as a whole (e.g., perform the set of analysis iteration should not taken longer than a day to perform) when identifying computing resources needed to perform the set of analysis iterations. In some embodiments, the predetermined time value may be preconfigured by a vendor or system administrator maintaining the analysis tool, or may be a user-defined time value that may be adjustable before performance of a set of analysis iterations begins or during the performance. The predetermined standard time value may be adjusted by a user, for instance, to ensure enough computing resources are committed to performing the set of analysis iterations, thereby ensuring timely completion of the set of analysis iterations.

In operation 2321, a processing time necessary to perform the set of analysis iterations on the architectural structure is determined. When determining the processing time needed to perform the set of analysis iterations, some embodiments may assume a standard set of computing resources will be utilized to perform the set analysis iterations. Depending on the embodiment, the standard set of computing resources for a given set of analysis iterations may be determined such that the standard set of computing resources is proportional to the size and/or complexity of the set of analysis iterations. For example, the processing time to perform a given set of analysis iterations may be based on the assumption that (as a standard) for each analysis iteration in the given set of analysis iterations, a single unit of computing resource (e.g., single virtual computer instance on a cloud computing platform) will assigned to perform the given set of analysis iterations.

It should be noted that adjustments to the values of one or more design option parameters (e.g., changing a design option parameter from a locked design option parameter to an unlock design option parameter, or adjusting a range for a set of varying values), or adjustments to portions of the architectural structure to which the set of design options are being applied (e.g., applying some of the design options to only one façade of the architectural structure rather than to the entirety of the architectural structure) may have an impact on the number of analysis iterations performed on the architectural structure during parametric analysis, an impact on the computing resources needed to perform the set of analysis iterations, an impact on the processing time, or a a combination thereof. Conversely, in some embodiments, a user may bind the processing time (i.e., time value) to a predetermined value, thereby impacting how the set of analysis iterations may be performed. For instance, where a user bounds the processing time, for a given set of analysis iterations, to a shorter duration than is defined by the standard time value (e.g., standard processing time alotted for each analysis iteration or alotted to the enstire set of analysis iterations), the one or more computing resources identified during operation 2318 may be revised (i.e., an updated) to account for the adjustment in processing time allowance.

During operation 2324, the set of analysis iterations may be performed on the architectural structure, thereby resulting in analysis data for each analysis iteration performed on the architectural structure. As noted herein, when the set of analysis iterations is performed on the architectural structure, for each analysis iteration: (a) the set of design options are applied to the architectural structure in accordance with the settings of the analysis iteration (i.e., in accordance with the value assignments for the design option parameters corresponding to the set of design options, and in accordance with how the design options are to be applied to the architectural structure), and (b) analyzing the impact (on all or some of the architectural structure) that results from the application of the set of design options.

In operation 2327, a feature of the architectural structure may be determined based on the analysis data that results from operation 2324. As noted herein, in some embodiments, a feature may include energy consumption of the architectural structure, water consumption of the architectural structure, compliance of the architectural structure with a construction standard, a thermal characteristic of the architectural structure, carbon footprint of the architectural structure, indoor environment quality of the architectural structure, a construction material utilized in the architectural structure, an equipment item utilized by the architectural structure, a construction cost of the architectural structure, an operational cost of the architectural structure, or a maintenance cost of the architectural structure. Other features may include the total cost-benefit, return-on-investment, or payback period for applying the sets of design options to the architectural structure based on the design option parameters and the sets of assignment combinations.

In operation 2330, an analysis iteration in the set of analysis iterations may be identified based on the analysis data or the design option parameter. For example, when reviewing the results of applying the set of analysis iterations, a user may filter out those analysis iterations (in the set of analysis iterations) having analysis results (i.e., analysis output) that do not meet a certain output criteria. For instance, a user may request to view those analysis iterations (or the results of those analysis iterations) that result in the architectural structure having (i.e., that result in an analysis output having) energy use intensity (EUI) between 30 to 150 kWh/m2/yr.

Likewise, when reviewing the results of applying the set of analysis iterations, a user may filter out those analysis iterations (in the set of analysis iterations) according to the values (i.e., input values) assigned to one or more design option parameters associated with those analysis iterations. For instance, when reviewing the results of the set of analysis iterations, a user may limit the range of values assigned to a particular unlocked design option parameter of the analysis iterations (e.g., glazing ratio) to a subset of the original set of varying values (limit to 5% to 20%), thereby filtering out those analysis iterations that have a value outside that range assigned to its particular unlocked design option parameter (e.g., those analysis iterations having a value less than 5% or more than 20% assigned to its design option parameter for glazing ratio).

Those of ordinary skill in the art will appreciate that various embodiments may allow use of a number of other criteria/factors when filtering and/or identifying certain analysis iterations in the set of analysis iterations including, for example, computation time for the analysis iteration, storage space occupied by the analysis iteration, and properties of the analysis iterations (e.g., application of certain design options to particular portions of the architectural structure).

In operation 2333, design concept may be created from or modified based on a specific analysis iteration from the set of analysis iterations. When doing so, some embodiments created or modified design concept may comprise (1) the set of design options of the specific analysis iteration, (2) the set of design option parameters associated with that set of design options, and (3) the assignment combination associated with the analysis iteration. In instances where an existing design concept is being modified based on the specific analysis iteration, the set of design options from the specific analysis iteration may be added to the design options already present in the design concept, and the set of design option parameters already present in the design concept may be adjusted according to the assignment combination of the specific analysis iteration.

Those of skill in the art reading this description will appreciate and understand that some or all of the method 2300 may be implemented through a web interface (e.g., a website, or may be implemented through software application operating on a computer,

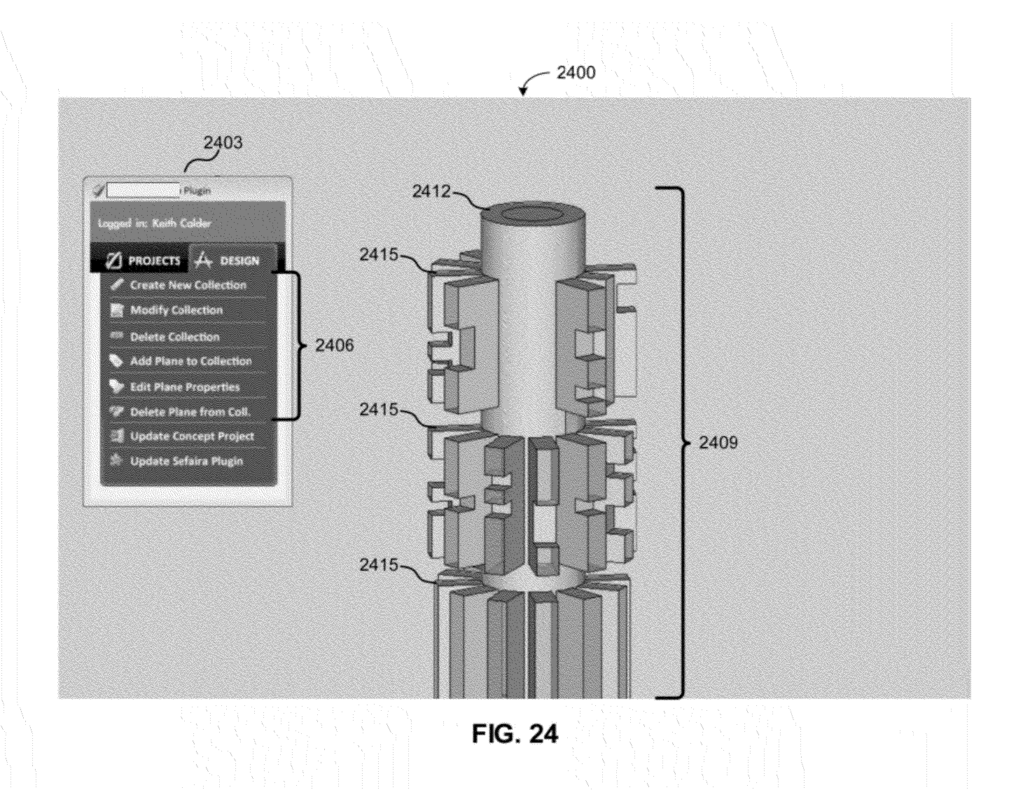

FIG. 24 is a screenshot 2400 illustrating an example interface 2403 for accessing collections of architectural structure elements in accordance with an embodiment of the present invention. As noted herein, a user may group elements of an architectural structure into user-defined collections, and that such collection may be defined when a design model of an architectural structure is being created or modified. Subsequently, when the architectural is to be analyzed (either parametrically or non-parametrically), a user may utilize one or more of the collections defined for the architectural structure to apply one or more design options to certain portions of the architectural structure, rather than having those design options apply to the architectural structure as a whole. The interface 2403 may be provided in a tool for creating or designing design models of an architectural structure, or through a web interface after a design model for the architectural structure has been uploaded to a system in accordance with some embodiments.

The interface 2403 comprises interface items 2406 that may allow a user to create and modify a collection in association with an architectural structure. For example, the interface 2403 may allow a user to create (i.e., defined) a new collection of elements, modify an existing collection of elements, or delete a collection of elements. Certain embodiments may allow a user to modify collections on an element-by-element basis. For example, a user may add a plane to or delete a plane from a collection by selecting the plane on a design model representing the architectural structure, and selecting the appropriate items from the interface items 2406.

In FIG. 24, such a design model 2409 representing an architectural structure is shown. The design model comprises a central column element 2412, and module side elements 2415. Through the design model 2409, a user may select one or more elements from the design model 2409 and have them added to or deleted from a collection.

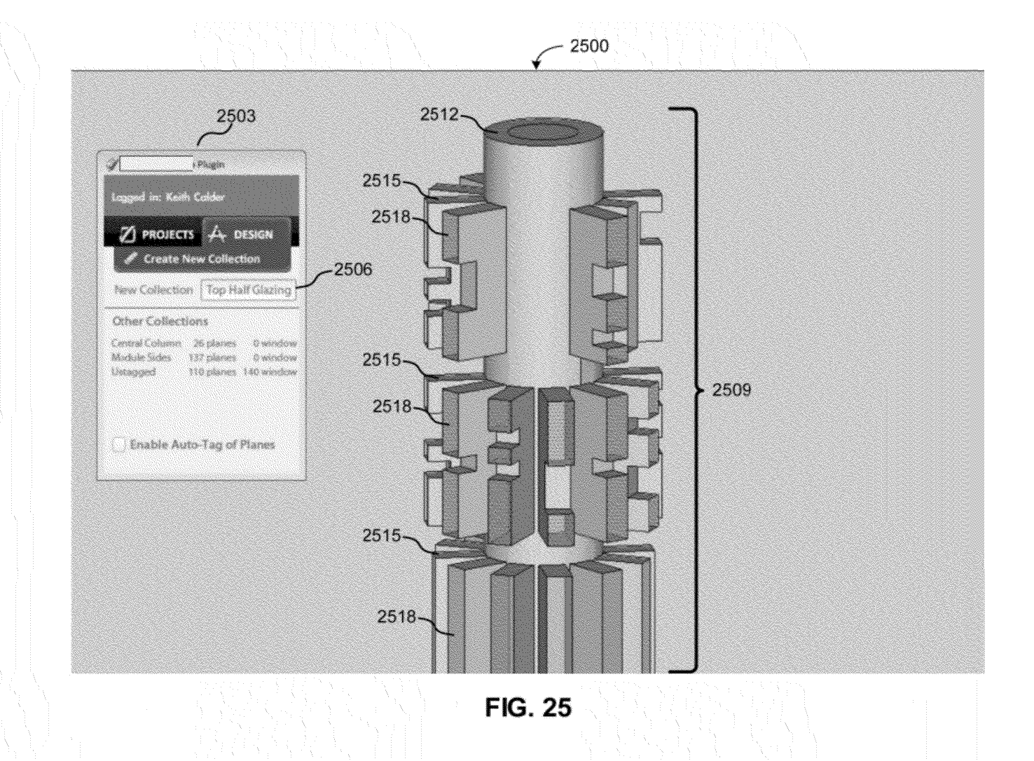

FIG. 25 is a screenshot 2500 illustrating example interface 2503 for creating collections of architectural structure elements in accordance with an embodiment of the present invention. The interface 2503 may be provided in a tool for creating or designing design models of an architectural structure, or through a web interface after a design model for the architectural structure has been uploaded to a system in accordance with some embodiments.

The interface 2503 comprises a collection name field 2406 that may allow a user to provide a name for a new collection to be added and associated with the design model of the architectural structure. The interface 2503 also comprises a listing of other collections already existing and associated with the design model, the number of planes for the other collections, and the number of windows for the other collections.

In FIG. 25, a design model 2509 representing the architectural structure is shown. The design model comprises a central column element 2512, module side elements 2515, and windows 2518 of the module side elements. By selecting the windows 2518 of the design model, a user may group the windows 2158 into a new collection named “Top Half Glazing.” Subsequently, the user may focus the application of one or more design options to the “Top Half Glazing” collection during the analysis of the architectural structure.

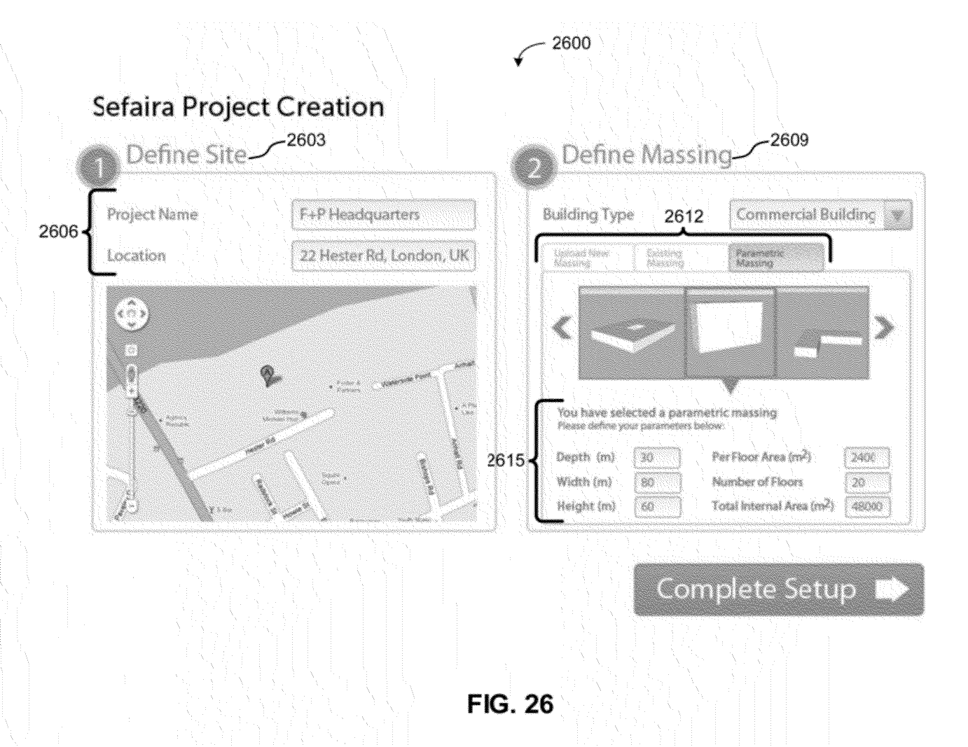

FIG. 26 is a screenshot illustrating an example interface 2600 for creating an architectural structure analysis project in accordance with an embodiment of the present invention. For some embodiments, the interface 2600 shown in FIG. 26 may be presented to a user through a web interface provided by an analysis server, or through the graphical user interface of an application operating on a personal computer.

In FIG. 26, a project creation involves a project definition section 2603 and an architectural structure (i.e., massing) definition section 2609. Under a project definition section 2603, a user may provide a project name and a project geographical location in fields 2606 for the project to be created. Based on the geographical location supplied in the fields 2606, some embodiments may provide the geographical location of the project site on a map so that the project creator (i.e., user) can confirm that the geographical location entered is correct. In some embodiments, defining the geographical location of the project site may involve the project creator selecting a geographical location for the project on a map, which may result in the auto-population of the fields 2606.

Under the architectural structure definition section 2609, a user may select the building type associated with the architectural structure. Examples of building types may include, without limitation, residential building, commercial building, and industrial building. Additionally, using the tabbed interface 2612, a user may select an architectural structure from a number of architectural structure categories. For example, a user may choose to provide an analysis system (in accordance with an embodiment) with a new design model representing an architectural structure (i.e., massing), may select a design model from those previously provided and still existing on the analysis system, or select a design model from a library of generic architectural structures having simple construction and dimensions.

When performing analysis on an intended architectural structure, a user may select and use a design model representing a generic architectural structure (also referred to herein as a “parametric massing”) in place of a design model representing the intended architectural structure to simplify and quicken the analysis process. Due to its simple construction and dimensions, analysis of a design model of a generic architectural structure can be faster than that of design mode of a comparably constructed and dimensioned architectural structure. Design models of generic architectural structure can be particularly useful when a design model for the intended architectural structure is not available for analysis, or when the design model of the intended architectural structure is complex (which typically adversely impacts the analysis processing time).

After selecting a design model of a generic architectural structure that best matches that of the intended architectural structure, a user may use fields 2615 to enter and adjust the dimensions of the selected design model to better match the dimensions of the intended architectural structure.

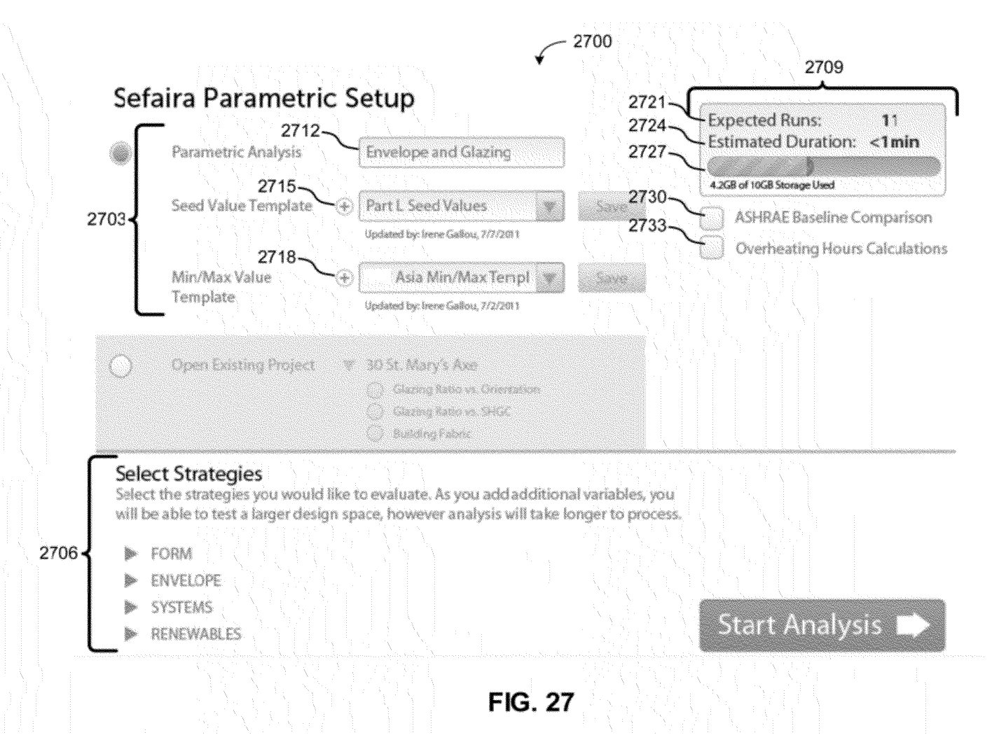

FIG. 27 is a screenshot illustrating an example interface 2700 for configuring a parametric analysis of an architectural structural in accordance with an embodiment of the present invention. The interface 2700 comprises parametric analysis setting fields 2703, a list of design options 2706, and analysis iterations information pane 2709.

Through the parametric analysis settings fields 2703, a user may provide a name 2712 for the parametric analysis being setup, designate a seed value template for those design option parameter that will be locked (i.e., assigned a static value) during the parametric analysis process, and a min/max value template for those design option parameters that will be unlocked (i.e., assigned values from a set of varying values) during the parametric analysis process. As noted herein, for some embodiments, a seed value template may provide static values to each of the locked design option parameters selected for application to the architectural structure during a parametric analysis. As also noted herein, for certain embodiments, a min/max value template may provide the mix, max, and interval values for a range of values that define a set of varying values assigned to an unlocked design option parameter selected for application to the architectural structure during a parametric analysis.

The listing of design option 2706 may present for user selection one or more design options available for application to the architectural structure during the parametric analysis process. In accordance with various embodiments, the design options presented through the listing 2706 may have one or more corresponding design option parameters that control the application of those design options to the architectural structure. As noted herein, the design option parameters associated with the design options of listing 2706 may be setup to be locked or unlocked during the parametric analysis of the selected architectural structure.

The analysis iterations information pane 2709 may display information relating to the set of analysis iterations to be performed during parametric analysis of the architectural structure. For example, the analysis iterations information pane 2709 may list an expected number of runs 2721 (i.e., expected number of analysis iterations) to be performed during the parametric analysis process, an estimated duration 2724 (i.e., processing time) for the parametric analysis process, and an estimated storage space 2727 that will be occupied by analysis data produced by the parametric analysis process. As described herein, adjustments to the parametric analysis, such as a change in design options to applied to the architectural structure, an adjustment to a design option parameters associated with a design option to be applied to the architectural structure, or a change in the selection of a min/max value template, may result in a corresponding change in the performance characteristics of the analysis iterations to be performed during the parametric analysis. Eventually, the information provided by analysis iterations information pane 2709 may reflect these performance characteristic changes.

Optionally, a user may select option 2730 to have the results produced during the analysis iterations compared against the ASHRAE baseline. A user may also select option 2733 to perform overheating hours calculations in addition to performing the analysis iterations on the architectural structure.

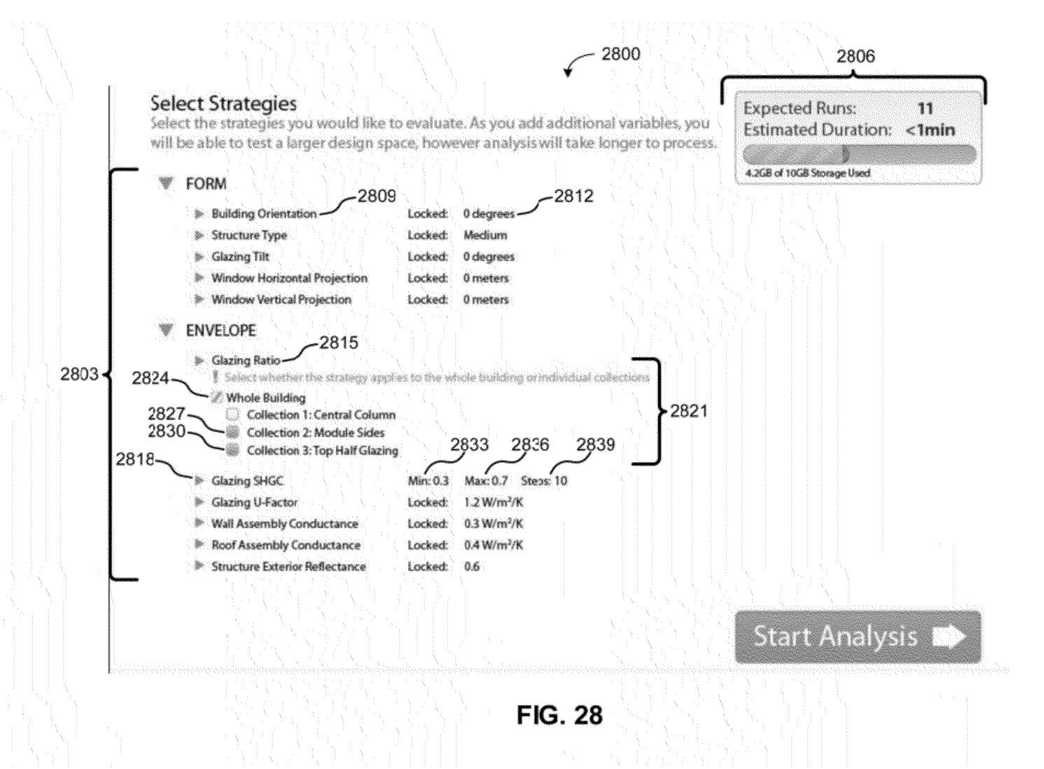

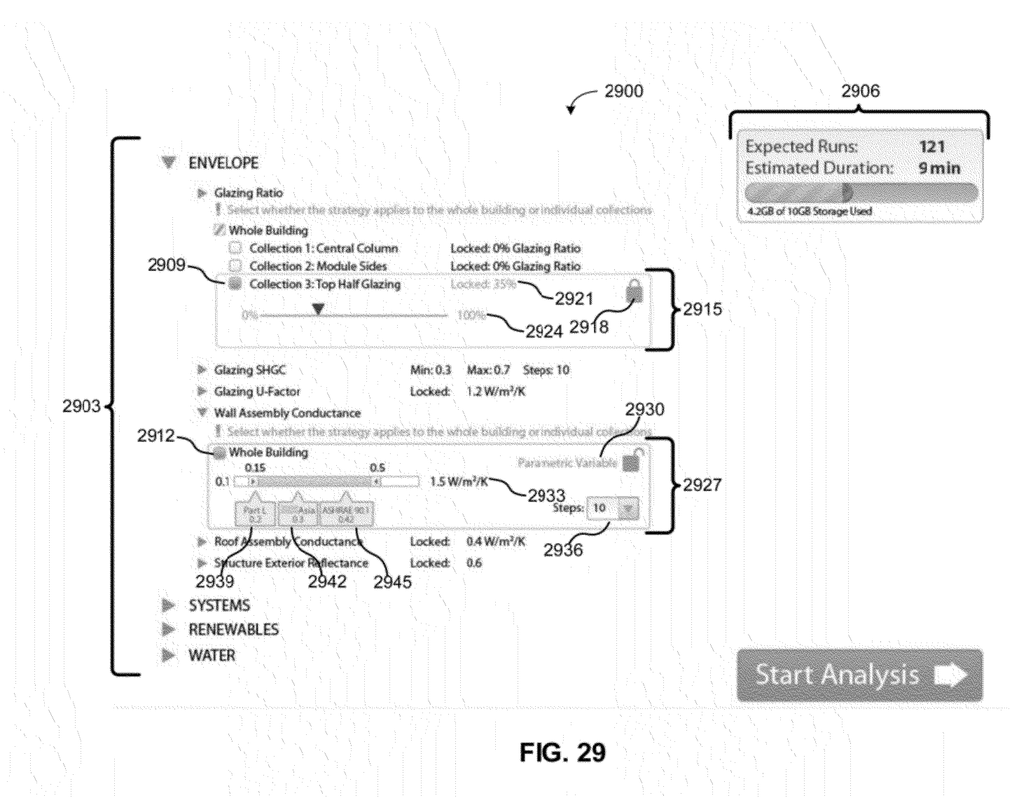

FIGS. 28 and 29 are screenshots illustrating example interfaces for selecting and configuring design options for a parametric analysis of an architectural structural in accordance with an embodiment of the present invention. FIG. 28 depicts a design option interface 2800 comprising a listing 2803 of design options available for selection and application to an architectural structure, and an analysis iterations information pane 2806 that provides information relating to the analysis iterations that will be performed when applying the selected design options to the architectural structure in accordance with values assigned to the design option parameters.

Through use of the listing 2803 of design options, a user may specify application of one or more design options to one or more elements of the architectural structure. For example, as shown in FIG. 28, a user may select to apply a glazing ratio design option to the architectural structure. The user may also specify application of the glazing ratio design option to one or more certain collections of elements of the architectural structure. For instance, through a design option sub-interface 2821 associated with the glazing ratio design option 2815, a user may specify application of the glazing ratio design option 2815 to the entire architectural structure (e.g., the whole building) through option 2824, or specify application of the glazing ratio design option to certain collections of elements of the architectural structure (such as collection 2827 of elements entitled “Module Sides” and collection 2830 of elements entitled “Top Half Glazing”).

The listing 2803 of design options may also display the one or more locked and unlocked design option parameters associated with the design options available for selection and application to the architectural structure. For instance, in FIG. 28, the listing 2803 of design options lists a building operation design option 2809 available for selection having a locked design option parameter assigned the value of 0 degrees. The listing 2803 of design options also lists a glazing (solar heat gain coefficient—SHGC) design option 2818 available for selection, having a unlocked design option parameter assigned a set of varying values ranging from a min value 2833 of 0.3, a max value 2836 of 0.7, and a step value 2839 of 10 (i.e., the set of varying values for the design option parameter may be {0.3, 0.4, 0.5, 0.6, 0.7} if the min and max values are inclusive).

As noted herein, for some embodiments, changes in application of one or more design options to one or more elements of the architectural structure may result in changes in the performance properties of the analysis iterations to be performed during parametric analysis. Eventually, these changes in the performance properties of the analysis iterations may be reflected in the information shown by the analysis iterations information pane 2806.

In FIG. 29, a design option interface 2900 is shown comprising a listing 2903 of design options available for selection and application to an architectural structure, and an analysis iterations information pane 2906 that provides information relating to the analysis iterations that will be performed when applying the selected design options to the architectural structure in accordance with values assigned to the design option parameters.

As noted herein, a user may select application of one or more design options to one or more elements of the architectural structure, may adjust the values assigned to design option parameters associated with the design options, and may further adjust the values assigned to the design option parameters on an element-by-element basis. For example, as shown in FIG. 29, a user may select application of a glazing ratio design option to a collection 2909 of elements entitled “Top Half Glazing.” Additionally, in applying the glazing ratio design option to the collection 2909 of elements entitled “Top Half Glazing,” a user may assign a static value between 0% and 100% to the design option parameter associated with the glazing ratio design option as the glazing ratio design option is applied to the collection 2909.

In some embodiments, a user may utilize a design option parameter interface 2915 to adjust the static value assigned to the design option parameter associated with the glazing ratio design option as applied to the collection 2909. For example, a user may utilize a value slider 2924 to assign a static value 2921 of 35% to the design option parameter. Though the design option parameter in the design option parameter interface 2915 is shown to be locked (i.e., assign it a static value), a user may desire to unlock the design option parameter (i.e., assign it a set of varying values) by clicking on a lock selector 2918.

As described herein, in various embodiments, a user may assign a set of varying values for a design option parameter associated with a design option. For instance, in FIG. 29, a user may select to apply a wall assembly conductance design option to an entire architectural structure 2912 (e.g., the whole building), and may utilize a design option parameter interface 2927 to adjust a set of varying values assigned for the design option parameter associated with the wall assembly conductance design option. Specifically, for particular embodiments, a user may use a range slider 2933 to set a min value and a max value for a range of values defining the set of varying values, and may assign an interval value 2936 (i.e., step value) for the range of values. Though the design option parameter in the design option parameter interface 2927 is shown to be unlocked (i.e., assign it a set of varying values), a user may desire to lock the design option parameter (i.e., assign it a static value) by clicking on a lock selector 2930.

In some embodiments, the design option parameter interface 2927 may provide one or more suggested min values, max values, or static values that a user may consider when adjusting one or more values assigned to a design option parameter. For some such embodiments, the suggested min values, max values, or static values may be in accordance with such standard and codes as ASHRAE, California Title 24, Part L United Kingdom (UK) Building Standard, PassivHaus, and International Energy Conservation Code. In one example, the design option parameter interface 2927 may display a suggested static value 2939 under Part L, a static value 2942 under Asia, or a static value 2945 under ASHRAE Standard 90.1.

As noted herein, for some embodiments, changes in application of one or more design options to one or more elements of the architectural structure, or adjustments in values assigned to design option parameters, may result in changes in the performance properties of the analysis iterations to be performed during parametric analysis. Subsequently, these changes in the performance properties of the analysis iterations may be reflected in the information shown by the analysis iterations information pane 2906.

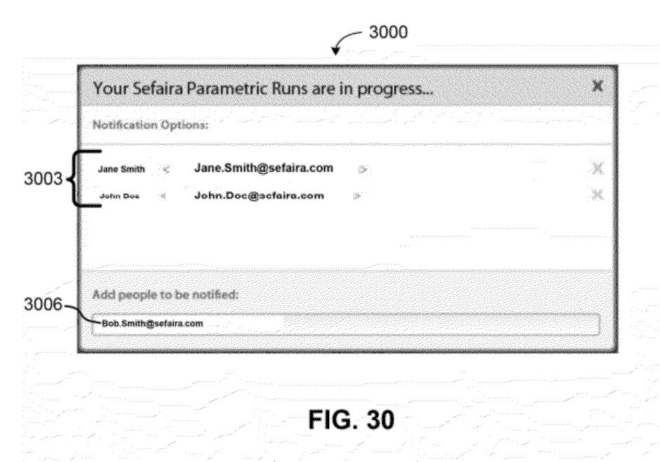

FIG. 30 is a screenshot illustrating an example interface 3000 for configuring a parametric analysis progress notification in accordance with an embodiment of the present invention. In some embodiments, application of one or more design options to an architectural structure and analysis impacts that result therefrom may be performed on a server, in accordance with and at the request of a client. For instance, a user may request that a server perform a set of analysis iterations on an architectural structure for a given set of design options, a given set of associated design option parameters, and a given set of values assigned to those design option parameters. So that a client does not have to remain connected to or monitor the server as the analysis process applies and analyzes the application of design options to the architectural structure, for some embodiments, a user may instruct the server to perform the application and analysis processes in the background, and may further instruct the server to automatically notify one or more individuals once the processes have been completed by the server. In doing so, a user can conveniently notified of a completion of an analysis via an e-mail or text message, thereby obviating the user's need to check periodically whether the server has completed the requested analysis processes.

For example, in FIG. 30, a user may list individuals and their contact information (e.g., e-mail addresses, or mobile number) in a notification list 3003 so that the listed individuals will be notified once a requested parametric analysis of an architectural structure has been completed. A user may enter additional individual to the notification list 3003 using a text entry field 3006.

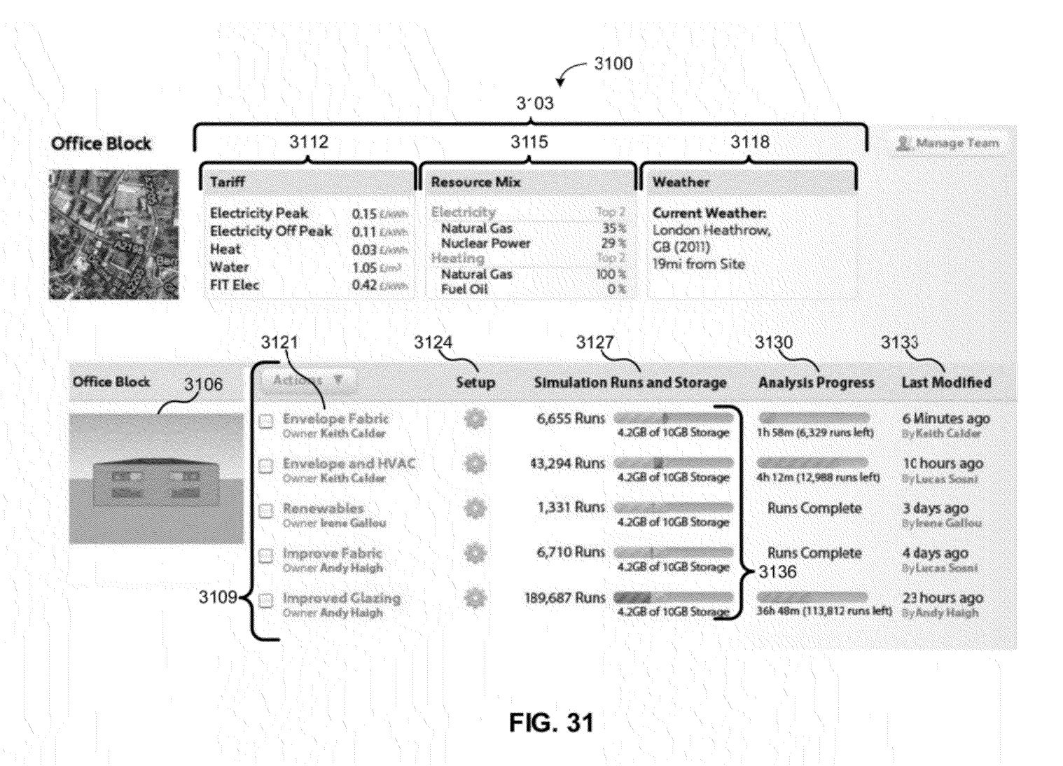

FIG. 31 is a screenshot illustrating an example interface 3100 for reviewing and accessing one or more parametric analyses associated with an architectural structure in accordance with an embodiment of the present invention. The interface 3100 may comprise a project site summary dashboard 3103, a preview 3106 of a design model representing the architectural structure, and a listing 3109 of parametric analyses associated with the architectural structure. In addition

In various embodiments, the project site summary dashboard 3103 may provide a tariff summary 3112, a resource mix summary 3115, and a weather summary 3118 for a project site associated with the architectural structure. Depending on the embodiment, the tariff summary 3112 may list for the project site tariff information relating to electricity usage during peak hours, electricity used during off peak hours, heat usage, water usage, and Feed in Tariff (FIT) Electricity usage. Additionally, the resource mix summary 3115 may list the electricity resource mixture available at the project site, and the heat resource mixture available at the project site, and the weather summary 3118 may list current weather data or annual weather data for the project site.

Each parametric analysis displayed in the listing 3109 of parametric analyses may be one associated with the given architectural structure, and may be added to the listing 3109 once the parametric analysis is ready for performance, is currently being performed (e.g., being performed in the background by cloud computing resources on a server), or has already been performed. In regard to FIG. 31, a column 3121 may list the name and creator of parametric analyses, a column 3124 may provide access to the setup of each parametric analysis provided in listing 3109; and a column 3127 may list information regarding performance characteristics associated with the parametric analyses (e.g., number of analysis iterations for each parametric analysis listed, and storage space needed for the analysis data produced by each parametric analysis listed). Additionally, a column 3130 may list the current progress of each parametric analysis listed (e.g., progress, expected completion time), while a column 3133 may list the when last each parametric analysis was modified.

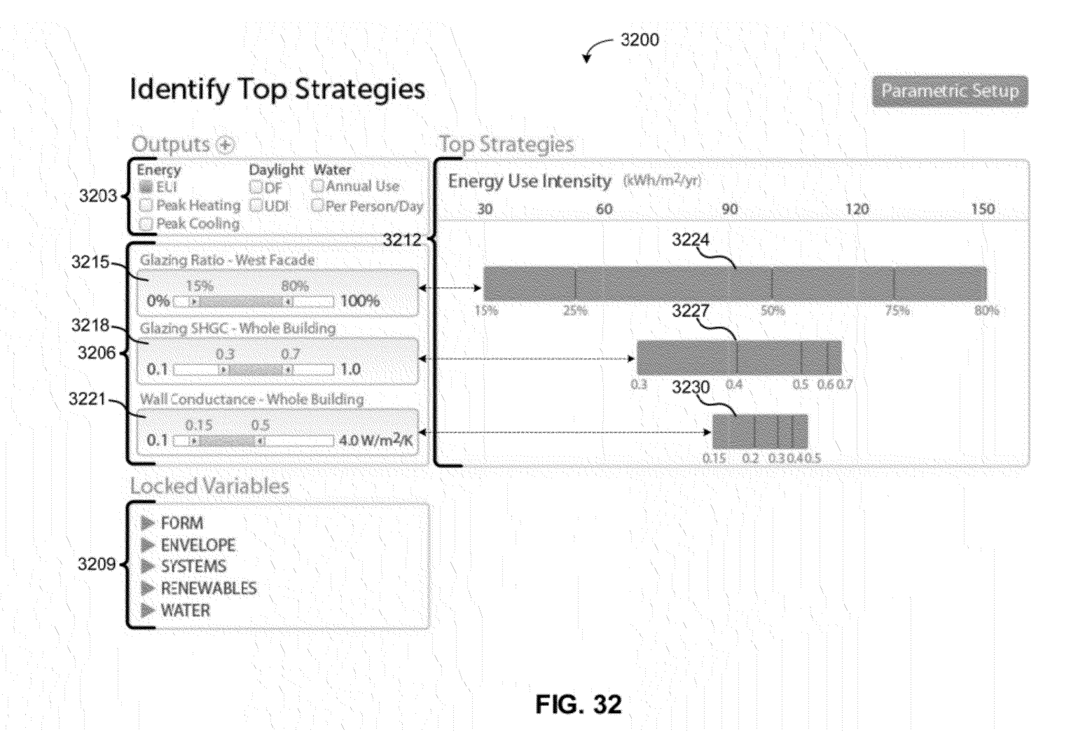

FIG. 32-35 are screenshots illustrating example interfaces for reviewing one or more results of a parametric analysis on an architectural structure in accordance with an embodiment of the present invention. In particular, the example interfaces illustrated in FIGS. 32-37 may allow a user to review the analysis data produced by a parametric analysis based on filtering of one or more input values to and/or filtering of one or more output values. The interfaces provided in FIGS. 32-37 may further permit a user utilize the filtered analysis data to identify design options, design option parameters, values, or specific analysis iterations performed on the architectural structure based.

FIG. 32 provides an interface 3200 comprising an output analysis output data selector 3203, an unlocked design option parameter filter 3206, a locked design option parameter filter 3209, and a graphical view 3212 of the analysis data based on filter parameters. The analysis output data selector 3203 may present a user with one or more categories of data, which once chosen, causes extrapolation or extraction of corresponding data from the analysis data resulting from a parametric analysis. For example, as shown in FIG. 32, a user may select to review energy use intensity (EUI) data in the analysis data. Other examples of analysis output data that can be provided to a user may include, without limitation, energy use intensity (EUI), peak heating usage, peak cooling usage, daylight factor (DF), useful daylight illuminance (UDI), annual water use, and water use per person per a day.

Subsequent to extrapolation or extraction of data from the analysis data resulting from a parametric analysis, the extrapolated/extracted data may be provided to the user in a number of different ways including, for example, by way of an exportable file (e.g., character delineated file, an Extensible-Markup Language [XML] file, and the like), a graphical representation of the extrapolated/extracted data (e.g., bar chart, scatter chart, line chart, pie chart, and the like), and a table of the extrapolated/extract data (e.g., spreadsheet, or Hypertext-Markup Language [HTML] table). Depending on the embodiment, a graphical representation or a table of the extrapolated/extracted data may be displayed to the user through a graphical user interface or may be provided in a file.

In instances where the extrapolated/extract data is provided as a graphical representation, the graphical representation may be interactive and permit a user to manipulate the presentation of the graphical representation. For example, the user may enlarge or shrink the presentation of the graphical representation, or change the graphical representation type (e.g., bar chart, scatter chart, and the like). In some embodiments, an interactively graphical representation may allow a user to inspect information regarding data points that comprise the graphical representation. For example, a user may use the interactive graphical representation to select a data point shown by the graphical presentation and examine information underlying that data point. Information relating to data points of the graphical representation may include, without limitation, data values associated with the selected data point and an analysis iteration associated with the selected data point.

The unlocked design option parameter filter 3206 may allow a user to filter analysis data, produced by a parametric analysis, according to one or more design options used during the parametric analysis and under the influence of one or more unlocked design option parameters. In various embodiments, the unlocked design option parameter filter 3206 may permit a user to filter data corresponding to a specific design options as influenced (i.e., controlled) by one or more unlocked design option parameters modified by a set of varying values (e.g., range of values). As a result, a user may filter the analysis data based on input values assigned to unlocked design option parameters during the parametric analysis.

In some embodiments, data filtered using the unlocked design option parameter filter 3206 may be data extrapolated or extracted from the analysis data based on selections using the analysis output data selector 3203. For example, as shown in FIG. 32, a user may choose to extrapolate or extract energy use intensity (EUI) data from the analysis data and filter the extrapolated/extracted according to the following unlocked design option parameters: a glazing ratio design option parameter 3215, a glazing SHGC design option parameter 3218, and a wall conductance design option parameter 3221. In FIG. 32, the user has selected a range of 15% to 80% for the glazing ratio design option parameter 3215, 0.3 to 0.7 for the glazing SHGC design option parameter 3218, and 0.15 to 0.5 W/m²/K for the wall conductance design option parameter 3221. The filtered analysis data eventually provided to the user will reflect settings made through the unlocked design option parameter filter 3206.

The locked design option parameter filter 3209 may enable a user to filter analysis data, produced by a parametric analysis, according to one or more design options used during the parametric analysis and under the influence of one or more locked design option parameters. In various embodiments, the locked design option parameter filter 3209 may facilitate filtering data that corresponds to specific design options under the influence of (i.e., as controlled by) particular locked design option parameters as modified by a static value. By doing so, a user may filter the analysis data based on an input value assigned to locked design option parameters during the parametric analysis.

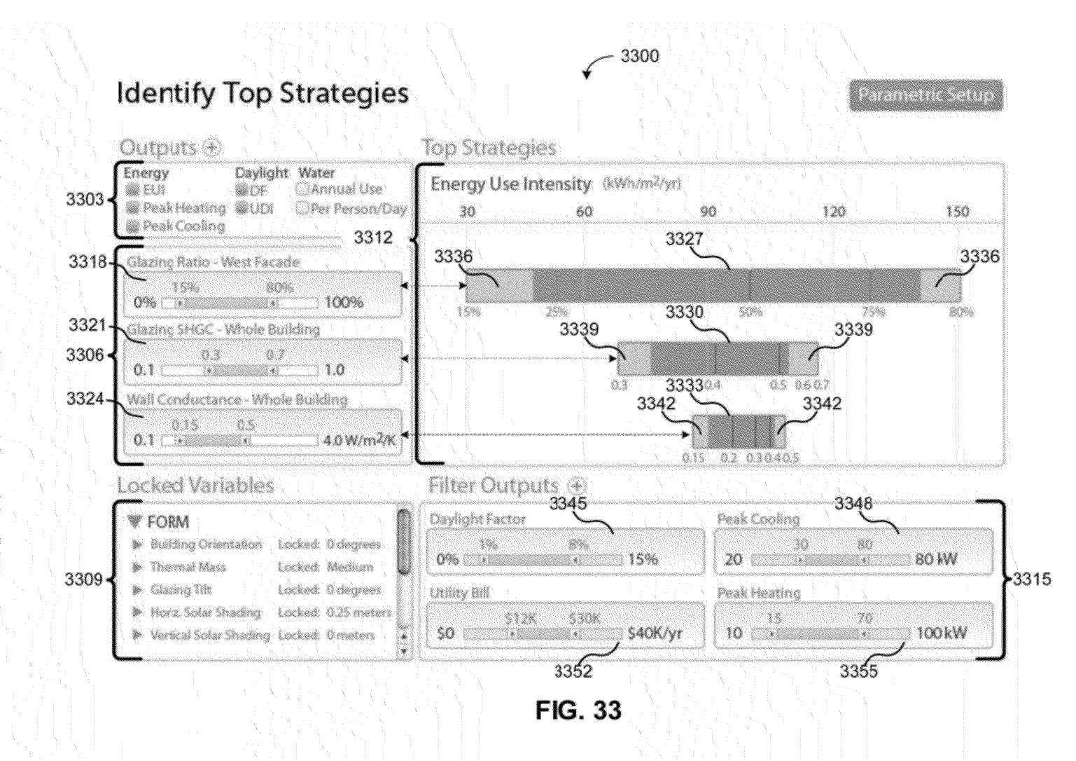

The graphical view 3212 of the analysis data may display a graphical representation or a tabular representation of the analysis data as selected and filtered according to user selections/preferences. Depending on the embodiment, the analysis data shown by graphical view 3212 may be filtered according to filter input parameters, as determined by the unlocked design option parameter filter 3206 or the locked design option parameter filter 3209, or according to output parameters, which are discussed further with respect to FIG. 33. In some embodiments, the filtered analysis data displayed by graphical view 3212 may be data extrapolated or extracted from the analysis data in accordance with the analysis output data selector 3203 and then filtered in accordance with the unlocked design option parameter filter 3206 or the locked design option parameter filter 3209.

In embodiments where the filtered analysis data is provided via the graphical view 3212, the graphical representation may take one of many forms including, for example, a chart or graph that is interactive or static in nature. For example, as shown in FIG. 32, the filtered analysis data may be generated in to a vertical bar graph. For some embodiments, where the analysis data is being filtered according to two or more unlocked design option parameters, the graphical view 3212 may present a separate graphical representation for the analysis data as it corresponds to each of the unlocked design option parameters. For instance, as shown in FIG. 32, the graphical representation of filtered analysis data may comprise a first graphical element 3224 corresponding to the glazing ratio design option parameter 3215, a second graphical element 3227 corresponding to the glazing SHGC design option parameter 3218, and a third graphical element 3230 corresponding to the wall conductance option parameter 3215. In the case of FIG. 32, the wider the graphical elements 3224, 3227, and 3230, the more of an impact the corresponding design option parameter has on energy use intensity (EUI) data (i.e., the more dominant that particular design option parameter and its associated design options are at affecting energy use intensity for the architectural structure). Effectively, this method of analysis may allow a user to gauge the sensitivity of analysis output data with respect to design options and associated design option parameters.

FIG. 33 provides an interface 3300 comprising an output analysis output data selector 3303, an unlocked design option parameter filter 3306, a locked design option parameter filter 3309, a graphical view 3312 of the analysis data based on filter parameters, and an output filter 3315. The analysis output data selector 3303 may present a user with one or more categories of data, which once chosen, causes extrapolation or extraction of corresponding data from the analysis data resulting from a parametric analysis. For example, as shown in FIG. 33, a user may select to review energy use intensity (EUI) data, peak heating usage data, peak cooling usage data, daylight factor (DF) data, and (UDI) data in the analysis data.

As noted herein, the extrapolated/extracted data may be provided to the user by way of an exportable file, a graphical representation of the extrapolated/extracted data, and a table of the extrapolated/extract data. A graphical representation or a table of the extrapolated/extracted data may be displayed to the user through a graphical user interface or may be provided in a file.

As noted herein, where the extrapolated/extract data is provided as a graphical representation, such a graphical representation may be interactive and permit a user to manipulate the presentation of the graphical representation (e.g., enlarge or shrink the graphical representation), and may permit a user to inspect information regarding data points that comprise the graphical representation.

The unlocked design option parameter filter 3306 may allow a user to filter analysis data, produced by a parametric analysis, according to one or more design options used during the parametric analysis and under the influence of one or more unlocked design option parameters. As noted herein, the unlocked design option parameter filter 3306 may permit a user to filter data corresponding to a specific design options as influenced (i.e., controlled) by one or more unlocked design option parameters modified by a set of varying values (e.g., range of values). The data filtered using the unlocked design option parameter filter 3306 may be data extrapolated or extracted from the analysis data based on selections made using the user using analysis output data selector 3303. For instance, as shown in FIG. 33, a user may choose to extrapolate or extract energy use intensity (EUI) data, peak heating usage data, peak cooling usage data, daylight factor (DF) data, and (UDI) data from the analysis data and filter the extrapolated/extracted data according to the following unlocked design option parameters: a glazing ratio design option parameter 3318, a glazing SHGC design option parameter 3321, and a wall conductance design option parameter 3324. For example, as shown in FIG. 33, the user may select a range of 15% to 80% for the glazing ratio design option parameter 3318, 0.3 to 0.7 for the glazing SHGC design option parameter 3321, and 0.15 to 0.5 W/m²/K for the wall conductance design option parameter 3324. The filtered analysis data eventually provided to the user will reflect settings made through the unlocked design option parameter filter 3306.

The locked design option parameter filter 3309 may enable a user to filter analysis data, produced by a parametric analysis, according to one or more design options used during the parametric analysis and under the influence of one or more locked design option parameters. In various embodiments, the locked design option parameter filter 3309 may facilitate filtering data that corresponds to specific design options under the influence of (i.e., as controlled by) particular locked design option parameters as modified by a static value. Effectively, with the locked design option parameter filter 3309, a user may filter the analysis data based on an input value assigned to locked design option parameters during the parametric analysis.

The output filter 3315 may allow a user to filter analysis data, produced by a parametric analysis, according to one or more output data types and according to one or more values (e.g., sets or ranges of values). For example, as shown in FIG. 33, a user may select to filter the analysis data according to the following output data types: daylight factor data 3345, peak cooling usage data 3348, utility bill data 3352, and peak heating usage data 3355. In FIG. 33, the user has selected the user may select a range of 1% to 8% for the daylight factor data 3345, 30 to 80 kW for the peak cooling usage data 3348, $12k to $18k for the utility bill data 3352, and 15 to 70 kW for the peak heating usage data 3355. In some embodiments, the output types provided for selection may depend on the analysis output data selected for review by the user (e.g., via the analysis output data selector 3303).

The graphical view 3312 of the analysis data may display a graphical representation or a tabular representation of the analysis data as selected and filtered according to user selections/preferences. Depending on the embodiment, the analysis data shown by graphical view 3312 may be filtered according to filter input parameters, as determined by the unlocked design option parameter filter 3306 or the locked design option parameter filter 3209, or according to output parameters, as determined by the output filter 3515. As noted herein, the filtered analysis data displayed by graphical view 3212 may be data extrapolated or extracted from the analysis data in accordance with the analysis output data selector 3303 and then filtered in accordance with the unlocked design option parameter filter 3306, the locked design option parameter filter 3309, and the output filter 3515.

The filtered analysis data provided via the graphical view 3312, may take one of many forms including, for example, a chart or graph that is interactive or static in nature. For instance, as illustrated in FIG. 33, the filtered analysis data may be generated in to a vertical bar graph. For some embodiments, where the analysis data is being filtered according to two or more unlocked design option parameters, the graphical view 3212 may present a separate graphical representation for the analysis data as it corresponds to each of the unlocked design option parameters. For example, in FIG. 33, the graphical representation of filtered analysis data comprises a first graphical element 3327 corresponding to the glazing ratio design option parameter 3318, a second graphical element 3330 corresponding to the glazing SHGC design option parameter 3321, and a third graphical element 3333 corresponding to the wall conductance option parameter 3324. In the case of FIG. 33, the wider the graphical elements 3327, 3330, and 3333 the more of an impact the corresponding design option parameter has on energy use intensity (EUI) data (i.e., the more dominant that particular design option parameter and its associated design options are at affecting energy use intensity for the architectural structure). This method of analysis provides the user insight on the sensitivity of certain analysis output data with respect to design options and associated design option parameters.

Additionally, in various embodiments that facilitate filtering the analysis data according to output data type and value, the graphical view 3312 may graphically present the filtered analysis data with a graphical representation of a delta attributed to the output data filtering. For instance, as shown in FIG. 33, a user may select to filter the analysis data according to the following output data types: daylight factor data, peak cooling usage data, utility bill data, and peak heating usage data. To display changes in the filtered analysis data based on this output data filtering, the graphical view 3312 may superimpose graphical deltas 3336, 3339, and 3342 over the graphical elements 3327, 3330, and 3342 to illustrate the change in filtered analysis data.

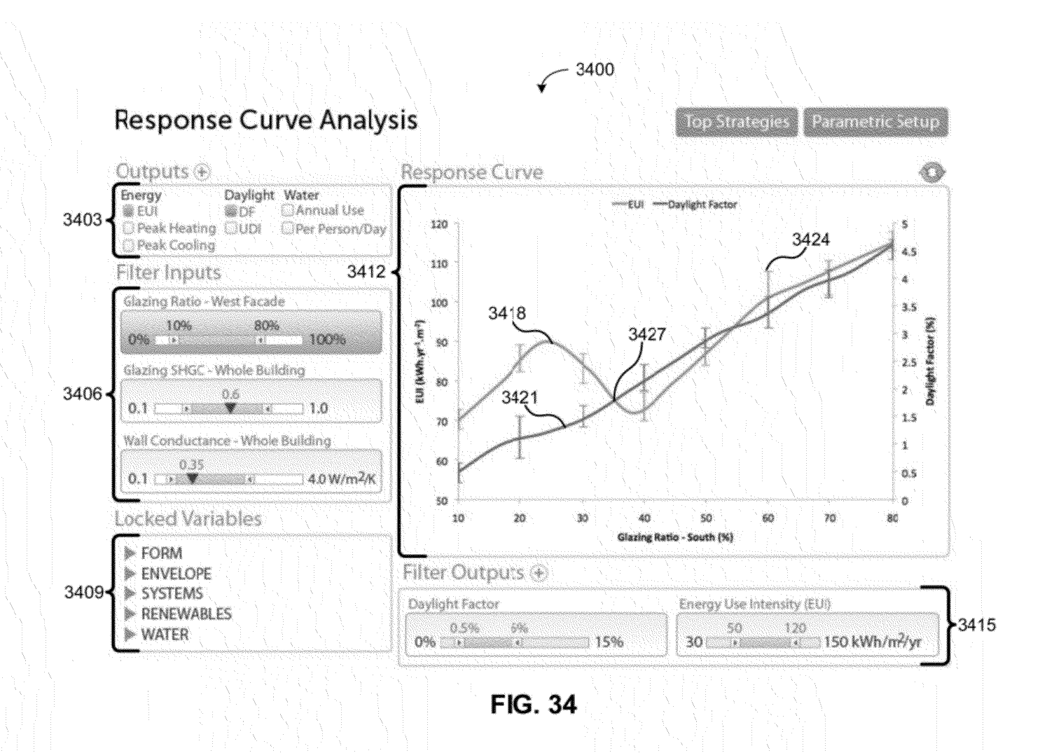

FIG. 34 provides an interface 3400 comprising an output analysis output data selector 3403, an unlocked design option parameter filter 3406, a locked design option parameter filter 3409, a graphical view 3412 of the analysis data based on filter parameters, and an output filter 3415. According to some embodiments, the output analysis output data selector 3403, the unlocked design option parameter filter 3406, the locked design option parameter filter 3409, the graphical view 3412, and the output filter 3415 are similar in function and form to elements similarly numbered in FIG. 33. For FIG. 34, the user has selected for review energy use intensity (EUI) data and daylight factor (DF) data, and has selected to filter the analysis data according to daylight factor (DF) data and energy use intensity (EUI) data.

In accordance with the settings of the output analysis output data selector 3403, the unlocked design option parameter filter 3406, the locked design option parameter filter 3409, and the output filter 3415, the graphical view 3412 displays a line graph 3418 for energy use intensity (EUI) data and a line graph 3421 for daylight factor data. In some embodiments, by graphically presenting two or more output data simultaneously, a user may compare two or more types of filtered analysis data and determine one or more optimal design options, design option parameters, and design option parameter values for the architectural structure.

In the case of FIG. 34, the line graphs 3148 and 3421 are shown to have an inflection point 3427 that indicates that a glazing ratio of 40% would result in an optimal design configuration for the architectural structure. According to the line graphs 3148 and 3421, at a glazing ratio of 40%, the architectural structure would achieve as much energy use as when the glazing ration is at 10% but while receiving more light than the architectural structure would at a glazing ratio 10% (a daylight factor of ˜0.5 at a glazing ratio of 10%, versus a daylight factor of ˜2.0 at a glazing ratio of 40%). Additionally, the line graphs 3148 and 3421 illustrate response curves based on multiple variables, which are represented in the graphical view 3412 by the multiple axes (i.e., EUI and daylight factor axes). Those skilled in the art would readily appreciate that for some embodiments, a response curve may be generated based on a single variable rather than multiple variables.

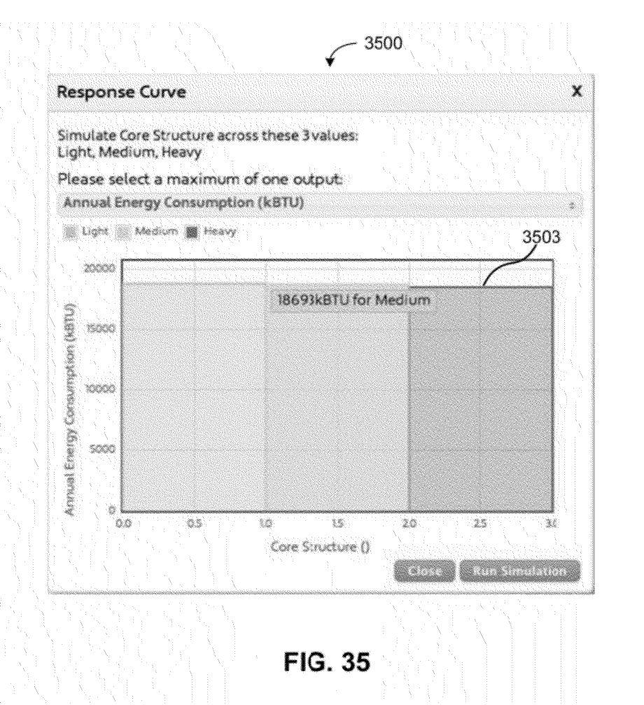

For instance, in FIG. 35, a graphical view 3500 of the analysis data illustrates a response curve based on a single variable relating to the thermal mass of the architectural structure. In particular, the graphical view 3500 illustrates a single variable-based response curve 3503 for Annual Energy Consumption, across the discrete values of “Light,” “Medium,” and “Heavy.” As shown, the response curve 3503 is illustrated as discrete bar charts.

Continuing with reference to FIG. 34, for some embodiments, the line graphs 3148 and 3421 may further include range bands 3424 that graphically illustrate the amount of filtered analysis data points or the number of analysis iterations that are causing the line to slope upward or downward.

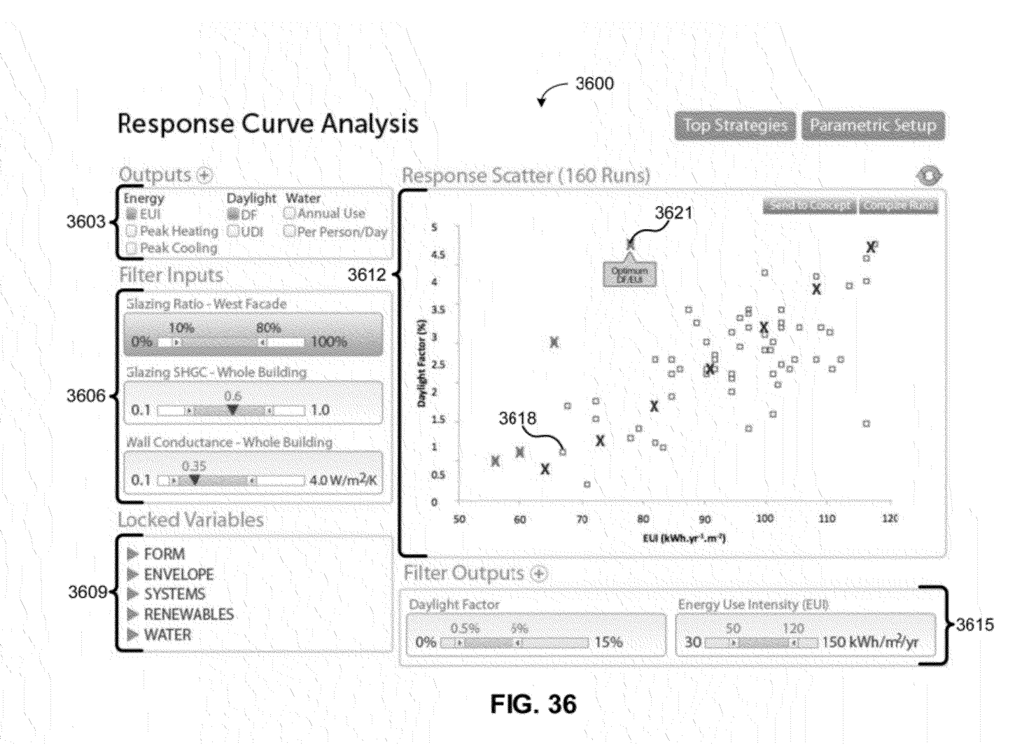

FIG. 36 provides an interface 3600 comprising an output analysis output data selector 3603, an unlocked design option parameter filter 3606, a locked design option parameter filter 3609, a graphical view 3612 of the analysis data based on filter parameters, and an output filter 3615. According to some embodiments, the output analysis output data selector 3603, the unlocked design option parameter filter 3606, the locked design option parameter filter 3609, the graphical view 3612, and the output filter 3615 are similar in function and form to elements similarly numbered in FIG. 33. For FIG. 36, the user has selected for review energy use intensity (EUI) data and daylight factor (DF) data, and has selected to filter the analysis data according to daylight factor (DF) data and energy use intensity (EUI) data.

In accordance with the settings of the output analysis output data selector 3603, the unlocked design option parameter filter 3606, the locked design option parameter filter 3609, the graphical view 3612, and the output filter 3615, the graphical view 3612 displays a scatter chart comprising multiple data points 3618. Depending on the embodiment, the data points 3618 may graphically represent the analysis data corresponding to one or more analysis iterations performed during the parametric analysis of the architectural structure. For example, based on its position in the scatter chart, each of the data points 3618 may represent the daylight factor output and energy use intensity (EUI) output for a given analysis iteration performed during the parametric analysis.

For some embodiments, if a user were to select one or more of the data points 3618 presented in the graphical view 3612, the graphical view 3612 may present the design options, design option parameters, and values (parametric or static) associated with the data point's associated analysis iteration. In addition, in various embodiments, after selecting one or more of the data points 3618, a user may choose to create a design concept from the analysis iterations associated with those selected data points. Depending on the embodiment, the graphical view 3612 may indicate an optimal data point 3621 corresponding to one or more analysis iterations that provide optimal (or best fit) design options, design option parameters, and values for the architectural structure.

The term tool can be used to refer to any apparatus configured to perform a recited function. For example, tools can include a collection of one or more modules and can be comprised of hardware, software or a combination thereof. Thus, for example, a tool can be a collection of one or more software modules, hardware modules, software/hardware modules or any combination or permutation thereof. As another example, a tool can be a computing device or other appliance on which software runs or in which hardware is implemented.

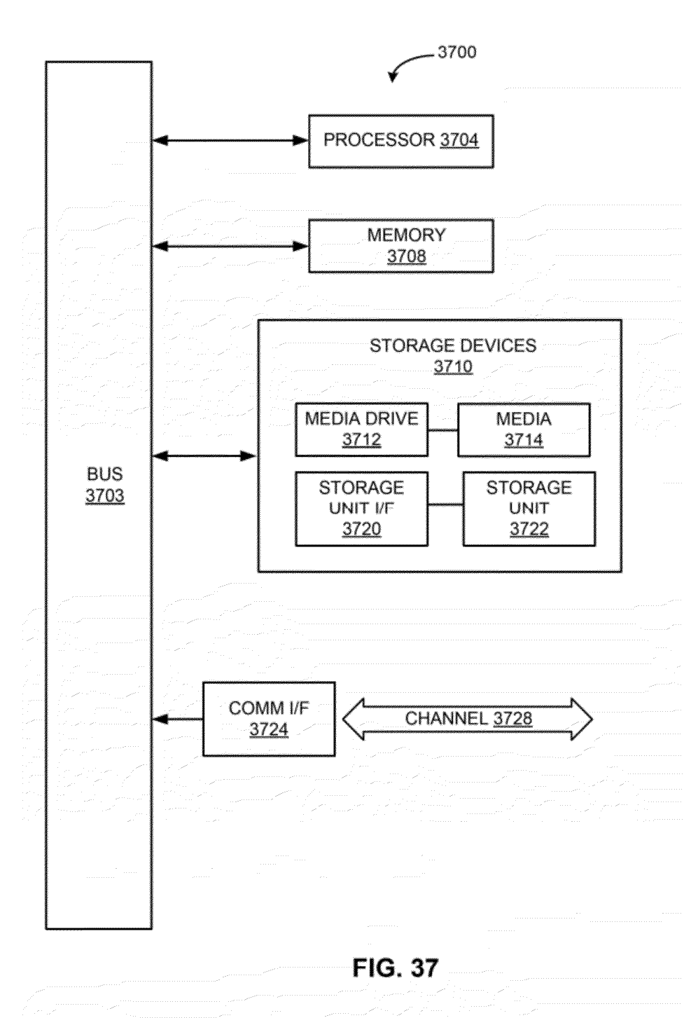

As used herein, the term module might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example computing module is shown in FIG. 37. Various embodiments are described in terms of this example-computing module 3700. After reading this description, it will become apparent to a person skilled in the relevant art how to implement the invention using other computing modules or architectures.

Referring now to FIG. 37, computing module 3700 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 3700 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 3700 might include, for example, one or more processors, controllers, control modules, or other processing devices, such as a processor 3704. Processor 3704 might be implemented using a general-purpose or special-purpose processing engine such as, for example, a microprocessor, controller, or other control logic. In the illustrated example, processor 3704 is connected to a bus 3702, although any communication medium can be used to facilitate interaction with other components of computing module 3700 or to communicate externally.

Computing module 3700 might also include one or more memory modules, simply referred to herein as main memory 3708. For example, preferably random access memory (RAM) or other dynamic memory, might be used for storing information and instructions to be executed by processor 3704. Main memory 3708 might also be used for storing temporary variables or other intermediate information during execution of instructions to be executed by processor 3704. Computing module 3700 might likewise include a read only memory (“ROM”) or other static storage device coupled to bus 3702 for storing static information and instructions for processor 3704.

The computing module 3700 might also include one or more various forms of information storage mechanism 3710, which might include, for example, a media drive 3712 and a storage unit interface 3720. The media drive 3712 might include a drive or other mechanism to support fixed or removable storage media 3714. For example, a hard disk drive, a floppy disk drive, a magnetic tape drive, an optical disk drive, a CD or DVD drive (R or RW), or other removable or fixed media drive might be provided. Accordingly, storage media 3714 might include, for example, a hard disk, a floppy disk, magnetic tape, cartridge, optical disk, a CD or DVD, or other fixed or removable medium that is read by, written to or accessed by media drive 3712. As these examples illustrate, the storage media 3714 can include a computer usable storage medium having stored therein computer software or data.

In alternative embodiments, information storage mechanism 3710 might include other similar instrumentalities for allowing computer programs or other instructions or data to be loaded into computing module 3700. Such instrumentalities might include, for example, a fixed or removable storage unit 3722 and an interface 3720. Examples of such storage units 3722 and interfaces 3720 can include a program cartridge and cartridge interface, a removable memory (for example, a flash memory or other removable memory module) and memory slot, a PCMCIA slot and card, and other fixed or removable storage units 3722 and interfaces 3720 that allow software and data to be transferred from the storage unit 3722 to computing module 3700.

Computing module 3700 might also include a communications interface 3724. Communications interface 3724 might be used to allow software and data to be transferred between computing module 3700 and external devices. Examples of communications interface 3724 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 3724 might typically be carried on signals, which can be electronic, electromagnetic (which includes optical) or other signals capable of being exchanged by a given communications interface 3724. These signals might be provided to communications interface 3724 via a channel 3728. This channel 3728 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 3708, storage unit 3720, media 3714, and channel 3728. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 3700 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for analyzing an architectural structure, comprising:
receiving a design option to apply to an element of the architectural structure;
assigning a set of varying values to a design option parameter associated with the design option, wherein the design option parameter is configured to control a level of change effectuated on the architectural structure by the design option; and
for each current varying value in the set of varying values:
applying the design option to the element of the architectural structure while the design option parameter is assigned the current varying value, and
analyzing an impact on the architectural structure as a result of applying the design option to the element of the architectural structure while the design option parameter is assigned the current varying value.

2. The method of claim 1, further comprising:
obtaining a first geographic location of the architectural structure;
obtaining location-related data regarding the first geographic location;
extracting from the architectural structure three-dimensional data representing the element of the architectural structure;
wherein the three-dimensional data is used when applying the design option to the element of the architectural structure while the design option parameter is assigned the current varying value uses, and
wherein the three-dimensional data and the location-related data are used when analyzing the impact on the architectural structure as a result of applying the design option to the element of the architectural structure while the design option parameter is assigned the current varying value.

3. The method of claim 1, further comprising defining a collection of elements of the architectural structure, wherein the element of the architectural structure is the collection of elements of the architectural structure.

4. The method of claim 1, wherein the set of varying values is defined by a range of values and an associated interval value that determines from the range one or more values in the set of varying values, or by a formula that determines one or more values in the set of varying values.

5. A computer program product for analyzing an architectural structure, the computer program product comprising a computer-readable storage medium in which program instructions are stored, the program instructions configured to cause a computer system to:
receive a design option to apply to an element of the architectural structure;
assign a set of varying values to a design option parameter associated with the design option, wherein the design option parameter is configured to control a level of change effectuated on the architectural structure by the design option; and
for each current varying value in the set of varying values:
apply the design option to the element of the architectural structure while the design option parameter is assigned the current varying value, and
analyze an impact on the architectural structure as a result of applying the design option to the element of the architectural structure while the design option parameter is assigned the current varying value.

6. The computer program product of claim 5, wherein the program instructions are further configured to cause a computer system to:
obtain a first geographic location of the architectural structure;
obtain location-related data regarding the first geographic location;
extract from the architectural structure three-dimensional data representing the element of the architectural structure;
wherein the three-dimensional data is used when applying the design option to the element of the architectural structure while the design option parameter is assigned the current varying value uses, and
wherein the three-dimensional data and the location-related data are used when analyzing the impact on the architectural structure as a result of applying the design option to the element of the architectural structure while the design option parameter is assigned the current varying value.

7. The computer program product of claim 5, wherein the program instructions are further configured to cause a computer system to:
define a collection of elements of the architectural structure, wherein the element of the architectural structure is the collection of elements of the architectural structure.

8. The computer program product of claim 5, wherein the set of varying values is defined by a range of values and an associated interval value that determines from the range one or more values in the set of varying values, or by a formula that determines one or more values in the set of varying values.

9. A computer system for analyzing an architectural structure, comprising:
a processor;
a memory connected to the processor; and
a computer readable medium having instructions embedded therein, the instructions configured to cause the processor to perform the operations of:
receiving a design option to apply to an element of the architectural structure;
assigning a set of varying values to a design option parameter associated with the design option; and
for each current varying value in the set of varying values:
applying the design option to the element of the architectural structure while the design option parameter is assigned the current varying value, and
analyzing an impact on the architectural structure as a result of applying the design option to the element of the architectural structure while the design option parameter is assigned the current varying value.

10. The computer system of claim 9, wherein the program instructions are further configured to cause a computer system to:
obtain a first geographic location of the architectural structure;
obtain location-related data regarding the first geographic location;
extract from the architectural structure three-dimensional data representing the element of the architectural structure;
wherein the three-dimensional data is used when applying the design option to the element of the architectural structure while the design option parameter is assigned the current varying value uses, and
wherein the three-dimensional data and the location-related data are used when analyzing the impact on the architectural structure as a result of applying the design option to the element of the architectural structure while the design option parameter is assigned the current varying value.

11. The computer system of claim 9, wherein the program instructions are further configured to cause a computer system to:
define a collection of elements of the architectural structure, wherein the element of the architectural structure is the collection of elements of the architectural structure.

12. The computer system of claim 9, wherein the set of varying values is defined by a range of values and an associated interval value that determines from the range one or more values in the set of varying values, or by a formula that determines one or more values in the set of varying values.

13. A method for analyzing an architectural structure, comprising:
receiving a set of design options to be applied to the architectural structure, wherein the set of design options includes a design option associated with a design option parameter in a set of design option parameters, and wherein the design option parameter is configured to control a level of change effectuated on the architectural structure by the design option;
assigning a set of values to the set of design option parameters, wherein at least one member of the set of values is a set of varying values, and wherein the design option parameter is assigned the set of varying values;
determining a set of assignment combinations for the set of design option parameters based on the design option parameter being assigned the set of varying values; and
determining a set of analysis iterations based on the set of assignment combinations, wherein each analysis iteration is associated with an assignment combination from the set of assignment combinations, and wherein each analysis iteration:
applies the set of design options to the architectural structure in accordance with the set of design option parameters as modified by an assignment combination associated with the analysis iteration, and
analyzes a set of impacts on the architectural structure that result from applying the set of design options to the architectural structure, thereby producing analysis data.

14. The method of claim 13, further comprising performing the set of analysis iterations on the architectural structure.

15. The method of claim 14, further comprising:
obtain a first geographic location of the architectural structure;
obtain location-related data regarding the first geographic location;
extract from the architectural structure three-dimensional data representing the architectural structure;
wherein the three-dimensional data is used when applying the set of design options to the architectural structure in accordance with the set of design option parameters as modified by the assignment combination associated with the analysis iteration , and
wherein the three-dimensional data and the location-related data are used when analyzing the set of impacts on the architectural structure that result from applying the set of design options to the architectural structure.

16. The method of claim 14, further comprising identifying a specific analysis iteration in the set of analysis iterations based on the analysis data.

17. The method of claim 16, wherein to identify the specific analysis iteration based on analysis data, the the method further comprises:
filtering the analysis data according to a desired feature, thereby resulting in filtered analysis data; and
identifying the specific analysis iteration in the set of analysis iterations, wherein the specific analysis iteration corresponds to the filtered analysis data.

18. The method of claim 16, wherein to identify the specific analysis iteration based on analysis data, the method further comprises:
compare, using the analysis data, a first impact on the architectural structure as a function of a specific design option parameter and a second impact on the architectural structure as a function of the specific design option parameter, wherein the first and second impacts are from the set of impacts, and wherein the specific design option parameter is from the set of design option parameters; and
identifying the specific analysis iteration in the set of analysis iterations based on the impact comparison.

19. The method of claim 14, further comprising identifying a specific analysis iteration in the set of analysis iterations, wherein the specific analysis iteration corresponds to a value or a range of values assigned to a design option parameter in the set of design option parameters.

20. The method of claim 13, further comprising identifying a computing resource necessary to perform the set of analysis iterations on the architectural structure.

21. The method of claim 13, further comprising determining a processing time necessary to perform the set of analysis iterations on the architectural structure.

22. The method of claim 13, further comprising determining a feature of the architectural structure based on the analysis data.

23. The method of claim 13, further comprising receiving a set of element selections, wherein an element selection in the set of element selections determines application of a design option in the set of design options to an element of the architectural structure.

24. The method of claim 13, wherein the set of varying values is defined by a range of values and an associated interval value that determines from the range one or more values in the set of varying values, or by a formula that determines one or more values in the set of varying values.

25. A computer program product for analyzing an architectural structure, the computer program product comprising a computer-readable storage medium in which program instructions are stored, the program instructions configured to cause a computer system to:
receive a set of design options to be applied to the architectural structure, wherein the set of design options includes a design option associated with a design option parameter in a set of design option parameters, and wherein the design option parameter is configured to control a level of change effectuated on the architectural structure by the design option;
assign a set of values to the set of design option parameters, wherein at least one member of the set of values is a set of varying values, and wherein the design option parameter is assigned the set of varying values;
determine a set of assignment combinations for the set of design option parameters based on the design option parameter being assigned the set of varying values; and
determine a set of analysis iterations based on the set of assignment combinations, wherein each analysis iteration is associated with an assignment combination from the set of assignment combinations, and wherein each analysis iteration:
applies the set of design options to the architectural structure in accordance with the set of design option parameters as modified by an assignment combination associated with the analysis iteration, and
analyzes a set of impacts on the architectural structure that result from applying the set of design options to the architectural structure, thereby producing analysis data.

26. The computer program product of claim 25, wherein the program instructions are further configured to cause a computer system to:
perform the set of analysis iterations on the architectural structure.

27. The computer program product of claim 26, wherein to perform the set of analysis iterations on the architectural structure, the program instructions are further configured to cause a computer system to:
obtain a first geographic location of the architectural structure;
obtain location-related data regarding the first geographic location;
extract from the architectural structure three-dimensional data representing the architectural structure;
wherein the three-dimensional data is used when applying the set of design options to the architectural structure in accordance with the set of design option parameters as modified by the assignment combination associated with the analysis iteration, and
wherein the three-dimensional data and the location-related data are used when analyzing the set of impacts on the architectural structure that result from applying the set of design options to the architectural structure.

28. The computer program product of claim 26, wherein the program instructions are further configured to cause a computer system to:
identify a specific analysis iteration in the set of analysis iterations based on the analysis data.

29. The computer program product of claim 28, wherein to identify the specific analysis iteration based on analysis data, the program instructions are further configured to cause a computer system to:
filter the analysis data according to a desired feature, thereby resulting in filtered analysis data; and
identify the specific analysis iteration in the set of analysis iterations, wherein the specific analysis iteration corresponds to the filtered analysis data.

30. The computer program product of claim 28, wherein to identify the specific analysis iteration based on analysis data, the program instructions are further configured to cause a computer system to:
compare, using the analysis data, a first impact on the architectural structure as a function of a specific design option parameter and a second impact on the architectural structure as a function of the specific design option parameter, wherein the first and second impacts are from the set of impacts, and wherein the specific design option parameter is from the set of design option parameters; and
identify the specific analysis iteration in the set of analysis iterations based on the impact comparison.

31. The computer program product of claim 26, wherein the program instructions are further configured to cause a computer system to:
identify a specific analysis iteration in the set of analysis iterations, wherein the specific analysis iteration corresponds to a value or a range of values assigned to a design option parameter in the set of design option parameters.

32. The computer program product of claim 25, wherein the program instructions are further configured to cause a computer system to:
identify a computing resource necessary to perform the set of analysis iterations on the architectural structure.

33. The computer program product of claim 25, wherein the program instructions are further configured to cause a computer system to:
determine a processing time necessary to perform the set of analysis iterations on the architectural structure.

34. The computer program product of claim 25, wherein the programs instructions are further configured to cause a computer system to:
determine a feature of the architectural structure based on the analysis data.

35. The computer program product of claim 25, wherein to receive the set of design options to be applied to the architectural structure, the programs instructions are further configured to cause a computer system to:
receive a set of element selections, wherein an element selection in the set of element selections determines application of a design option in the set of design options to an element of the architectural structure.

36. The computer program product of claim 25, wherein the set of varying values is defined by a range of values and an associated interval value that determines from the range one or more values in the set of varying values, or by a formula that determines one or more values in the set of varying values.

37. A computer system for analyzing an architectural structure, comprising:
a processor;
a memory connected to the processor; and
a computer readable medium having instructions embedded therein, the instructions configured to cause the processor to perform the operations of:
receiving a set of design options to be applied to the architectural structure, wherein the set of design options includes a design option associated with a design option parameter in a set of design option parameters, and wherein the design option parameter is configured to control a level of change effectuated on the architectural structure by the design option;
assigning a set of values to the set of design option parameters, wherein at least one member of the set of values is a set of varying values, and wherein the design option parameter is assigned the set of varying values;
determining a set of assignment combinations for the set of design option parameters based on the design option parameter being assigned the set of varying values; and
determining a set of analysis iterations based on the set of assignment combinations, wherein each analysis iteration is associated with an assignment combination from the set of assignment combinations, and wherein each analysis iteration:
applies the set of design options to the architectural structure in accordance with the set of design option parameters as modified by an assignment combination associated with the analysis iteration, and
analyzes a set of impacts on the architectural structure that result from applying the set of design options to the architectural structure, thereby producing analysis data.

38. The computer system of claim 37, wherein the instructions are further configured to cause the processor to perform the operation of:
performing the set of analysis iterations on the architectural structure.

39. The computer system of claim 38, wherein to perform the set of analysis iterations on the architectural structure, the instructions are further configured to cause the processor to perform the operations of:
obtaining a first geographic location of the architectural structure;
obtaining location-related data regarding the first geographic location;
extracting from the architectural structure three-dimensional data representing the architectural structure;
wherein the three-dimensional data is used when applying the set of design options to the architectural structure in accordance with the set of design option parameters as modified by the assignment combination associated with the analysis iteration, and
wherein the three-dimensional data and the location-related data are used when analyzing the set of impacts on the architectural structure that result from applying the set of design options to the architectural structure.

40. The computer system of claim 38, wherein the instructions are further configured to cause the processor to perform the operations of:
identifying a specific analysis iteration in the set of analysis iterations based on the analysis data.

41. The computer system of claim 40, wherein to identify the specific analysis iteration based on analysis data, the instructions are further configured to cause the processor to perform the operations of:
filtering the analysis data according to a desired feature, thereby resulting in filtered analysis data; and
identifying the specific analysis iteration in the set of analysis iterations, wherein the specific analysis iteration corresponds to the filtered analysis data.

42. The computer system of claim 40, wherein to identify the specific analysis iteration based on analysis data, the instructions are further configured to cause the processor to perform the operations of:
compare, using the analysis data, a first impact on the architectural structure as a function of a specific design option parameter and a second impact on the architectural structure as a function of the specific design option parameter, wherein the first and second impacts are from the set of impacts, and wherein the specific design option parameter is from the set of design option parameters; and
identifying the specific analysis iteration in the set of analysis iterations based on the impact comparison.

43. The computer system of claim 38, wherein the instructions are further configured to cause the processor to perform the operations of:
identifying a specific analysis iteration in the set of analysis iterations, wherein the specific analysis iteration corresponds to a value or a range of values assigned to a design option parameter in the set of design option parameters.

44. The computer system of claim 37, wherein the instructions are further configured to cause the processor to perform the operation of:
identifying a computing resource necessary to perform the set of analysis iterations on the architectural structure.

45. The computer system of claim 37, wherein the instructions are further configured to cause the processor to perform the operation of:
determining a time necessary to perform the set of analysis iterations on the architectural structure.

46. The computer system of claim 37, wherein the instructions are further configured to cause the processor to perform the operation of:
determining a feature of the architectural structure based on the analysis data.

47. The computer system of claim 37, wherein to receive the set of design options to be applied to the architectural structure, the instructions are further configured to cause the processor to perform the operation of:
receiving a set of element selections, wherein an element selection in the set of element selections determines application of a design option in the set of design options to an element of the architectural structure.

48. The computer system of claim 37, wherein the set of varying values is defined by a range of values and an associated interval value that determines from the range one or more values in the set of varying values, or by a formula that determines one or more values in the set of varying values.
